(19) United States
(12) Patent Application Publication
(10) Pub. No.: US 2015/0043637 A1
(43) Pub. Date: Feb. 12, 2015

(54) IMAGE PROCESSING DEVICE AND METHOD

(71) Applicant: SONY CORPORATION, Tokyo (JP)

(72) Inventors: Yoshitaka Morigami, Tokyo (JP); Kazushi Sato, Kanagawa (JP)

(73) Assignee: SONY CORPORATION, Tokyo (JP)

(21) Appl. No.: 14/385,635

(22) PCT Filed: Apr. 4, 2013
(86) PCT No.: PCT/JP2013/060364

§ 371 Date: Sep. 16, 2014

(30) Foreign Application Priority Data
Apr. 13, 2012 (JP) 2012-091611

(51) Int. Cl. H04N 19/51

(52) U.S. Cl. CPC H04N 19/51; H04N 19/124
USPC 375/240.12

(57) ABSTRACT

The present technology relates to an image processing device and method capable of improving the coding efficiency.

An image processing device of the present technology includes: a generator configured to generate information on a scaling list to which identification information is assigned according to a format of image data to be encoded; an encoder configured to encode the information on the scaling list generated by the generator; and a transmitter configured to transmit the encoded data of the information on the scaling list generated by the encoder. The present technology can be applied to image processing devices.

### TECHNICAL FIELD

The present technique relates to an image processing device and a method therefor.

### BACKGROUND ART

In related art, devices compliant with a system such as MPEG (Moving Picture Experts Group) that handles image information digitally, and compresses the digitally handled image information through orthogonal transform such as discrete cosine transform by using redundancy unique to image information for the purpose of efficient transmission and storage of information are widespread for both information distribution in broadcast stations or the like and information reception at home.

In recent years, for further improved coding efficiency than H.264 and MPEG-4 Part10 (Advanced Video Coding; hereinafter referred to as AVC), standardization of the coding techniques called HEVC (High Efficiency Video Coding) is under way by JCTVC (Joint Collaboration Team-Video Coding) that is a standards organization jointly run by ITU-T (International Telecommunication Union Telecommunication Standardization Sector) and ISO (International Organization for Standardization)/IEC (International Electrotechnical Commission). For the HEVC standards, a Committee draft that is the first drafted specification is issued in February 2012 (refer to Non-Patent Document 1, for example).

According to the coding techniques, information on quantization matrices (scaling lists) used for quantization in encoding can be transmitted to the decoding side.

### CITATION LIST

### Non-Patent Document

Non-Patent Document 1: Benjamin Bross, Woo-Jin Han, Jens-Rainer Ohm, Gary J. Sullivan, Thomas Wiegand, “High efficiency video coding (HEVC) text specification draft 6”, JCTVC-H1003 ver20, 2012.2.17

### SUMMARY OF THE INVENTION

### Problems to be Solved by the Invention

With the coding techniques, however, the chroma format of images is not considered in transmission of information on scaling lists. Thus, unnecessary information on scaling lists for color components is transmitted even for encoding a monochrome image (black-and-white image) having only brightness components (no color components), for example. Owing to transmission of such unnecessary information, the coding efficiency may be degraded.

The present technology is proposed in view of these circumstances and an object thereof is to improve the coding efficiency.

### Solutions to Problems

One aspect of the present technology is an image processing device including: a generator configured to generate information on a scaling list to which identification information is assigned according to a format of image data to be encoded; an encoder configured to encode the information on the scaling list generated by the generator; and a transmitter configured to transmit the encoded data of the information on the scaling list generated by the encoder.

The identification information can be assigned to a scaling list used for quantization of the image data.

The identification information can be assigned to a scaling list used for quantization of the image data from among multiple scaling lists provided in advance.

The identification information can be an identification number for identifying an object with a numerical value, and a small identification number can be assigned to the scaling list used for quantization of the image data.

When a chroma format of the image data is monochrome, the identification information can be assigned only to a scaling list for brightness components.

In a normal mode: the generator can generate difference data between the scaling list to which the identification number is assigned and a predicted value thereof, the encoder can encode the difference data generated by the generator, and the transmitter can transmit the encoded data of the difference data generated by the encoder.

In a copy mode: the generator can generate information indicating a reference scaling list that is a reference, the encoder can encode the information indicating the reference scaling list generated by the generator, and the transmitter can transmit the encoded data of the information indicating the reference scaling list generated by the encoder.

The generator can generate the information indicating the reference scaling list only when multiple candidates for the reference scaling list are present.

An image data encoder configured to encode the image data; and an encoded data transmitter configured to transmit the encoded data of the image data generated by the image data encoder can further be included.

The one aspect of the present technology is an image processing method including: generating information on a scaling list to which identification information is assigned according to a format of image data to be encoded; encoding the generated information on the scaling list; and transmitting the generated encoded data of the information on the scaling list.

Another aspect of the present technology is an image processing device including: an acquisition unit configured to acquire encoded data of information on a scaling list to which identification information is assigned according to a format of encoded image data; a decoder configured to decode the encoded data of information on the scaling list acquired by the acquisition unit; and a generator configured to generate a current scaling list to be processed on the basis of the information on the scaling list generated by the decoder.

The identification information can be assigned to a scaling list used for quantization of the image data.

The identification information can be assigned to a scaling list used for quantization of the image data from among multiple scaling lists provided in advance.

The identification information can be an identification number for identifying an object with a numerical value, and a small identification number can be assigned to the scaling list used for quantization of the image data.

When a chroma format of the image data is monochrome, the identification information can be assigned only to a scaling list for brightness components.

In a normal mode: the acquisition unit can acquire encoded data of difference data between the scaling list to which the identification number is assigned and a predicted value thereof, the decoder can decode the encoded data of difference data acquired by the acquisition unit, and the generator can generate the current scaling list on the basis of the difference data generated by the decoder.

In a copy mode: the acquisition unit can acquire encoded data of information indicating a reference scaling list that is a reference, the decoder can decode the encoded data of the information indicating the reference scaling list acquired by the acquisition unit, and the generator can generate the current scaling list by using the information indicating the reference scaling list generated by the decoder.

When the information indicating the reference scaling list is not transmitted, the generator can set “0” to the identification information of the reference scaling list.

An encoded data acquisition unit configured to acquire encoded data of the image data; and an image data decoder configured to decode the encoded data of the image data acquired by the encoded data acquisition unit can further be included.

Another aspect of the present technology is an image processing method including: acquiring encoded data of information on a scaling list to which identification information is assigned according to a format of encoded image data; decoding the acquired encoded data of the information on the scaling list; and generating a current scaling list to be processed on the basis of the generated information on the scaling list.

In one aspect of the present technology, information on a scaling list to which identification information is assigned according to a format of image data to be encoded is generated; the generated information on the scaling list is encoded; and the generated encoded data of the information on the scaling list is transmitted.

In another aspect of the present technology, encoded data of information on a scaling list to which identification information is assigned according to a format of encoded image data is acquired; the acquired encoded data of the information on the scaling list is decoded; and a current scaling list to be processed on the basis of the generated information on the scaling list is generated.

### Effects of the Invention

According to the present technology, images can be processed. In particular, the coding efficiency can be improved.

### BRIEF DESCRIPTION OF DRAWINGS

FIG. 1 is a table for explaining an example of syntax of a scaling list.

FIG. 2 is a table for explaining examples of chroma formats.

FIG. 3 is a table for explaining another example of syntax of a scaling list.

FIG. 4 is a table for explaining an example of assignment of MatrixIDs.

FIG. 5 shows tables for explaining examples of assignment of MatrixIDs.

FIG. 6 is a table for explaining an example of syntax of a scaling list.

FIG. 7 is a block diagram showing a typical example structure of an image encoding device.

FIG. 8 is a block diagram showing a typical example structure of an orthogonal transform/quantization unit.

FIG. 9 is a block diagram showing a typical example structure of a matrix processor.

FIG. 10 is a flowchart for explaining an example of a flow of an encoding process.

FIG. 11 is a flowchart for explaining an example of a flow of an orthogonal transform/quantization process.

FIG. 12 is a flowchart for explaining an example of a flow of a scaling list encoding process.

FIG. 13 is a flowchart following the flowchart of FIG. 12 for explaining an example of the flow of the scaling list encoding process.

FIG. 14 is a block diagram showing a typical example structure of an image decoding device.

FIG. 15 is a block diagram showing a typical example structure of an inverse quantization/inverse orthogonal transform unit.

FIG. 16 is a block diagram showing a typical example structure of a matrix generator.

FIG. 17 is a flowchart for explaining an example of a flow of a decoding process.

FIG. 18 is a flowchart for explaining an example of a flow of an inverse quantization/inverse orthogonal transform process.

FIG. 19 is a flowchart for explaining an example of a flow of a scaling list decoding process.

FIG. 20 is a flowchart following the flowchart of FIG. 19 for explaining an example of the flow of the scaling list decoding process.

FIG. 21 is a table for explaining an example of syntax of a scaling list.

FIG. 22 is a flowchart for explaining an example of a flow of a scaling list encoding process.

FIG. 23 is a flowchart following the flowchart of FIG. 22 for explaining an example of the flow of the scaling list encoding process.

FIG. 24 is a flowchart for explaining an example of a flow of a scaling list decoding process.

FIG. 25 is a flowchart following the flowchart of FIG. 24 for explaining an example of the flow of the scaling list decoding process.

FIG. 26 is a table for explaining an example of syntax of a scaling list.

FIG. 27 is a flowchart for explaining an example of a flow of a scaling list encoding process.

FIG. 28 is a flowchart following the flowchart of

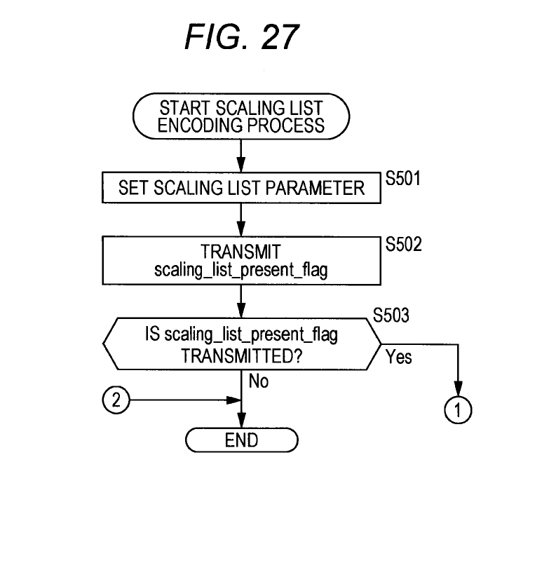

FIG. 27 for explaining an example of the flow of the scaling list encoding process.

FIG. 29 is a flowchart for explaining an example of a flow of a scaling list decoding process.

FIG. 30 is a flowchart following the flowchart of FIG. 29 for explaining an example of the flow of the scaling list decoding process.

FIG. 31 is a diagram showing an example of a multi-view image encoding technique.

FIG. 32 is a diagram showing a typical example structure of a multi-view image encoding device to which the present technology is applied.

FIG. 33 is a diagram showing a typical example structure of a multi-view image decoding device to which the present technology is applied.

FIG. 34 is a diagram showing an example of a progressive image coding technique.

FIG. 35 is a diagram showing a typical example structure of a progressive image encoding device to which the present technology is applied.

FIG. 36 is a diagram showing a typical example structure of a progressive image decoding device to which the present technology is applied.

FIG. 37 is a block diagram showing a typical example structure of a computer.

FIG. 38 is a block diagram showing one example of a schematic structure of a television apparatus.

FIG. 39 is a block diagram showing one example of a schematic structure of a portable telephone device.

FIG. 40 is a block diagram showing one example of a schematic structure of a recording/reproducing device.

FIG. 41 is a block diagram showing one example of a schematic structure of an imaging device.

FIG. 42 is a block diagram showing an example of use of scalable coding.

FIG. 43 is a block diagram showing another example of use of scalable coding.

FIG. 44 is a block diagram showing still another example of use of scalable coding.

### MODES FOR CARRYING OUT THE INVENTION

Modes for carrying out the present disclosure (hereinafter referred to as embodiments) will be described below. The description will be made in the following order.

1. First Embodiment (image encoding device)
2. Second Embodiment (image decoding device)
3. Third Embodiment (other syntax)
4. Fourth Embodiment (still other syntax)
5. Fifth Embodiment (multi-view image encoding device, multi-view image decoding device)
6. Sixth Embodiment (progressive image encoding device, progressive image decoding device)
7. Seventh Embodiment (computer)

### 8. Applications

### 9. Applications of Scalable Coding

### 1. First Embodiment

### 1-1 Chroma Format and Matrix ID

According to coding techniques such as H.264 and MPEG-4 Part10 (Advanced Video Coding; hereinafter referred to as AVC), and HEVC (High Efficiency Video Coding), information on quantization matrices (scaling lists) used for quantization in encoding can be transmitted to the decoding side. At the decoding side, inverse quantization can be performed by using the information on the scaling lists transmitted from the encoding side.

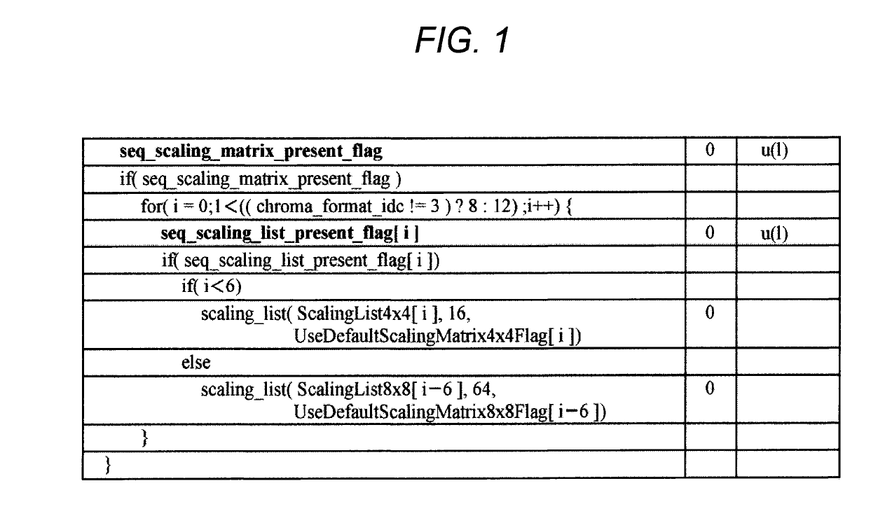

FIG. 1 is a table for explaining an example of syntax of a scaling list in the AVC. According to the AVC, in processing information on a scaling list to be transmitted, chroma_format_idc that is identification information representing a chroma format of image data to be encoded as on the third line from the top of the syntax shown in FIG. 1 is referred to.

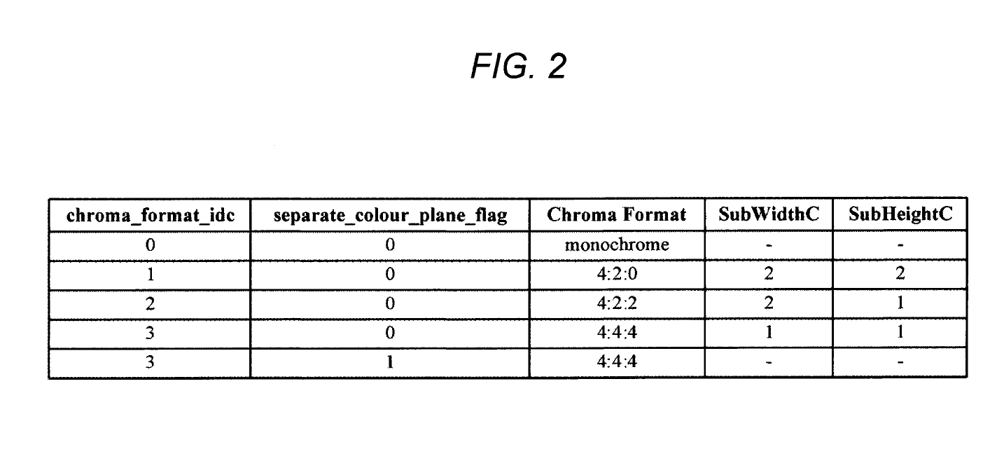

If chroma_format_idc is other than “3”, however, the processing is performed in the same manner for any value. chroma_format_idc is assigned as in the table shown in FIG. 2. Specifically, when chroma_format_idc is “0” (that is, the chroma format is monochrome), the processing on the scaling list for color components (color difference components) is performed in the same manner as the case where chroma_format_idc is not “0”. The encoding process and the decoding process may thus be increased correspondingly. Furthermore, when the chroma format is monochrome, information on the scaling list for color components (color difference components) is also to be transmitted similarly to the case where the chroma format is not monochrome, and the coding efficiency may therefore be degraded.

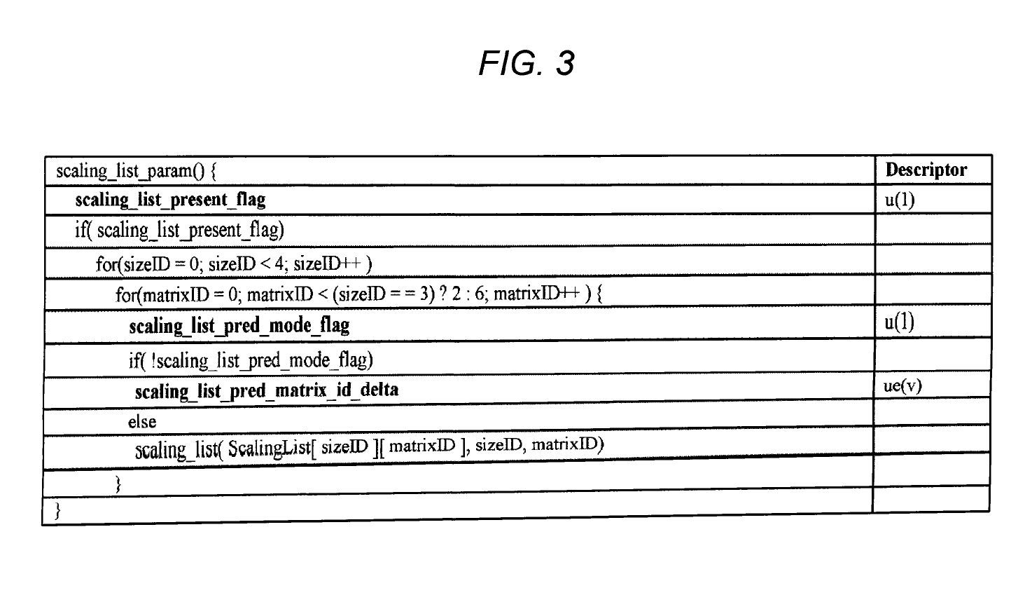

Furthermore, FIG. 3 is a table for explaining another example of syntax of a scaling list in the HEVC. According to the HEVC, in processing information on a scaling list to be transmitted, processing to be executed is controlled according to a matrix ID (MatrixID) as on the fifth line from the top of the syntax shown in FIG. 3.

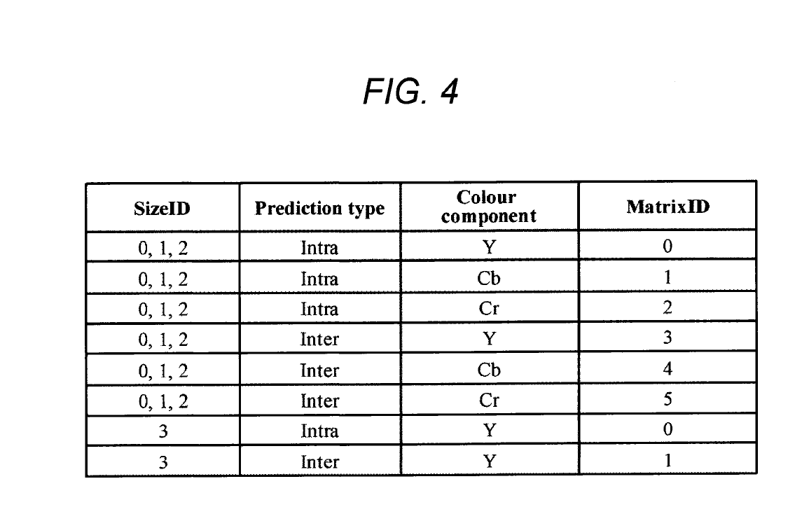

A matrix ID (MatrixID) is identification information representing the type of a scaling list. For example, a matrix ID (MatrixID) contains an identification number for identification using a numerical value. FIG. 4 shows an example of assignment of matrix IDs (MatrixIDs). In the example of FIG. 4, a matrix ID is assigned to each combination of a size ID (SizeID), a prediction type (Prediction type), and the type of a color component (Colour component).

A size ID represents the size of a scaling list. A prediction type represents a method for predicting a block (intra prediction or inter prediction, for example).

According to the HEVC, similarly to the AVC, the chroma format (chroma_format_idc) of the image data to be encoded is also assigned as in the table shown in FIG. 2.

As shown on the fifth line from the top of the syntax of FIG. 3, however, the chroma format (chroma_format_idc) is not considered (referred to) in determination of the processing condition. Specifically, when chroma_format_idc is “0” (the chroma format is monochrome), processing on a scaling list for color components (color difference components) is performed in the same manner as the case where chroma_format_idc is not “0”. The encoding process and the decoding process may thus be increased correspondingly.

Furthermore, when the chroma format is monochrome, information on a scaling list for color components (color difference components) is also to be transmitted similarly to the case where the chroma format is not monochrome, and the coding efficiency may therefore be degraded.

In transmission of information on scaling lists, control is therefore made not to transmit unnecessary information that is not used for quantization and inverse quantization. For example, transmission of information on scaling lists and execution of processing relating to the transmission are controlled according to the format of image data to be encoded/decoded (or image data to be transmitted). In other words, control is made so that only information on scaling lists used for quantization and inverse quantization is transmitted from among multiple scaling lists provided in advance.

In this manner, increase in the code amount as a result of transmitting information on scaling lists can be suppressed and the coding efficiency can be improved. Furthermore, as a result of suppressing execution of processing relating to transmission of unnecessary information, loads of the encoding process and the decoding process can be decreased.

For example, when information on a scaling list for color components is unnecessary, the information is not to be transmitted. In other words, information on a scaling list for color components is to be transmitted only where necessary.

Whether or not information on a scaling list for color components is unnecessary may be determined according to the chroma format, for example. For example, when the chroma format of image data to be encoded is monochrome, information on a scaling list for color components may be not to be transmitted. In other words, when the chroma format of image data to be encoded is not monochrome, information on a scaling list for color components may be to be transmitted.

In this manner, unnecessary transmission of information on scaling lists for color components can be suppressed and the coding efficiency can be improved. Furthermore, increase in loads of the encoding process and the decoding process owing to unnecessary transmission of information on scaling lists for color components can be suppressed.

For example, whether or not information on a scaling list for color components is unnecessary may be determined on the basis of the value of the identification information (chroma_format_idc) of the chroma format. For example, when chroma_format_idc assigned as in the table of FIG. 2 is referred to and the value thereof is “0”, information on a scaling list for color components may be not to be transmitted. In other words, when the value of chroma_format_idc is not “0”, information on a scaling list for color components may be to be transmitted. In this manner, determination on whether or not transmission of information on scaling lists for color components can easily be made.

For example, when the side ID (SizeID) is large (“3”, for example), information on a scaling list for color components may be not to be transmitted. In other words, when the size ID (SizeID) is not large (“2” or smaller, for example), information on a scaling list for color components may be to be transmitted. In this manner, unnecessary transmission of information on scaling lists for color components can be suppressed and the coding efficiency can be improved.

Control on transmission of information on a scaling list and control on execution of processing relating to the transmission may be made by controlling assignment of a matrix ID (MatrixID) that is identification information for the scaling list.

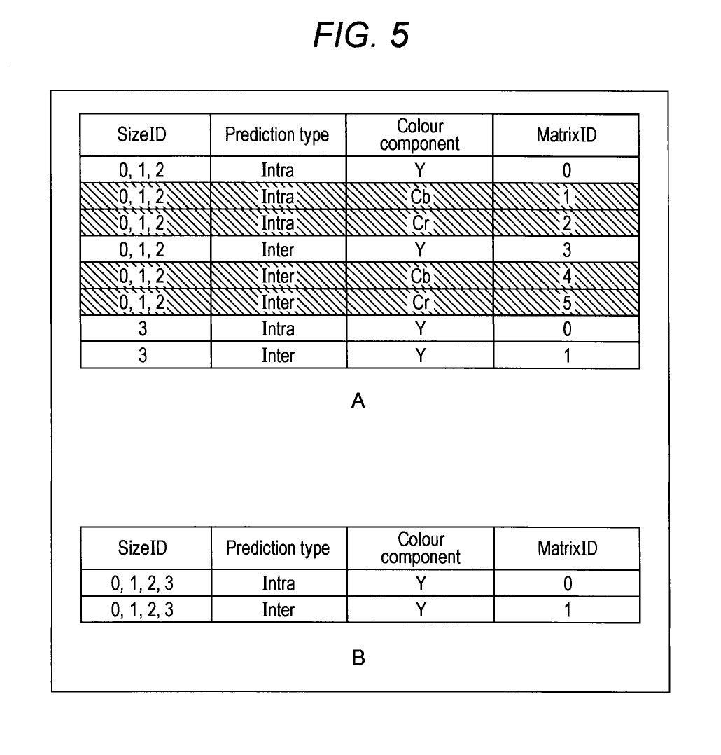

For example, according to the HEVC, matrix IDs are assigned as shown in FIG. 4. When transmission of scaling lists for color components is unnecessary, however, assignment of matrix IDs to the scaling lists for color components is also unnecessary. Thus, in such a case, matrix IDs may not be assigned to scaling lists for color components (hatched parts in FIG. 5 A) but matrix IDs may be assigned only to scaling lists for brightness components.

Assignment of matrix IDs in such a case is as in the table shown in FIG. 5B. The assignment of matrix IDs is controlled in this manner, and execution of processing is controlled by using the matrix IDs. As a result, transmission of scaling lists to which no matrix IDs are assigned and processing relating to the transmission can be easily omitted.

As mentioned above, a matrix ID can contain an identification number. For example, serial identification numbers that are different from one another are sequentially assigned to respective scaling lists from the smallest number. In this case, the values of matrix IDs assigned to the respective scaling lists can be made smaller by controlling the assignment of the matrix IDs and omitting assignment to scaling lists that are not to be transmitted. As a result, the code amount can be decreased. In particular, for exponential golomb coding of matrix IDs, the code amount can be further decreased by making the values of the matrix IDs smaller.

Note that, in the HEVC, a normal mode and a copy mode are present for transmission of information on scaling lists. In the normal mode, a difference value between a scaling list used for quantization and a predicted value thereof is encoded and transmitted as information on the scaling list. For example, the difference value is subjected to DPCM (Differential Pulse Code Modulation) coding and further subjected to unsigned exponential golomb coding before being transmitted.

In such a normal mode of transmission of scaling lists similar to that of the HEVC, encoded data of the difference value between a scaling list for color components and a predicted value thereof can be transmitted only where necessary (not be transmitted where unnecessary) by controlling the transmission of the encoded data and execution of processing relating to the transmission as described above.

For example, the encoded data may be transmitted only when the value of chroma_format_idc is not “0” or when the size ID (SizeID) is “2” or smaller by controlling assignment of matrix IDs to scaling lists for color components. In this manner, increase in the code amount as a result of transmitting information on scaling lists in the normal mode can be suppressed and the coding efficiency can be improved. Furthermore, loads of the encoding process and the decoding process can be decreased.

In contrast, in the copy mode, scaling_list_pred_matrix_id_delta is transmitted as information on a scaling list.

scaling_list_pred_matrix_id_delta is a difference value between a matrix ID (MatrixID) of a scaling list to be processed (current scaling list) and a value obtained by subtracting “1” from a matrix ID (RefMatrixID) of a scaling list that is referred to (reference scaling list). Thus, scaling list_pred_matrix_id_delta can be expressed as the following Expression (1).

Scaling_list_pred_matrix_id_delta=MatrixID−(RefMatrixID−1) (1)

This scaling_list_pred_matrix_id_delta is subjected to unsigned exponential golomb coding before being transmitted.

In such a copy mode of transmission of scaling lists similar to that of the HEVC, the value of scaling_list_pred_matrix_id_delta that is a parameter transmitted in the copy mode may be controlled by controlling assignment of the matrix IDs as described above.

For example, as described above, when the value of chroma_format_idc is not “0”, matrix IDs may be assigned to both of scaling lists for brightness components and scaling lists for color components as shown in FIG. 4. In other words, when the value of chroma_format_idc is “0”, matrix IDs may be assigned only to scaling lists for brightness components as shown in FIG. 5B, for example.

In the assignment pattern shown in FIG. 5B, when a matrix of Inter is Intra, scaling_list_pred_matrix_id_delta is “0”. Thus, increase in the code amount owing to transmission of scaling_list_pred_matrix_id_delta can be further suppressed and the coding efficiency can be further improved as compared to the assignment pattern shown in FIG. 4.

Furthermore, as a result of controlling the assignment of matrix IDs in this manner, the matrix IDs can be made smaller whether transmission of information on scaling lists for color components is necessary or unnecessary. As a result, the value of scaling_list_pred_matrix_id_delta can be made smaller, increase in the code amount owing to transmission of scaling_list_pred_matrix_id_delta can be suppressed and the coding efficiency can be improved.

In particular, when scaling_list_pred_matrix_id_delta is subjected to unsigned exponential golomb coding before being transmitted, increase in the code amount can be further suppressed and the coding efficiency can be further improved by making the value of scaling_list_pred_matrix_id_delta smaller.

When the size ID (SizeID) is “3” or larger, matrix IDs area assigned only to brightness components in both of the assignment patterns shown in FIG. 4 and FIG. 5B. Thus, in this case, either pattern may be selected (the pattern of FIG. 4 may be deemed to be selected or the pattern of FIG. 5B may be deemed to be selected).

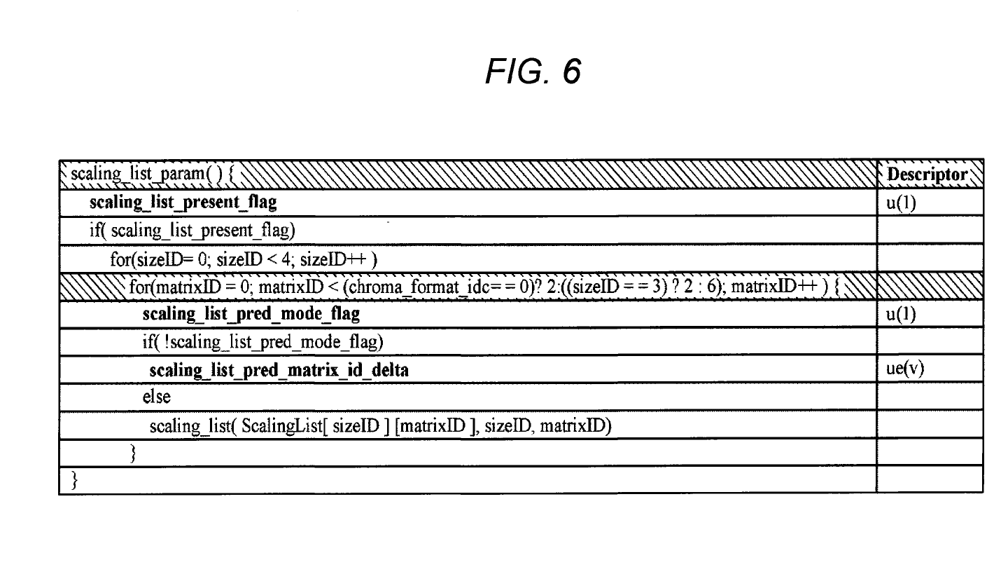

An example of syntax when transmission of information on scaling lists and execution of processing relating to the transmission are controlled by controlling assignment of matrix IDs as described above is shown in FIG. 6. In the example of FIG. 6, identification information (chroma_format_idc) of a chroma format is acquired on the first line from the top of the syntax, and the acquired value is checked on the fifth line from the top. The upper limit of the matrix ID under the condition is then controlled according to the value.

For example, when the value of chroma_format_idc is “0” (when the chroma format of image data is monochrome), matrix IDs (MatrixIDs) are assigned as in FIG. 5B and thus limited to values smaller than “2”.

Alternatively, for example, when the size ID (SizeID) is “3”, matrix IDs are assigned as in FIG. 4 or FIG. 5B and thus limited to values smaller than “2”.

Still alternatively, for example, when the value of chroma_format_idc is not “0” and the size ID is not “3”, matrix IDs are assigned as in FIG. 4 and thus limited to values smaller than “6”.

According to such control, processing on the tenth line from the top of the syntax of FIG. 6 is performed in the normal mode or processing on the eighth line from the top of the syntax of FIG. 6 is performed in the copy mode.

Thus, both in the normal mode and the copy mode, processing is controlled as described above according to whether or not the chroma format of image data is monochrome.

Note that matrix IDs may be set in advance. For example, the matrix IDs may be set in advance as shown in FIG. 5B. Alternatively, for example, the matrix IDs may be set in a pattern for each format of image data to be encoded as in FIG. 4 or FIG. 5B, for example. In this case, one pattern is selected and used according to the format from among multiple patterns provided in advance, for example.

In this manner, the coding efficiency can be improved. Furthermore, loads of the encoding process and the decoding process can be decreased. Image processing devices that perform such control on transmission of scaling lists will be described below.

### 1-2 Image Encoding Device

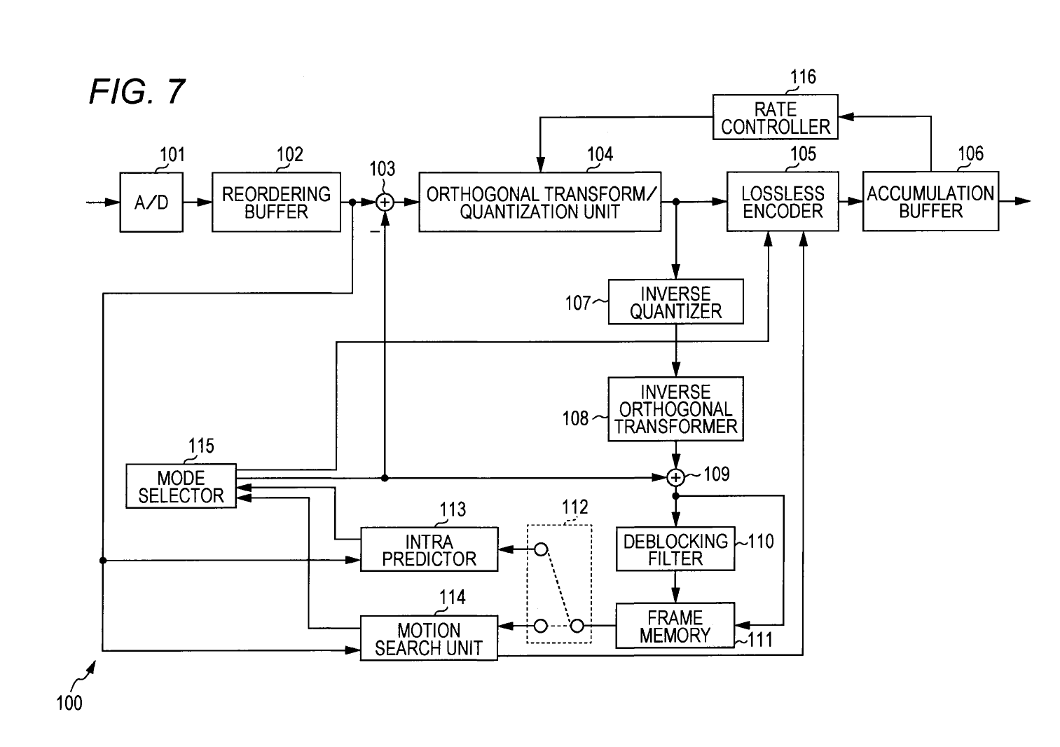

FIG. 7 is a block diagram showing a typical example structure of an image encoding device that is an image processing device to which the present technology is applied.

The image encoding device 100 shown in FIG. 7 is an image processing device to which the present technology is applied and which encodes input image data and outputs resulting encoded data. The image encoding device 100 includes an A/D (Analogue to Digital) converter 101 (A/D), a reordering buffer 102, an arithmetic operation unit 103, an orthogonal transform/quantization unit 104, a lossless encoder 105, an accumulation buffer 106, an inverse quantizer 107, an inverse orthogonal transformer 108, an arithmetic operation unit 109, a deblocking filter 110, a frame memory 111, a selector 112, an intra predictor 113, a motion search unit 114, a mode selector 115, and a rate controller 116.

The A/D converter 101 converts an image signal input in an analog format into image data in a digital format, and outputs a series of digital image data to the reordering buffer 102.

The reordering buffer 102 reorders images contained in the series of image data input from the A/D converter 101. The reordering buffer 102 reorders images according to a GOP (Group of Pictures) structure of the encoding process, and then outputs the reordered image data to the arithmetic operation unit 103, the intra predictor 113, and the motion search unit 114.

Image data input from the reordering buffer 102 and predicted image data selected by the mode selector 115, which will be described later, are supplied to the arithmetic operation unit 103. The arithmetic operation unit 103 calculates a prediction error data that is a difference between image data input from the reordering buffer 102 and the predicted image data input from the mode selector 115, and outputs the calculated prediction error data to the orthogonal transform/quantization unit 104.

The orthogonal transform/quantization unit 104 performs orthogonal transform and quantization on the prediction error data input from the arithmetic operation unit 103, and outputs quantized transform coefficient data (hereinafter referred to as quantized data) to the lossless encoder 105 and the inverse quantizer 107. The bit rate of the quantized data output from the orthogonal transform/quantization unit 104 is controlled on the basis of a rate control signal from the rate controller 116. A detailed structure of the orthogonal transform/quantization unit 104 will be further described later.

The quantized data input from the orthogonal transform/quantization unit 104, information on scaling lists (quantization matrices), and information on intra prediction or inter prediction selected by the mode selector 115 are supplied to the lossless encoder 105. The information on intra prediction can contain prediction mode information representing an intra prediction mode optimal for each block, for example. The information on inter prediction can contain prediction mode information, difference motion vector information, reference image information, and the like for prediction of a motion vector for each block, for example.

The lossless encoder 105 performs lossless coding on the quantized data to generate an encoded stream. The lossless coding performed by the lossless encoder 105 may be variable-length coding or arithmetic coding, for example. The lossless encoder 105 also multiplexes information on scaling lists at a predetermined position in the encoded stream. The lossless encoder 105 further multiplexes the information on intra prediction or inter prediction mentioned above into a header of the encoded stream. The lossless encoder 105 then outputs the generated encoded stream to the accumulation buffer 106.

The accumulation buffer 106 temporarily stores the encoded stream input from the lossless encoder 105 by using a storage medium such as a semiconductor memory. The accumulation buffer 106 then outputs the stored encoded stream at a rate according to the band of a transmission path (or an output line from the image encoding device 100).

The inverse quantizer 107 performs an inverse quantization process on the quantized data input from the orthogonal transform/quantization unit 104. The inverse quantizer 107 then outputs transform coefficient data obtained as a result of the inverse quantization process to the inverse orthogonal transformer 108.

The inverse orthogonal transformer 108 performs an inverse orthogonal transform process on the transform coefficient data input from the inverse quantizer 107 to restore the prediction error data. The inverse orthogonal transformer 108 then outputs the restored prediction error data to the arithmetic operation unit 109.

The arithmetic operation unit 109 adds the restored prediction error data input from the inverse orthogonal transformer 108 and the predicted image data input from the mode selector 115 to generate decoded image data. The arithmetic operation unit 109 then outputs the generated decoded image data to the deblocking filter 110 and the frame memory 111.

The deblocking filter 110 performs a filtering process to reduce block distortion caused during encoding of images. The deblocking filter 110 filters the decoded image data input from the arithmetic operation unit 109 to remove (or at least reduce) the block distortion, and outputs the decoded image data resulting from the filtering to the frame memory 111.

The frame memory 111 stores the decoded image data input from the arithmetic operation unit 109 and the decoded image data resulting from the filtering input from the deblocking filter 110 by using a storage medium.

The selector 112 reads out the decoded image data before the filtering used for intra prediction from the frame memory 111, and supplies the read decoded image data as reference image data to the intra predictor 113. The selector 112 also reads out the decoded image data resulting from the filtering used for inter prediction from the frame memory 111, and supplies the read decoded image data as reference image data to the motion search unit 114.

The intra predictor 113 performs an intra prediction process in each intra prediction mode on the basis of the image data to be encoded input from the reordering buffer 102 and the decoded image data supplied via the selector 112.

For example, the intra predictor 113 evaluates the prediction result in each intra prediction mode by using a predetermined cost function. The intra predictor 113 then selects an intra prediction mode in which the cost function value is the smallest, that is, an intra prediction mode in which the compression ratio is the highest as an optimal intra prediction mode.

The intra predictor 113 outputs information on the intra prediction such as prediction mode information representing the optimal intra prediction mode, the predicted image data, and the cost function value to the mode selector 115.

The motion search unit 114 performs an inter prediction process (inter-frame prediction process) on the basis of the image data to be encoded input from the reordering buffer 102 and the decoded image data supplied via the selector 112.

For example, the motion search unit 114 evaluates the prediction result in each prediction mode by using a predetermined cost function. Subsequently, the motion search unit 114 selects a prediction mode in which the cost function value is the smallest, that is, a prediction mode in which the compression ratio is the highest as an optimal prediction mode. The motion search unit 114 also generates predicted image data according to the optimal prediction mode. The motion search unit 114 then outputs information on the inter prediction containing prediction mode information representing the selected optimal prediction mode, the predicted image data, and information on the inter prediction such as the cost function value to the mode selector 115.

The mode selector 115 compare the cost function value for the intra prediction input from the intra predictor 113 and the cost function value for the inter prediction input from the motion search unit 114. The mode selector 115 then selects a prediction method in which the cost function value is smaller from the intra prediction and the inter prediction.

For example, when the intra prediction is selected, the mode selector 115 outputs the information on the intra prediction to the lossless encoder 105 and outputs the predicted image data to the arithmetic operation unit 103 and the arithmetic operation unit 109. In contrast, for example, when the inter prediction is selected, the mode selector 115 outputs the aforementioned information on the inter prediction to the lossless encoder 105 and outputs the predicted image data to the arithmetic operation unit 103 and the arithmetic operation unit 109.

The rate controller 116 monitors the free space of the accumulation buffer 106. The rate controller 116 then generates a rate control signal according to the free space of the accumulation buffer 106, and outputs the generated rate control signal to the orthogonal transform/quantization unit 104. For example, when the free space of the accumulation buffer 106 is small, the rate controller 116 generates a rate control signal for lowering the bit rate of the quantized data. In contrast, for example, when the free space of the accumulation buffer 106 is sufficiently large, the rate controller 116 generates a rate control signal for increasing the bit rate of the quantized data.

### 1-3 Orthogonal Transform/Quantization Unit

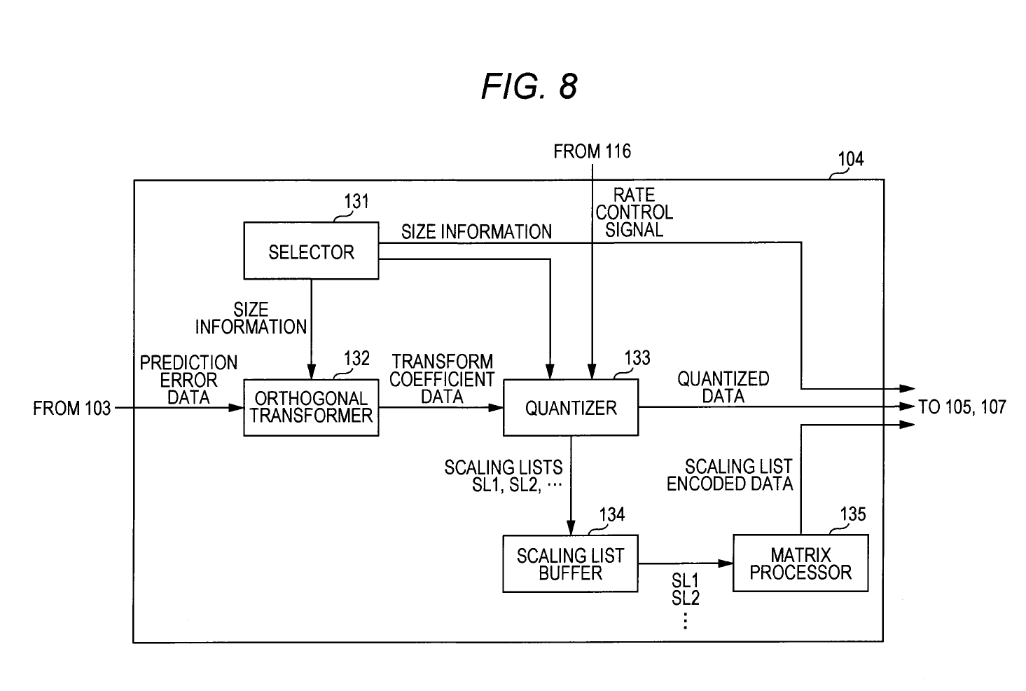

FIG. 8 is a block diagram showing an example of a detailed structure of the orthogonal transform/quantization unit 104 of the image encoding device 100 shown in FIG. 7. As shown in FIG. 8, the orthogonal transform/quantization unit 104 includes a selector 131, an orthogonal transformer 132, a quantizer 133, a scaling list buffer 134, and a matrix processor 135.

The selector 131 selects a unit of transform (TU) used for orthogonal transform of image data to be encoded from among multiple units of transform of different sizes. Candidates for the size of the unit of transform that can be selected by the selector 131 includes 4×4 and 8×8 in the AVC, and 4×4 (SizeID==0), 8×8 (SizeID==1), 16×16 (SizeID==2), and 32×32 (SizeID==3) in the HEVC, for example. The selector 131 may select any of the units of transform according to the size or the quality of the image to be encoded, or the performance of the image encoding device 100, for example. The selection of the unit of transform by the selector 131 may be hand-tuned by the user developing the image encoding device 100. The selector 131 then outputs information specifying the selected size of the unit of transform to the orthogonal transformer 132, the quantizer 133, the lossless encoder 105, and the inverse quantizer 107.

The orthogonal transformer 132 performs orthogonal transform on the image data (that is, prediction error data) supplied from the arithmetic operation unit 103 in the unit of transform selected by the selector 131. The orthogonal transform performed by the orthogonal transformer 132 may be discrete cosine transform (DCT) or Karhunen-Loeve transform, for example. The orthogonal transformer 132 then outputs transform coefficient data resulting from the orthogonal transform process to the quantizer 133.

The quantizer 133 quantizes the transform coefficient data generated by the orthogonal transformer 132 by using a scaling list associated with the unit of transform selected by the selector 131. The quantizer 133 also changes the bit rate of the output quantized data by switching the quantization step size on the basis of the rate control signal from the rate controller 116.

The quantizer 133 also stores a set of scaling lists associated with respective units of transform that can be selected by the selector 131 in the scaling list buffer 134. For example, when there are four candidates for the size (SizeID==0 to 3) of the unit of transform, which are 4×4, 8×8, 16×16 and 32×32, as in the HEVC, a set of four scaling sets associated with the four sizes, respectively, can be stored by the scaling list buffer 134.

When a default scaling list for a certain size is used, only a flag indicating that the default scaling list is to be used (that a scaling list defined by the user is not to be used) may be stored in association with the size by the scaling list buffer 134.

The set of scaling lists that may be used by the quantizer 133 can typically be set for each sequence of the encoded stream. Furthermore, the quantizer 133 may update the set of scaling lists set for each sequence for each picture. Information for controlling such setting and update of the set of scaling lists can be inserted in a sequence parameter set and a picture parameter set, for example.

The scaling list buffer 134 temporarily stores the set of scaling lists associated with each of multiple units of transform that can be selected by the selector 131 by using a storage medium such as a semiconductor memory. The set of scaling lists stored by the scaling list buffer 134 is referred to in processing performed by the matrix processor 135, which will be described next.

The matrix processor 135 performs processing on transmission of scaling lists used for encoding (quantization) that are stored in the scaling list buffer 134. For example, the matrix processor 135 encodes the scaling lists stored in the scaling list buffer 134. The encoded data of scaling lists (hereinafter also referred to as scaling list encoded data) generated by the matrix processor 135 can then be output to the lossless encoder 105 and inserted in the header of the encoded stream.

### 1-4 Matrix Processor

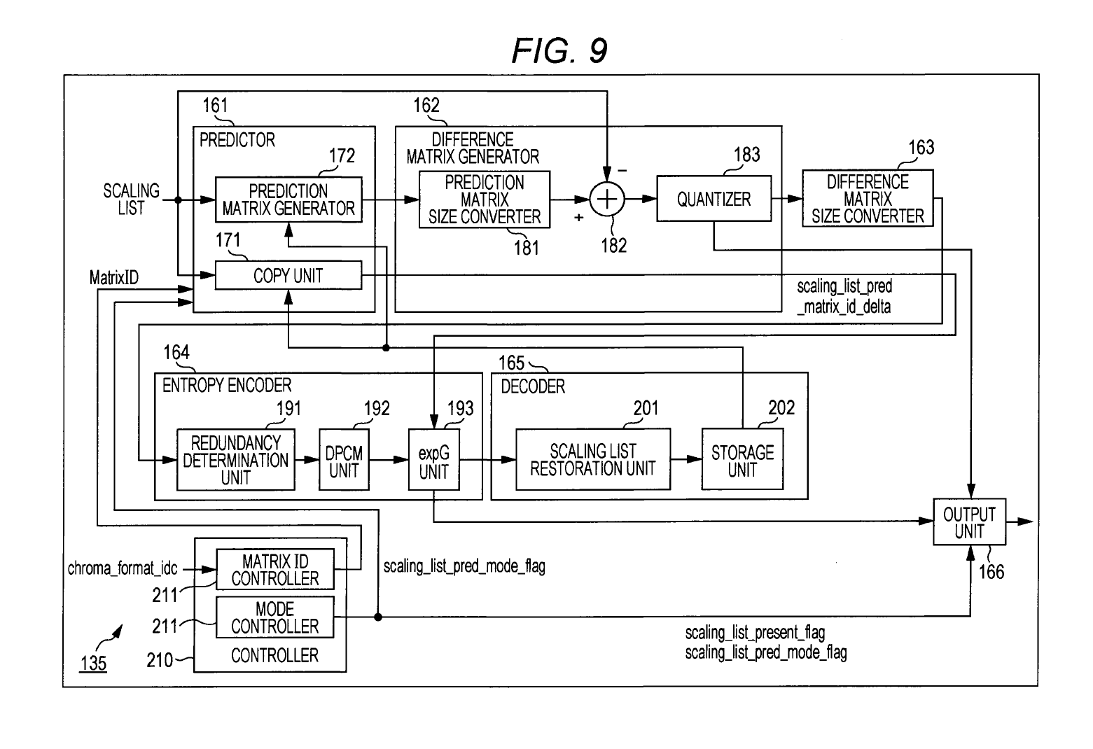

FIG. 9 is a block diagram showing a typical example structure of the matrix processor 135 of FIG. 8. As illustrated in FIG. 9, the matrix processor 135 includes a predictor 161, a difference matrix generator 162, a difference matrix size converter 163, an entropy encoder 164, a decoder 165, and an output unit 166.

The predictor 161 generates a prediction matrix. As shown in FIG. 9, the predictor 161 includes a copy unit 171 and a prediction matrix generator 172.

The copy unit 171 performs processing in the copy mode. In the copy mode, scaling lists to be processed are generated by copying other scaling lists at the decoding side. Thus, in the copy mode, information specifying other scaling lists to be copied may be transmitted. The copy unit 171 therefore operates in the copy mode, and specifies other scaling lists having the same structure as the scaling lists to be processed as the scaling lists to be copied (reference).

More specifically, the copy unit 171 acquires matrix IDs (RefMatrixID) of the scaling lists to be referred to (hereinafter also referred to as reference matrix IDs) from a storage unit 202 of the decoder 165.

The matrix IDs (MatrixID) are assigned as shown in FIG. 4 or FIG. 5B. Specifically, the reference matrix IDs (RefMatrixID) indicates the size (SizeID) of a reference block to be referred to, a prediction type (Prediction type) (intra prediction or inter prediction), and components (Colour component) (brightness components or color (color difference) components).

The copy unit 171 obtains the matrix ID (MatrixID) (hereinafter also referred to as a current matrix ID) of the current scaling list to be processed from the size (SizeID), the prediction type (Prediction type), and the components (Colour component) of the current scaling list. The copy unit 171 calculates the parameter scaling_list_pred_matrix_id_delta as Expression (1), for example, by using the current matrix ID (MatrixID) and the reference matrix ID (RefMatrixID).

The copy unit 171 supplies the calculated parameter scaling_list_pred_matrix_id_delta to an expG unit 193 of the entropy encoder 164 so that the parameter scaling_list_pred_matrix_id_delta is subjected to unsigned exponential golomb coding and output through the output unit 166 to outside of the matrix processor 135 (the lossless encoder 105 and the inverse quantizer 107). Thus, in this case, the parameter scaling_list_pred_matrix_id_delta indicating the reference of the scaling lists is transmitted (contained in the encoded data) as information on the scaling lists to the decoding side. The image encoding device 100 can therefore suppress increase in the code amount for transmitting information on the scaling lists.

In the normal mode, the prediction matrix generator 172 acquires previously transmitted scaling lists (also referred to as reference scaling lists) from the storage unit 202 of the decoder 165, and generates a prediction matrix (predicts the current scaling list) by using the scaling lists. The prediction matrix generator 172 supplies the generated prediction matrix to the difference matrix generator 162.

The difference matrix generator 162 generates a difference matrix (residual matrix) that is a difference between the prediction matrix supplied from the predictor 161 (prediction matrix generator 172) and the scaling lists input to the matrix processor 135. As shown in FIG. 9, the difference matrix generator 162 includes a prediction matrix size converter 181, an arithmetic operation unit 182, and a quantizer 183.

The prediction matrix size converter 181 converts the size of the prediction matrix supplied from the prediction matrix generator 172 to match the size of the scaling list input to the matrix processor 135 where necessary.

For example, when the size of the prediction matrix is larger than that of the current scaling list, the prediction matrix size converter 181 down-converts the prediction matrix. More specifically, for example, when the prediction matrix is 16×16 and the current scaling list is 8×8, the prediction matrix size converter 181 down-converts the prediction matrix into 8×8. Any method may be used for the down-conversion. For example, the prediction matrix size converter 181 may reduce the number of elements of the prediction matrix by using a filter (by operation) (hereinafter also referred to as downsampling). Alternatively, for example, the prediction matrix size converter 181 may reduce the number of elements of the prediction matrix by thinning out some elements (only even numbers of two-dimensional elements, for example) without using any filter (hereinafter also referred to as subsampling).

Alternatively, for example, when the size of the prediction matrix is smaller than that of the current scaling list, the prediction matrix size converter 181 up-converts the prediction matrix. More specifically, for example, when the prediction matrix is 8×8 and the current scaling list is 16×16, the prediction matrix size converter 181 up-converts the prediction matrix into 16×16. Any method may be used for the up-conversion. For example, the prediction matrix size converter 181 may increase the number of elements of the prediction matrix by using a filter (by operation) (hereinafter also referred to as upsampling). Alternatively, for example, the prediction matrix size converter 181 may increase the number of elements of the prediction matrix by copying elements of the prediction matrix without using any filter (hereinafter also referred to as inverse subsampling).

The prediction matrix size converter 181 supplies a prediction matrix with the size matched with that of the current scaling list to the arithmetic operation unit 182.

The arithmetic operation unit 182 subtracts the current scaling list from the prediction matrix supplied from the prediction matrix size converter 181 to generate a difference matrix (residual matrix). The arithmetic operation unit 182 supplies the calculated difference matrix to the quantizer 183.

The quantizer 183 quantizes the difference matrix supplied from the arithmetic operation unit 182. The quantizer 183 supplies the result of quantizing the difference matrix to the difference matrix size converter 163. The quantizer 183 also supplies information on quantization parameters and the like used for the quantization to the output unit 166 to output the information to outside of the matrix processor 135 (the lossless encoder 105 and the inverse quantizer 107). Note that the quantizer 183 may be omitted (that is, the quantization of the difference matrix may not be performed).

The difference matrix size converter 163 converts the size of the difference matrix (quantized data) supplied from the difference matrix generator 162 (quantizer 183) to a size equal to or smaller than the maximum size (hereinafter also referred to as a transmission size) permitted in transmission where necessary. The maximum size may be any size, and may be 8×8, for example.

The encoded data output from the image encoding device 100 is transmitted to an image decoding device associated with the image encoding device 100 via a transmission path or a storage medium, for example, and decoded by the image decoding device. For example, in the image encoding device 100, the upper limit (maximum size) of the size of the difference matrix (quantized data) in such transmission, that is, in the encoded data output from the image encoding device 100 is set. When the size of the difference matrix is larger than the maximum size, the difference matrix size converter 163 down-converts the difference matrix so that the size becomes the maximum size or smaller.

Any method may be used for the down-conversion similarly to the down-conversion of the prediction matrix described above. For example, down-sampling using a filter or the like may be used or sub-sampling that thins out elements may be used.

The size of the difference matrix resulting from down-conversion may be any size smaller than the maximum size. Typically, however, the difference matrix is desirably down-converted to the maximum size because more error is caused as the size difference between before and after conversion is larger.

The difference matrix size converter 163 supplies the down-converted difference matrix to the entropy encoder 164. If the size of the difference matrix is smaller than the maximum size, the down-conversion is unnecessary and the difference matrix size converter 163 thus supplies the input difference matrix without any change to the entropy encoder 164 (that is, the down-conversion is omitted).

The entropy encoder 164 encodes the difference matrix (quantized data) supplied from the difference matrix size converter 163 by a predetermined method. As shown in FIG. 9, the entropy encoder 164 includes a redundancy determination unit 191, a DPCM unit 192, and an expG unit 193.

The redundancy determination unit 191 determines symmetry of the difference matrix supplied from the difference matrix size converter 163, and delete symmetric data (matrix elements) that are redundant data if the residual (difference matrix) is a symmetric matrix of 135 degrees. If the residual is not a symmetric matrix of 135 degrees, the redundancy determination unit 191 does not delete the data (matrix elements). The redundancy determination unit 191 supplies the difference matrix data resulting from deleting the symmetric part where necessary to the DPCM unit 192.

The DPCM unit 192 performs DPCM coding on the difference matrix data resulting from deleting the symmetric part where necessary supplied from the redundancy determination unit 191 to generate DPCM data. The DPCM unit 192 supplies the generated DPCM data to the expG unit 193.

The expG unit 193 performs signed/unsigned exponential golomb coding on the DPCM data supplied from the DPCM unit 192. The expG unit 193 supplies the coding result to the decoder 165 and the output unit 166.

Note that the expG unit 193 performs unsigned exponential golomb coding on the parameter scaling_list_pred_matrix_id_delta supplied from the copy unit 171 as described above. The expG unit 193 supplies the generated unsigned exponential golomb code to the output unit 166.

The decoder 165 restores the current scaling list from the data supplied from the expG unit 193. The decoder 165 supplies information on the restored current scaling list as a previously transmitted scaling list to the predictor 161.

As shown in FIG. 9, the decoder 165 includes a scaling list restoration unit 201 and a storage unit 202.

The scaling list restoration unit 201 decodes the exponential golomb code supplied from the entropy encoder 164 (the expG unit 193) to restore the scaling list input to the matrix processor 135. For example, the scaling list restoration unit 201 decodes the exponential golomb code by a method associated with the encoding method of the entropy encoder 164, performs inverse conversion of the size conversion by the difference matrix size converter 163, performs inverse quantization of the quantization by the quantizer 183, and subtract the resulting difference matrix from the prediction matrix to restore the current scaling list.

The scaling list restoration unit 201 supplies the restored current scaling list to the storage unit 202 and stores the restored current scaling list in association with the matrix ID (MatrixID).

The storage unit 202 stores information on the scaling list supplied from the scaling list restoration unit 201. The information on the scaling list stored in the storage unit 202 is used for generation of another prediction matrix in the unit of orthogonal transform to be processed later in time. Thus, the storage unit 202 supplies the stored information on scaling lists as information on previously transmitted scaling lists (information on reference scaling lists) to the predictor 161.

Note that the storage unit 202 may store information on the current scaling list input to the matrix processor 135 in association with the matrix ID (MatrixID) instead of storing the information on the current scaling list restored in this manner. In such a case, the scaling list restoration unit 201 may be omitted.

The output unit 166 outputs various information supplied thereto to outside of the matrix processor 135. For example, in the copy mode, the output unit 166 supplies the unsigned exponential golomb code of the parameter scaling_list_pred_matrix_id_delta indicating the reference of the scaling lists supplied from the expG unit 193 to the lossless encoder 105 and the inverse quantizer 107. Furthermore, for example, in the normal mode, the output unit 166 supplies the exponential golomb code supplied from the expG unit 193 and the quantization parameter supplied from the quantizer 183 to the lossless encoder 105 and the inverse quantizer 107.

The lossless encoder 105 includes the information on the scaling lists supplied in this manner into the encoded stream to provide the information to the decoding side. For example, the lossless encoder 105 stores scaling list parameters such as scaling_list_present_flag and scaling_list_pred_mode_flag in an APS (Adaptation parameter set), for example. The storage of the scaling list parameters is of course not limited to APS. For example, the parameters may be stored at any location such as a SPS (Sequence parameter set) or a PPS (Picture parameter set).

The matrix processor 135 further includes a controller 210. The controller 210 controls the mode (the normal mode and the copy mode, for example) of encoding of scaling lists, and controls the assignment pattern of matrix IDs.

As shown in FIG. 9, the controller 210 includes a matrix ID controller 211 and a mode controller 212. The matrix ID controller 211 acquires chroma_format_idc from VUI (Video usability information) and controls the assignment pattern of matrix IDs on the basis of the value of chroma_format_idc, for example.

For example, as described above, assume that a pattern in which matrix IDs are assigned to both of brightness components and color components (FIG. 4) and a pattern in which matrix IDs are assigned only to brightness components (FIG. 5B) are provided as the assignment patterns of matrix IDs. When the value of chroma_format_idc is “0”, for example, the matrix ID controller 211 selects the pattern in which matrix IDs are assigned only to brightness components is selected, and otherwise, the pattern in which matrix IDs are assigned to both of brightness components and color components is selected.

When the size ID (SizeID) is “3” or larger, the matrix ID controller 211 selects the pattern in which matrix IDs are assigned only to brightness components (FIG. 4 and FIG. 5B).

The matrix ID controller 211 supplies control information indicating the assignment pattern of matrix IDs selected as described above to the predictor 161.

The copy unit 171 or the prediction matrix generator 172 (either one associated with the selected mode) of the predictor 161 performs the aforementioned process according to the assignment pattern. As a result, the copy unit 171 and the prediction matrix generator 172 can perform the processes on scaling lists for color components only where necessary, which can not only improve the coding efficiency but also reduce loads of the respective processes. The load of the encoding process is thus reduced.

The mode controller 212 controls the mode in which scaling lists are encoded. For example, the mode controller 212 selects whether to encode scaling lists in the normal mode or the copy mode. For example, the mode controller 212 sets a flag scaling_list_pred_mode_flag indicating the mode for encoding the scaling lists and supplies the flag to the predictor 161. Either one of the copy unit 171 and the prediction matrix generator 172 of the predictor 161 that is associated with the value of the flag scaling_list_pred_mode_flag indicating the mode processes the scaling lists.

For example, the mode controller 212 also generates a flag scaling_list_present_flag indicating whether or not to encode scaling lists. The mode controller 212 supplies the generated flag scaling_list_present_flag indicating whether or not to encode the scaling lists and the generated flag scaling_list_pred_mode_flag indicating the mode for encoding the scaling lists to the output unit 166.

The output unit 166 supplies the supplied flag information to the lossless encoder 105. The lossless encoder 105 includes the information on the scaling lists supplied in this manner into the encoded stream (APS, for example) to provide the information to the decoding side.

A device at the decoding side can thus easily and accurately know whether or not encoding of the scaling lists has been performed, and if the encoding has been performed, in what mode the encoding has been performed on the basis of the flag information.

As described above, the predictor 161 through the output unit 166 perform processing on scaling lists for color components and transmit the information on the scaling lists for the color components only where necessary in the mode selected by the controller 210. The image encoding device 100 can therefore suppress increase in the code amount for transmitting information on scaling lists and improve the coding efficiency. The image encoding device 100 can also suppress increase in the loads of the encoding process.

### 1-5 Flow of Encoding Process

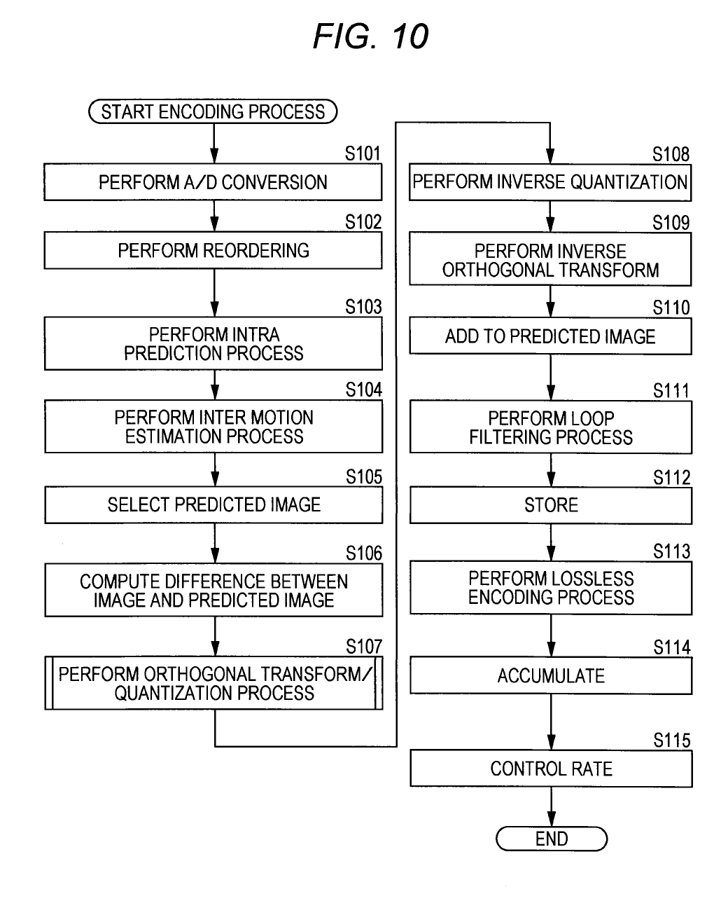

Next, various processes performed by the image encoding device 100 will be described. First, an example of a flow of an encoding process will be described with reference to the flowchart of FIG. 10.

In step S101, the A/D converter 101 performs A/D conversion on an input image. In step S102, the reordering buffer 102 stores the image obtained by the A/D conversion and reorders respective pictures in display order into encoding order.

In step S103, the intra predictor 113 performs an intra prediction process in the intra prediction mode. In step S104, the motion search unit 114 performs an inter motion estimation process in which motion estimation and motion compensation are performed in the inter prediction mode.

In step S105, the mode selector 115 determines the optimal prediction mode on the basis of cost function values output from the intra predictor 113 and the motion search unit 114. Specifically, the mode selector 115 selects either one of a predicted image generated by the intra predictor 113 and a predicted image generated by the motion search unit 114.

In step S106, the arithmetic operation unit 103 computes a difference between the reordered image obtained by the processing in step S102 and the predicted image selected by the processing in step S105. The difference data is reduced in the data amount as compared to the original image data. Accordingly, the data amount can be made smaller as compared to a case in which images are directly encoded.

In step S107, the orthogonal transform/quantization unit 104 performs an orthogonal transform/quantization process to perform orthogonal transform on the difference information generated by the processing in step S106, and further quantizes the orthogonal transform.

The difference information quantized by the processing in step S107 is locally decoded as follows. In step S108, the inverse quantizer 107 performs inverse quantization on the orthogonal transform coefficient quantized by the processing in step S107 by a method associated with the quantization. In step S109, the inverse orthogonal transformer 108 performs inverse orthogonal transform on the orthogonal transform coefficient obtained by the processing in step S108 by a method associated with the processing in step S107.

In step S110, the arithmetic operation unit 109 adds the predicted image to the locally decoded difference information to generate a locally decoded image (an image corresponding to that input to the arithmetic operation unit 103). In step S111, the deblocking filter 110 filters the image generated by the processing in step S110. As a result, block distortion or the like is removed.

In step S112, the frame memory 111 stores the image resulting from removing block distortion or the like by the processing in step S111. Note that images that are not subjected to the filtering by the deblocking filter 110 are also supplied from the arithmetic operation unit 109 and stored in the frame memory 111.

The images stored in the frame memory 111 are used in processing in step S103 and processing in step S104.

In step S113, the lossless encoder 105 encodes the transform coefficient quantized by the processing in step S107 to generate encoded data. Specifically, lossless coding such as variable-length coding or arithmetic coding is performed on the difference image (two-dimensional difference image in the case of inter).

The lossless encoder 105 also encodes information on the prediction mode of the predicted image selected by the processing in step S105 and adds the encoded information to the encoded data obtained by encoding the difference image. For example, when the intra prediction mode is selected, the lossless encoder 105 encodes intra prediction mode information. In contrast, for example, when the inter prediction mode is selected, the lossless encoder 105 encodes inter prediction mode information. The information is added (multiplexed) into the encoded data in a form of header information, for example.

In step S114, the accumulation buffer 106 accumulates encoded data obtained by the processing in step S113. The encoded data accumulated in the accumulation buffer 106 is read out where necessary and transmitted to a device at the decoding side via a certain transmission path (including not only a communication channel but also a storage medium and the like).

In step S115, the rate controller 116 controls the rate of quantization operation of the orthogonal transform/quantization unit 104 so as not to cause overflow or underflow on the basis of compressed images accumulated in the accumulation buffer 106 by the processing in step S114.

The encoding process is terminated when the processing in step S115 is terminated.

### 1-6 Flow of Orthogonal Transform/Quantization Process

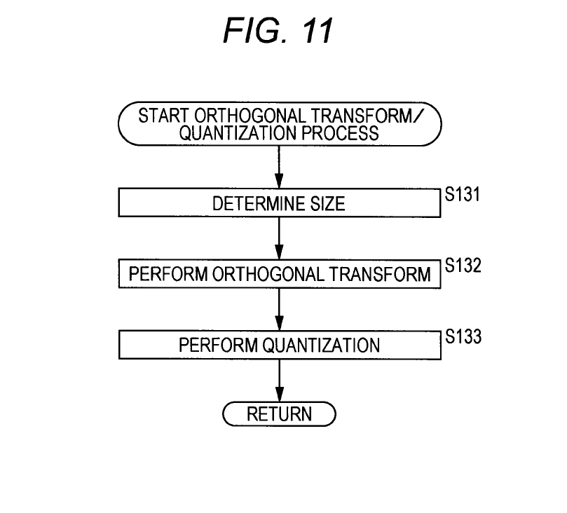

Next, an example of a flow of an orthogonal transform/quantization process performed in step S107 of FIG. 10 will be described with reference to the flowchart of FIG. 11.

When the orthogonal transform/quantization process is started, the selector 131 determines the size of the current block in step S131. In step S132, the orthogonal transformer 132 performs orthogonal transform on prediction error data of the current block of the size determined in step S131.

In step S133, the quantizer 133 quantizes the orthogonal transform coefficient of the prediction error data of the current block obtained in step S132.

When the processing in step S133 is terminated, the process returns to FIG. 10.

### 1-7 Flow of Scaling List Encoding Process

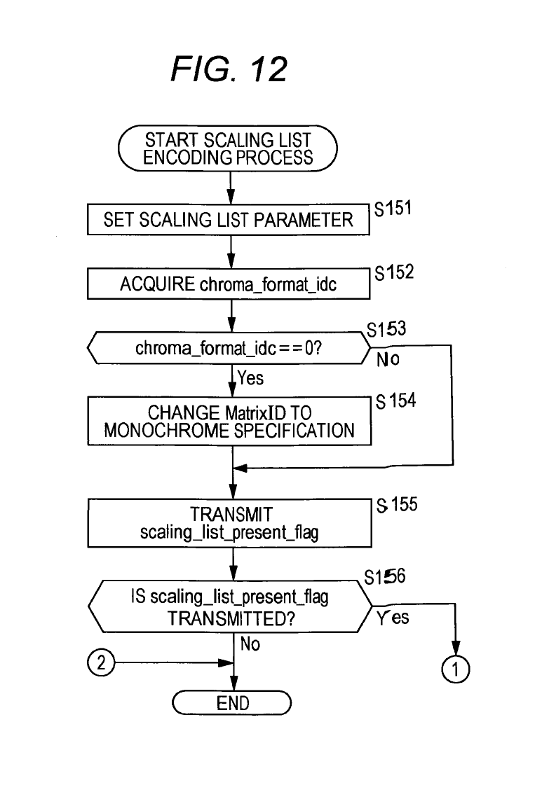

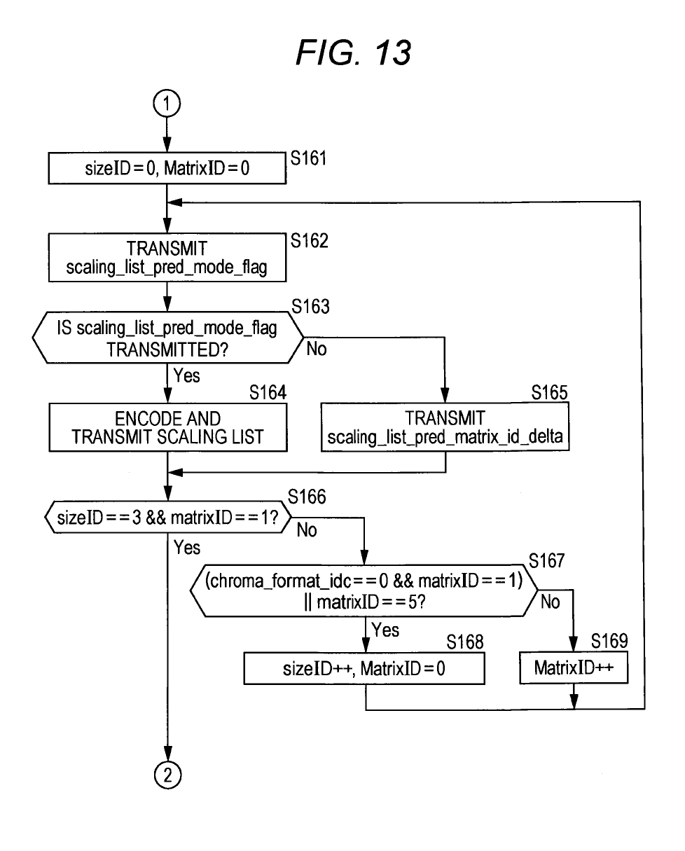

Next, an example of a flow of a scaling list encoding process performed by the matrix processor 135 will be described with reference to the flowcharts of FIGS. 12 and 13. The scaling list encoding process is a process for encoding and transmitting information on scaling lists used for quantization.

When the process is started, the mode controller 212 (FIG. 9) sets scaling list parameters including flag information such as scaling_list_present_flag and scaling_list_pred_mode_flag in step S151 of FIG. 12.

In step S152, the matrix ID controller 211 acquires chroma_format_idc from VUI. In step S153, the matrix ID controller 211 determines whether or not chroma_format_idc is “0”. If chroma_format_idc is determined to be “0”, the process proceeds to step S154.

In step S154, the matrix ID controller 211 changes MatrixIDs to those for a monochrome specification. Specifically, the matrix ID controller 211 selects a pattern in which matrix IDs are assigned only to brightness components as shown in FIG. 5B. When the processing in step S154 is terminated, the process proceeds to step S155.

If chroma_format_idc is determined not to be “0” (not to be monochrome) in step S153, the process proceeds to step S155.

In step S155, the output unit 166 transmits scaling_list_present_flag indicating that information on scaling lists is to be transmitted. If the information on scaling lists is not to be transmitted, this processing is of course omitted. Thus, scaling_list_present_flag is transmitted if scaling_list_present_flag is set in step S151, or this processing is omitted if scaling_list_present_flag is not set.

In step S156, the output unit 166 determines whether or not scaling_list_present_flag is transmitted. If scaling_list_present_flag is determined not to be transmitted in step S155, that is, if information on scaling lists is not to be transmitted, the scaling list encoding process is terminated.

If scaling_list_present_flag is determined to be transmitted in step S156, that is, if information on scaling lists is to be transmitted, the process proceeds to FIG. 13.

In step S161 of FIG. 13, the matrix ID controller 211 sets the size ID and the matrix ID to initial values (“0”, for example) (SizeID=0, MatrixID=0).

In step S162, the output unit 166 transmits scaling_list_pred_mode_flag (of the current scaling list) associated with the current SizeID and MatrixID in the normal mode. If scaling_list_pred_mode_flag is not set in step S151, that is, in the copy mode, this processing is of course omitted.

In step S163, the output unit 166 determines whether or not scaling_list_pred_mode_flag is transmitted. If scaling_list_pred_mode_flag is determined to be transmitted in step S162, that is, in the normal mode, the process proceeds to step S164.

In step S164, processing in the normal mode is performed. For example, the respective processing units such as the prediction matrix generator 172, the difference matrix generator 162, the difference matrix size converter 163, the entropy encoder 164, the decoder 165, and the output unit 166 encode the current scaling list (that is, the scaling list associated with the current SizeID and MatrixID) and transmits the encoded scaling list to the lossless encoder 105. When the processing in step S164 is terminated, the process proceeds to step S166.

If the mode is the copy mode in step S163, that is, if scaling_list_pred_mode_flag is determined not to be transmitted in step S162, the process proceeds to step S165.

In step S165, processing in the copy mode is performed. For example, the copy unit 171 generates scaling_list_pred_matrix_id_delta as in the aforementioned Expression (1), and the output unit 166 transmits this scaling_list_pred_matrix_id_delta to the lossless encoder 105. When the processing in step S165 is terminated, the process proceeds to step S166.

In step S166, the matrix ID controller 211 determines whether or not the size ID is “3” (SizeID==3) and the matrix ID is “1” (MatrixID==1).

If it is determined that the size ID is not “3” (SizeID!=3) or that the matrix ID is not “1” (MatrixID!=1), the process proceeds to step S167.

In step S167, the matrix ID controller 211 determines whether chroma_format_idc is “0” (chroma_format_idc==0) and the matrix ID is “1” (MatrixID==1), or the matrix ID is “5” (MatrixID==5), or neither of these conditions are satisfied.

If it is determined that chroma_format_idc is “0” (chroma_format_idc==0) and the matrix ID is “1” (MatrixID==1), or if it is determined that the matrix ID is “5” (MatrixID==5), the process proceeds to step S168.

In this case, all the matrix IDs for the current size ID are processed. The matrix ID controller 211 thus increments the size ID by “+1” (SizeID++) and sets the matrix ID to “0” (MatrixID=0) in step S168.

When the processing in step S168 is terminated, the process returns to step S162.

If it is determined that the chroma_format_idc is “0” but the matrix ID is not “1” (is “0”), or if it is determined that chroma_format_idc is not “0” (is “1” or larger) and the matrix ID is not “5” (is “4” or smaller) in step S167, the process proceeds to step S169.

In this case a matrix ID that is unprocessed for the current SizeID is present. The matrix ID controller 211 thus increments the matrix ID by “+1” (MatrixID++) in step S169.

When the processing in step S169 is terminated, the process returns to step S162.

Specifically, the processing in steps S162 to S167 and step S169 is repeated and scaling lists of all the matrix IDs for the current size ID are processed.

Furthermore, the processing in steps S162 to S169 is repeated and all the scaling lists are processed.

If it is determined in step S166 that the size ID is “3” (SizeID==3) and the matrix ID is “1” (MatrixID==1), the scaling list encoding process is terminated because all the scaling lists have been processed.

As described above, since the scaling list encoding process is controlled by using the size IDs and the matrix IDs, the image encoding device 100 can omit processing and transmission of information on unnecessary scaling lists, which can reduce the encoding efficiency and reduce the loads of the encoding process.

### 2. Second Embodiment

### 2-1 Image Decoding Device

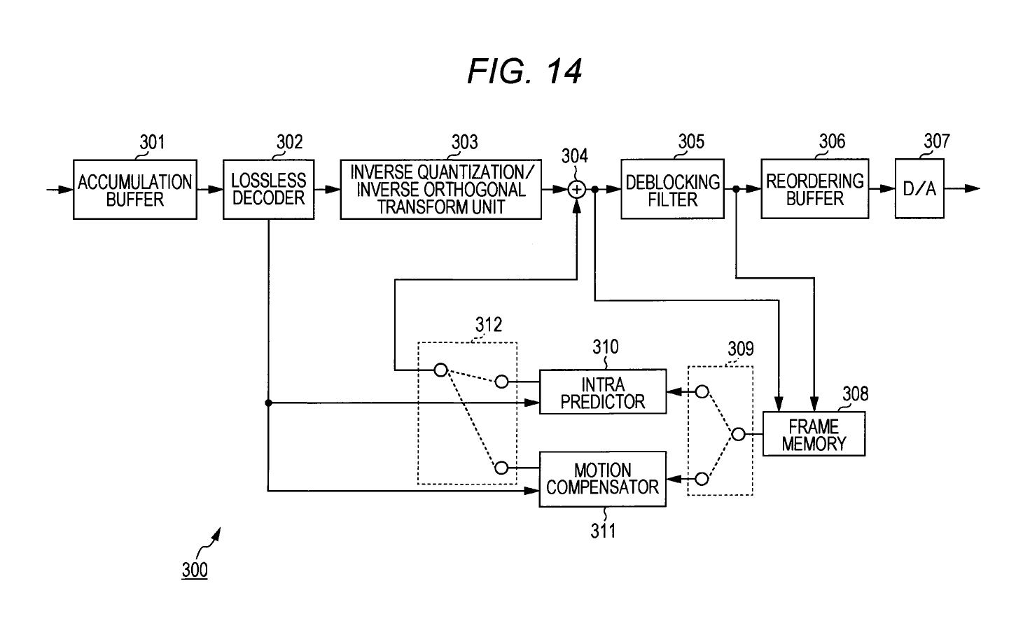

FIG. 14 is a block diagram showing a typical example structure of an image decoding device that is an image processing device to which the present technology is applied. The image decoding device 300 shown in FIG. 14 is an image processing device to which the present technology is applied and which decodes encoded data generated by the image encoding device 100 (FIG. 7). As shown in FIG. 14, the image decoding device 300 includes an accumulation buffer 301, a lossless decoder 302, an inverse quantization/inverse orthogonal transform unit 303, an arithmetic operation unit 304, a deblocking filter 305, a reordering buffer 306, a D/A (Digital to Analogue) converter 307, a frame memory 308, a selector 309, an intra predictor 310, a motion compensator 311, and a selector 312.

The accumulation buffer 301 temporarily stores an encoded stream input through a transmission path by using a storage medium.

The lossless decoder 302 reads out the encoded stream from the accumulation buffer 301 and decodes the encoded stream according to the encoding method used in encoding. The lossless decoder 302 also decodes information multiplexed in the encoded stream. The information multiplexed in the encoded stream can include the aforementioned information on scaling lists, and information on intra prediction and information on inter prediction in the block header. The lossless decoder 302 supplies the decoded quantized data and information for generating scaling lists to the inverse quantization/inverse orthogonal transform unit 303. The lossless decoder 302 also supplies the information on the intra prediction to the intra predictor 310. The lossless decoder 302 also supplies the information on the inter prediction to the motion compensator 311.

The inverse quantization/inverse orthogonal transform unit 303 performs inverse quantization and inverse orthogonal transform on the quantized data supplied from the lossless decoder 302 to generate prediction error data. The inverse quantization/inverse orthogonal transform unit 303 then supplies the generated prediction error data to the arithmetic operation unit 304.

The arithmetic operation unit 304 adds the prediction error data supplied from the inverse quantization/inverse orthogonal transform unit 303 and predicted image data supplied from the selector 312 to generate decoded image data. The arithmetic operation unit 304 then outputs the generated decoded image data to the deblocking filter 305 and the frame memory 308.

The deblocking filter 305 filters the decoded image data input from the arithmetic operation unit 304 to remove the block distortion, and supplies the decoded image data resulting from the filtering to the reordering buffer 306 and the frame memory 308.

The reordering buffer 306 reorders image supplied from the deblocking filter 305 to generate a series of image data in time series. The reordering buffer 306 then supplies the generated image data to the D/A converter 307.

The D/A converter 307 converts the image data in the digital format supplied from the reordering buffer 306 into an image signal in the analog format, and outputs the image signal in the analog format to outside of the image decoding device 300. For example, the D/A converter 307 outputs the image signal in analog format on a display (not shown) connected to the image decoding device 300 to display the image.

The frame memory 308 stores the decoded image data before the filtering input from the arithmetic operation unit 304 and the decoded image data resulting from the filtering input from the deblocking filter 305 by using a storage medium.

The selector 309 switches the component to which the image data from the frame memory 308 is output between the intra predictor 310 and the motion compensator 311 for each block in the image according to the mode information obtained by the lossless decoder 302. For example, when the intra prediction mode is selected, the selector 309 supplies the decoded image data before the filtering supplied from the frame memory 308 as reference image data to the intra predictor 310. When the inter prediction mode is selected, the selector 309 supplies the decoded image data resulting from the filtering supplied from the frame memory 308 as the reference image data to the motion compensator 311.

The intra predictor 310 performs intra-frame prediction of pixel values on the basis of the information on the intra prediction supplied from the lossless decoder 302 and the reference image data supplied from the frame memory 308 to generate predicted image data. The intra predictor 310 then supplies the generated predicted image data to the selector 312.

The motion compensator 311 performs motion compensation on the basis of the information on the inter prediction supplied from the lossless decoder 302 and the reference image data supplied from the frame memory 308 to generate predicted image data. The motion compensator 311 then supplies the generated predicted image data to the selector 312.

The selector 312 switches the source of the predicted image data to be supplied to the arithmetic operation unit 304 between the intra predictor 310 and the motion compensator 311 for each block in the image according to the mode information obtained by the lossless decoder 302. For example, when the intra prediction mode is specified, the selector 312 supplies the predicted image data output from the intra predictor 310 to the arithmetic operation unit 304. In contrast, for example, when the inter prediction mode is specified, the selector 312 supplies the predicted image data output from the motion compensator 311 to the arithmetic operation unit 304.

### 2-2 Inverse Quantization/Inverse Orthogonal Transform Unit

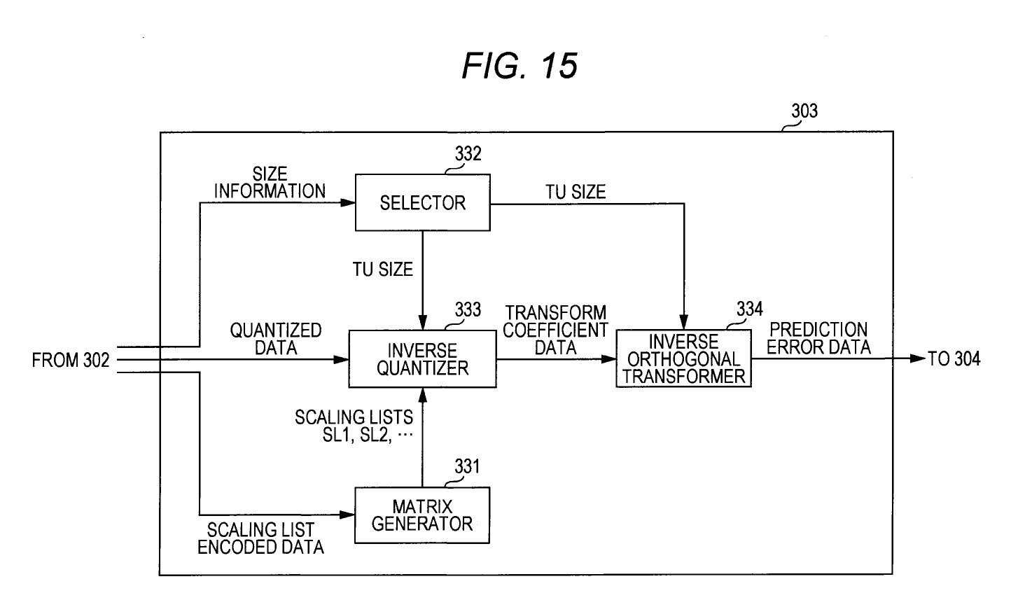

FIG. 15 is a block diagram showing a typical example structure of the inverse quantization/inverse orthogonal transform unit 303 of FIG. 14.

As shown in FIG. 15, the inverse quantization/inverse orthogonal transform unit 303 includes a matrix generator 331, a selector 332, an inverse quantizer 333, and an inverse orthogonal transformer 334.

The matrix generator 331 decodes encoded data of information on scaling lists extracted from a bit stream by the lossless decoder 302 and supplied thereto to generate scaling lists. The matrix generator 331 supplies the generated scaling lists to the inverse quantizer 333.

The selector 332 selects a unit of transform (TU) used for inverse orthogonal transform of image data to be decoded from among multiple units of transform of different sizes. Candidates for the size of the unit of transform that can be selected by the selector 332 includes 4×4 and 8×8 in the H.264/AVC, and 4×4 (SizeID==0), 8×8 (SizeID==1), 16×16 (SizeID==2), and 32×32 (SizeID==3) in the HEVC, for example. The selector 332 may select a unit of transform on the basis of LCU, SCU, and split flag contained in the header of the encoded stream, for example. The selector 332 then supplies information specifying the selected size of the unit of transform to the inverse quantizer 333 and the inverse orthogonal transformer 334.

The inverse quantizer 333 performs inverse quantization on transform coefficient data quantized in encoding of the image by using a scaling list associated with the unit of transform selected by the selector 332. The inverse quantizer 333 then supplies the transform coefficient data subjected to inverse quantization to the inverse orthogonal transformer 334.

The inverse orthogonal transformer 334 performs inverse orthogonal transform on the transform coefficient data subjected to inverse quantization by the inverse quantizer 333 in the selected unit of transform according to the orthogonal transform method used in encoding to generate prediction error data. The inverse orthogonal transformer 334 then supplies the generated prediction error data to the arithmetic operation unit 304.

### 2-3 Matrix Generator

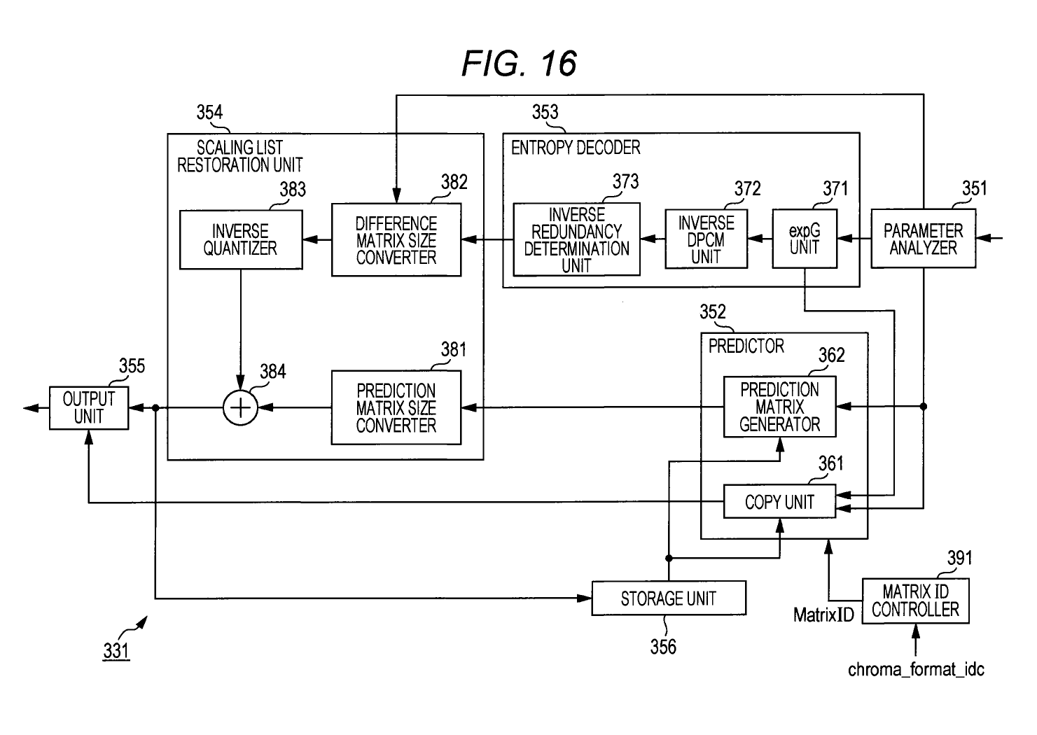

FIG. 16 is a block diagram showing a typical example structure of the matrix generator 331 of FIG. 15. As shown in FIG. 16, the matrix generator 331 includes a parameter analyzer 351, a predictor 352, an entropy decoder 353, a scaling list restoration unit 354, an output unit 355, and a storage unit 356.

The parameter analyzer 351 analyzes various flags and parameters relating to scaling lists supplied from the lossless decoder 302 (FIG. 14). The parameter analyzer 351 controls the respective components according to the analysis result.

For example, when scaling_list_pred_mode_flag is not present, the parameter analyzer 351 determines that the mode is the copy mode. In this case, the parameter analyzer 351 supplies an exponential golomb code of scaling_list_pred_matrix_id_delta to an expG unit 371 of the entropy decoder 353, for example. The parameter analyzer 351 controls the expG unit 371 to decode the unsigned exponential golomb code, for example. The parameter analyzer 351 also controls the expG unit 371 to supply scaling_list_pred_matrix_id_delta resulting from decoding to a copy unit 361 of the predictor 352, for example.

When the mode is determined to be the copy mode, the parameter analyzer 351 controls the copy unit 361 of the predictor 352 to calculate a reference matrix ID (RefMatrixID) from scaling_list_pred_matrix_id_delta, for example. The parameter analyzer 351 further controls the copy unit 361 to identify a reference scaling list by using the calculated reference matrix ID and generate the current scaling list by copying the reference scaling list, for example. The parameter analyzer 351 further controls the copy unit 361 to supply the generated current scaling list to the output unit 355, for example.

When scaling_list_pred_mode_flag is present, the parameter analyzer 351 determines that the mode is the normal mode, for example. In this case, the parameter analyzer 351 supplies an exponential golomb code a difference value between the scaling list used for quantization and a predicted value thereof to the expG unit 371 of the entropy decoder 353, for example. The parameter analyzer 351 also controls a prediction matrix generator 362 to generate a prediction matrix.

The predictor 352 generates the prediction matrix and the current scaling list according to the control of the parameter analyzer 351. As shown in FIG. 16, the predictor 352 includes the copy unit 361 and a prediction matrix generator 362.

In the copy mode, the copy unit 361 copies the reference scaling list as the current scaling list. More specifically, the copy unit 361 calculates a reference matrix ID (RefMatrixID) from scaling_list_pred_matrix_id_delta supplied from the expG unit 371, and reads out a reference scaling list associated with the reference matrix ID from the storage unit 356. The copy unit 361 copies the reference scaling list to generate the current scaling list. The copy unit 361 supplies the thus generated current scaling list to the output unit 355.

In the normal mode, the prediction matrix generator 362 generates (predicts) a prediction matrix by using previously transmitted scaling lists. Thus, the prediction matrix generator 362 generates a prediction matrix similar to that generated by the prediction matrix generator 172 (FIG. 7) of the image encoding device 100. The prediction matrix generator 362 supplies the generated prediction matrix to a prediction matrix size converter 381 of the scaling list restoration unit 354.

The entropy decoder 353 decodes the exponential golomb code supplied from the parameter analyzer 351. As shown in FIG. 16, the entropy decoder 353 includes the expG unit 371, an inverse DPCM unit 372, and an inverse redundancy determination unit 373.

The expG unit 371 performs signed or unsigned exponential golomb decoding (hereinafter also referred to as exponential golomb decoding) to restore DPCM data. The expG unit 371 supplies the restored DPCM data to the inverse DPCM unit 372.

The expG unit 371 also decodes an unsigned exponential golomb code of scaling_list_pred_matrix_id_delta to obtain scaling_list_pred_matrix_id_delta that is a parameter representing a reference. Upon obtaining scaling_list_pred_matrix_id_delta, the expG unit 371 supplies scaling_list_pred_matrix_id_delta that is the parameter representing the reference to the copy unit 361 of the predictor 352.

The inverse DPCM unit 372 performs DPCM decoding on data from which redundant parts are deleted to generate residual data from the DPCM data. The inverse DPCM unit 372 supplies the generated residual data to the inverse redundancy determination unit 373.

When the residual data is data resulting from deleting redundant symmetric data (matrix elements) of a symmetric matrix of 135 degrees, the inverse redundancy determination unit 373 restores data of the symmetric parts. Thus, the difference matrix of the symmetric matrix of 135 degrees is restored. When the residual data is not a symmetric matrix of 135 degrees, the inverse redundancy determination unit 373 uses the residual data as the difference matrix without restoring data of symmetric parts. The inverse redundancy determination unit 373 supplies the difference matrix restored in this manner to the scaling list restoration unit 354 (a difference matrix size converter 382).

The scaling list restoration unit 354 restores the scaling lists. As shown in FIG. 16, the scaling list restoration unit 354 includes the prediction matrix size converter 381, the difference matrix size converter 382, an inverse quantizer 383, and an arithmetic operation unit 384.

The prediction matrix size converter 381 converts the size of the prediction matrix supplied from the predictor 352 (the prediction matrix generator 362) when the size of the prediction matrix is different from that of the restored current scaling list.

For example, when the size of the prediction matrix is larger than that of the current scaling list, the prediction matrix size converter 381 down-converts the prediction matrix. Alternatively, for example, when the size of the prediction matrix is smaller than that of the current scaling list, the prediction matrix size converter 381 up-converts the prediction matrix. The same method as that for the prediction matrix size converter 181 (FIG. 9) of the image encoding device 10 is selected as the conversion method.

The prediction matrix size converter 381 supplies a prediction matrix with the size matched with that of the current scaling list to the arithmetic operation unit 384.

When the size of the transmitted difference matrix is smaller than that of the current scaling list, the difference matrix size converter 382 up-converts the size of the difference matrix to the size of the current scaling list. Any method may be used for the up-conversion. For example, the up-conversion may be associated with the method of down-conversion performed by the difference matrix size converter 163 (FIG. 9) of the image encoding device 100.

For example, when the difference matrix size converter 163 downsampled the difference matrix, the difference matrix size converter 382 may upsample the difference matrix. When the difference matrix size converter 163 subsampled the difference matrix, the difference matrix size converter 382 may perform inverse subsampling on the difference matrix.

When the difference matrix having the same size as that used in quantization is transmitted, the difference matrix size converter 382 may omit up-conversion of the difference matrix (or may perform up-conversion of multiplication by 1).

The difference matrix size converter 382 supplies the difference matrix subjected to up-conversion where necessary to the inverse quantizer 383.

The inverse quantizer 383 performs inverse quantization on the supplied difference matrix (quantized data) by a method corresponding to the quantization for the quantizer 183 (FIG. 9) of the image encoding device 100, and supplies the difference matrix resulting from the inverse quantization to the arithmetic operation unit 384. When the quantizer 183 is not provided, that is, when the difference matrix supplied from the difference matrix size converter 382 is not quantized data, the inverse quantizer 383 can be omitted.

The arithmetic operation unit 384 adds the prediction matrix supplied from the prediction matrix size converter 381 and the difference matrix supplied from the inverse quantizer 383 to restore the current scaling list. The arithmetic operation unit 384 supplies the restored scaling list to the output unit 355 and the storage unit 356.

The output unit 355 outputs the information supplied thereto to outside of the matrix generator 331. In the copy mode, for example, the output unit 355 supplies the current scaling list supplied from the copy unit 361 to the inverse quantizer 383. In the normal mode, for example, the output unit 355 supplies the scaling list in the current region supplied from the scaling list restoration unit 354 (the arithmetic operation unit 384) to the inverse quantizer 383.

The storage unit 356 stores the scaling list supplied from the scaling list restoration unit 354 (the arithmetic operation unit 384) together with the matrix ID (MatrixID) thereof. The information on the scaling list stored in the storage unit 356 is used for generation of another prediction matrix in the unit of orthogonal transform to be processed later in time. Thus, the storage unit 356 supplies the stored information on scaling lists as information on reference scaling lists to the predictor 352, etc.

The matrix generator 331 also includes a matrix ID controller 391. The matrix ID controller 391 acquires chroma_format_idc from VUI (Video usability information) and controls the assignment pattern of matrix IDs on the basis of the value of chroma_format_idc, for example.

For example, as described above, assume that a pattern in which matrix IDs are assigned to both of brightness components and color components (FIG. 4) and a pattern in which matrix IDs are assigned only to brightness components (FIG. 5B) are provided as the assignment patterns of matrix IDs. When the value of chroma_format_idc is “0”, for example, the matrix ID controller 391 selects the pattern in which matrix IDs are assigned only to brightness components is selected, and otherwise, the pattern in which matrix IDs are assigned to both of brightness components and color components is selected.

When the size ID (SizeID) is “3” or larger, the matrix ID controller 391 selects the pattern in which matrix IDs are assigned only to brightness components (FIG. 4 and FIG. 5B).

The matrix ID controller 391 supplies control information indicating the assignment pattern of matrix IDs selected as described above to the predictor 352.

The copy unit 361 or the prediction matrix generator 362 (either one associated with the selected mode) of the predictor 352 performs the aforementioned process according to the assignment pattern. As a result, the copy unit 361 and the prediction matrix generator 362 can perform the processes on scaling lists for color components only where necessary, which can not only realize improvement in the coding efficiency but also reduce loads of the respective processes. The load of the encoding process is thus reduced.

As described above, the parameter analyzer 351 through the storage unit 356 performs processing on scaling lists for color components only where necessary in the mode determined by the parameter analyzer 351. The image decoding device 300 can therefore realize suppression of increase in the code amount for transmitting information on scaling lists and realize improvement in the coding efficiency. The image decoding device 300 can also suppress increase in the load of the decoding process.

### 2-4 Flow of Decoding Process

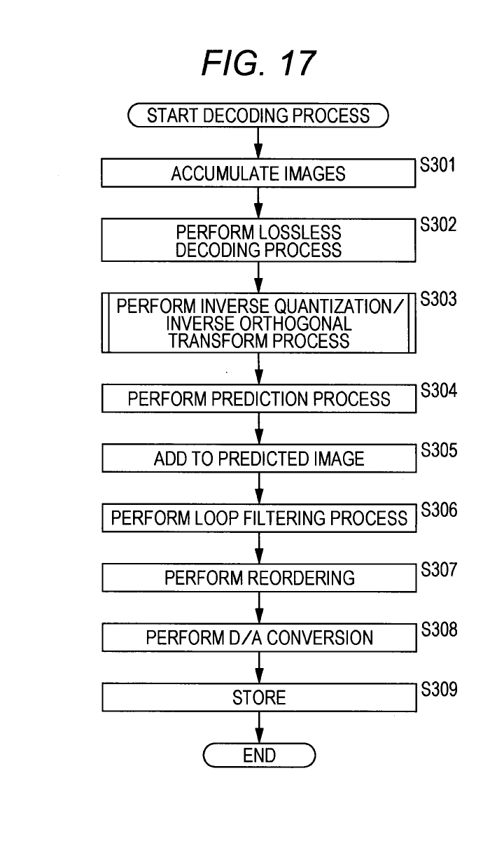

Next, various processes performed by the image decoding device 300 will be described. First, an example of a flow of a decoding process will be described with reference to the flowchart of FIG. 17.

When the decoding process is started, the accumulation buffer 301 accumulates encoded data being transmitted in step S301. In step S302, the lossless decoder 302 decodes the encoded data supplied from the accumulation buffer 301. Specifically, I-pictures, P-pictures, and B-pictures encoded by the lossless encoder 105 in FIG. 7 are decoded.

In this process, motion vector information, reference frame information, prediction mode information (intra prediction mode or inter prediction mode), and information on parameters and the like relating to quantization are also decoded.

In step S303, the inverse quantization/inverse orthogonal transform unit 303 performs an inverse quantization/inverse orthogonal transform process to perform inverse quantization on the quantized orthogonal transform coefficient obtained by the processing in step S302 and further perform inverse orthogonal transform on the resulting orthogonal transform coefficient.

As a result, difference information corresponding to the input to the orthogonal transform/quantization unit 104 (the output from the arithmetic operation unit 103) of FIG. 7 is decoded.

In step S304, the intra predictor 310 or the motion compensator 311 performs a prediction process on the image according to the prediction mode information supplied from the lossless decoder 302. Specifically, when intra prediction mode information is supplied from the lossless decoder 302, the intra predictor 310 performs an intra prediction process in the intra prediction mode. In contrast, when inter prediction mode information is supplied from the lossless decoder 302, the motion compensator 311 performs an inter prediction process (including motion estimation and motion compensation).

In step S305, the arithmetic operation unit 304 adds the predicted image obtained by the processing in step S304 to the difference information obtained by the processing in step S303. As a result, the original image data (reconstructed image) is decoded.

In step S306, the deblocking filter 305 performs a loop filtering process including deblocking filtering and adaptive loop filtering where appropriate on the reconstructed image obtained by the processing in step S305.

In step S307, the frame reordering buffer 306 reorders the frames of the decoded image data. Specifically, the frames reordered for encoding by the frame reordering buffer 102 (FIG. 7) of the image encoding device 100 are reordered into the original display order.

In step S308, the D/A converter 307 performs D/A conversion on the decoded image data having the frames reordered by the frame reordering buffer 306. The decoded image data is output to the display (not shown) and the image is displayed thereon.

In step S309, the frame memory 308 stores the decoded image resulting from the filtering by the processing in step S306.

### 2-5 Flow of Inverse Quantization/Inverse Orthogonal Transform Process

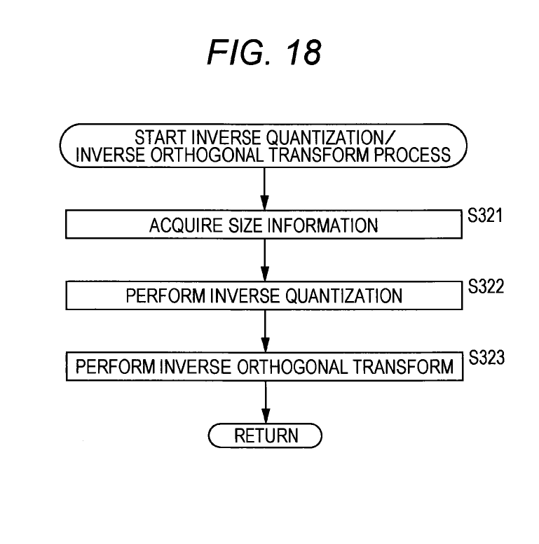

Next, an example of a flow of an inverse quantization/inverse orthogonal transform process performed in step S303 of FIG. 17 will be described with reference to the flowchart of FIG. 18.

When an inverse quantization process is started, the selector 332 acquires size information transmitted from the encoding side from the lossless decoder 302 and determines the TU size of the current block in step S321.

In step S322, the inverse quantizer 333 acquires quantized data transmitted from the encoding side for the current block of the TU size obtained from the lossless decoder 302 in step S321, and performs inverse quantization on the quantized data.

In step S323, the inverse orthogonal transformer 334 performs inverse orthogonal transform on the orthogonal transform coefficient obtained by the inverse quantization in step S322.

When the processing in step S323 is terminated, the process returns to FIG. 17.

### 2-6 Flow of Scaling list Decoding Process

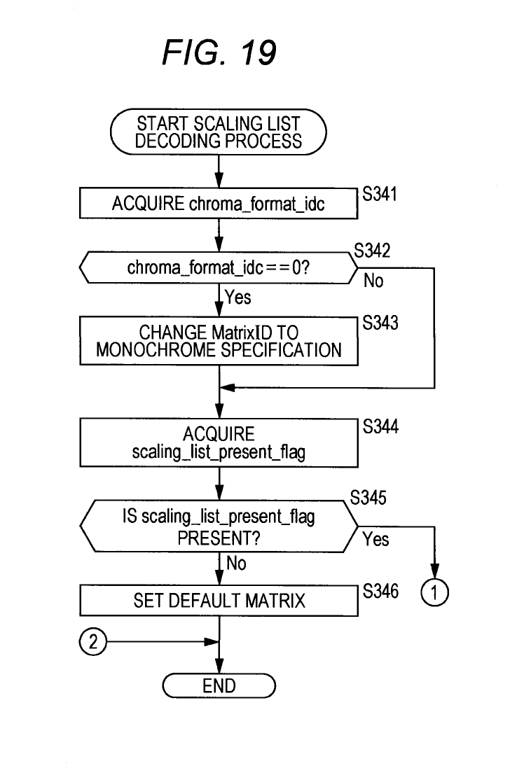

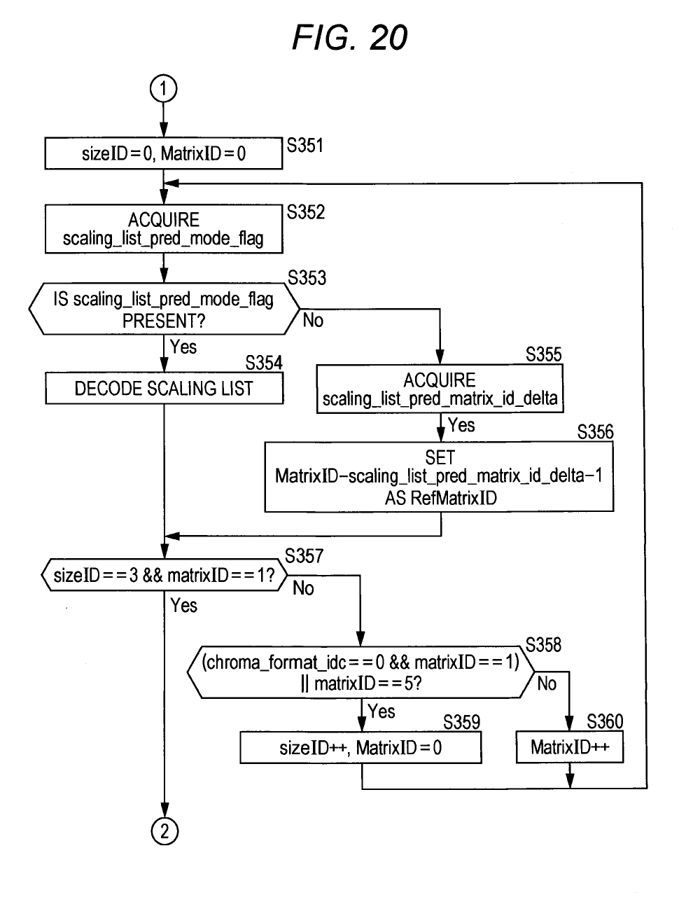

Next, an example of a flow of a scaling list decoding process performed by the matrix generator 331 will be described with reference to the flowcharts of FIGS. 19 and 20. The scaling list decoding process is a process for decoding encoded information on scaling lists used for quantization.

When the process is started, the matrix ID controller 391 acquires chroma_format_idc from VUI in step S341 of FIG. 19. In step S342, the matrix ID controller 391 determines whether or not chroma_format_idc is “0”. If chroma_format_idc is determined to be “0”, the process proceeds to step S343.

In step S343, the matrix ID controller 391 changes MatrixIDs to those for a monochrome specification. Specifically, the matrix ID controller 391 selects a pattern in which matrix IDs are assigned only to brightness components as shown in FIG. 5B. When the processing in step S343 is terminated, the process proceeds to step S344.

If chroma_format_idc is determined not to be “0” (not to be monochrome) in step S342, the process proceeds to step S344. Thus, in this case, the pattern in which matrix IDs are assigned to brightness components and color difference components as shown in FIG. 4 is selected.

In step S344, the parameter analyzer 351 acquires scaling_list_present_flag indicating that information on scaling lists is transmitted. For example, the lossless decoder 302 extracts scaling_list_present_flag from APS and supplies scaling_list_present_flag to the matrix generator 331. The parameter analyzer 351 acquires the scaling_list_present_flag.

When information on scaling lists is not transmitted, scaling_list_present_flag indicating that information on scaling lists is transmitted is not transmitted. Thus, in this case, the processing in step S344 results in failure (scaling_list_present_flag cannot be acquired).

In step S345, the parameter analyzer 351 determines the result of processing in step S344. Specifically, the parameter analyzer 351 determines whether or not scaling_list_present_flag is present (whether or not scaling_list_present_flag can be acquired in step S344).

If scaling_list_present_flag is determined not to be present, the process proceeds to step S346.

In this case, since information scaling lists is not transmitted, the output unit 355 sets and outputs a default matrix that is a predetermined scaling list provided in advance as the current scaling list in step S346. When the processing in step S346 is terminated, the scaling list decoding process is terminated.

If scaling_list_present_flag is determined to be present in step S345, that is, if acquisition of scaling_list_present_flag is determined to be successful in step S344, the process proceeds to FIG. 20.

In step S351 of FIG. 20, the matrix ID controller 391 sets the size ID and the matrix ID to initial values (“0”, for example) (SizeID=0, MatrixID=0).

In step S352, the parameter analyzer 351 acquires scaling_list_pred_mode_flag (of the current scaling list) associated with the current SizeID and MatrixID.

For example, the lossless decoder 302 extracts scaling_list_pred_mode_flag from APS and supplies scaling_list_pred_mode_flag to the matrix generator 331. The parameter analyzer 351 acquires the scaling_list_pred_mode_flag.

In the copy mode, this scaling_list_pred_mode_flag is not transmitted. Thus, in this case, the processing in step S352 results in failure (scaling_list_pred_mode_flag cannot be acquired).

In step S353, the parameter analyzer 351 determines the result of processing in step S352. Specifically, the parameter analyzer 351 determines whether or not scaling_list_pred_mode_flag is present (whether or not scaling_list_pred_mode_flag can be acquired in step S352).

If scaling_list_pred_mode_flag is determined not to be present, the process proceeds to step S354.

In this case, the mode is the normal mode. Thus, inn step S354, processing in the normal mode is performed. For example, the respective processing units such as the prediction matrix generator 362, the entropy decoder 353, the scaling list restoration unit 354, the output unit 355, and the storage unit 356 decode encoded data of the current scaling list (that is, the scaling list associated with the current SizeID and MatrixID) to obtain the current scaling list. Upon obtaining the current scaling list, the output unit 355 supplies the current scaling list to the inverse quantizer 333.

When the processing in step S354 is terminated, the process proceeds to step S357.

If scaling_list_pred_mode_flag is determined to be present in step S353, that is, if acquisition of scaling_list_pred_mode_flag is determined to be successful in step S352, the process proceeds to step S355.

In this case, the mode is the copy mode. Thus, in steps S355 and S356, processing in the copy mode is performed.

In step S355, the copy unit 361 acquires scaling_list_pred_matrix_id_delta. For example, the lossless decoder 302 extracts scaling_list_pred_matrix_id_delta from encoded data transmitted from the image encoding device 100 and supplies scaling_list_pred_matrix_id_delta to the matrix generator 331. The copy unit 361 acquires the scaling_list_pred_matrix_id_delta.

In step S356, the copy unit 361 sets (MatrixID-scaling_list_pred_matrix_id_delta−1) as the reference matrix ID (RefMatrixID). The copy unit 361 acquires the reference scaling list identified by the reference matrix ID (RefMatrixID) from the storage unit 356, and copies the reference scaling list as the current scaling list. The output unit 355 supplies the current scaling list to the inverse quantizer 333.

When the processing in step S356 is terminated, the process proceeds to step S357.

In step S357, the matrix ID controller 391 determines whether or not the size ID is “3” (SizeID==3) and the matrix ID is “1” (MatrixID==1).

If it is determined that the size ID is not “3” (SizeID!=3) or that the matrix ID is not “1” (MatrixID!=1), the process proceeds to step S358.

In step S358, the matrix ID controller 391 determines whether chroma_format_idc is “0” (chroma_format_idc==0) and the matrix ID is “1” (MatrixID==1), or the matrix ID is “5” (MatrixID==5), or neither of these conditions are satisfied.

If it is determined that chroma_format_idc is “0” (chroma_format_idc==0) and the matrix ID is “1” (MatrixID==1), or if it is determined that the matrix ID is “5” (MatrixID==5), the process proceeds to step S359.

In this case, all the matrix IDs for the current size ID are processed. The matrix ID controller 391 thus increments the size ID by “+1” (SizeID++) and sets the matrix ID to “0” (MatrixID=0) in step S359.

When the processing in step S359 is terminated, the process returns to step S352.

If it is determined that the chroma_format_idc is “0” but the matrix ID is not “1” (is “0”), or if it is determined that chroma_format_idc is not “0” (is “1” or larger) and the matrix ID is not “5” (is “4” or smaller) in step S358, the process proceeds to step S360.

In this case a matrix ID that is unprocessed for the current SizeID is present. The matrix ID controller 391 thus increments the matrix ID by “+1” (MatrixID++) in step S360.

When the processing in step S360 is terminated, the process returns to step S352.

Specifically, the processing in steps S352 to S358 and step S360 is repeated and encoded data of scaling lists of all the matrix IDs for the current size ID are decoded.

Furthermore, the processing in steps S352 to S360 is repeated and encoded data of all the scaling lists are decoded.

If it is determined in step S357 that the size ID is “3” (SizeID==3) and the matrix ID is “1” (MatrixID==1), this means that encoded data of all the scaling lists have been decoded, and the scaling list decoding process is thus terminated.

As described above, since the scaling list decoding process is controlled by using the size IDs and the matrix IDs, the image decoding device 300 can realize omission of processing and transmission of information on unnecessary scaling lists, which can realize reduction in the coding efficiency and reduce the loads of the decoding process.

### 3. Third Embodiment

### 3-1 Another Example of Syntax

As described above, in the copy mode, scaling_list_pred_matrix_id_delta is transmitted as information representing a reference scaling list. IF only one scaling list that can be the reference scaling list (that is, if only one candidate for the reference is present), the image decoding device 300 can identify the reference (the reference scaling list) without scaling_list_pred_matrix_id_delta.

For example, when chroma_format_idc is “0” and the assignment pattern of matrix IDs is set as in FIG. 5B, there are only two scaling lists. In such a case, only one scaling list can be the reference scaling list, which is the other scaling list. Thus, in such a case, scaling_list_pred_matrix_id_delta that is a parameter indicating the reference is unnecessary.

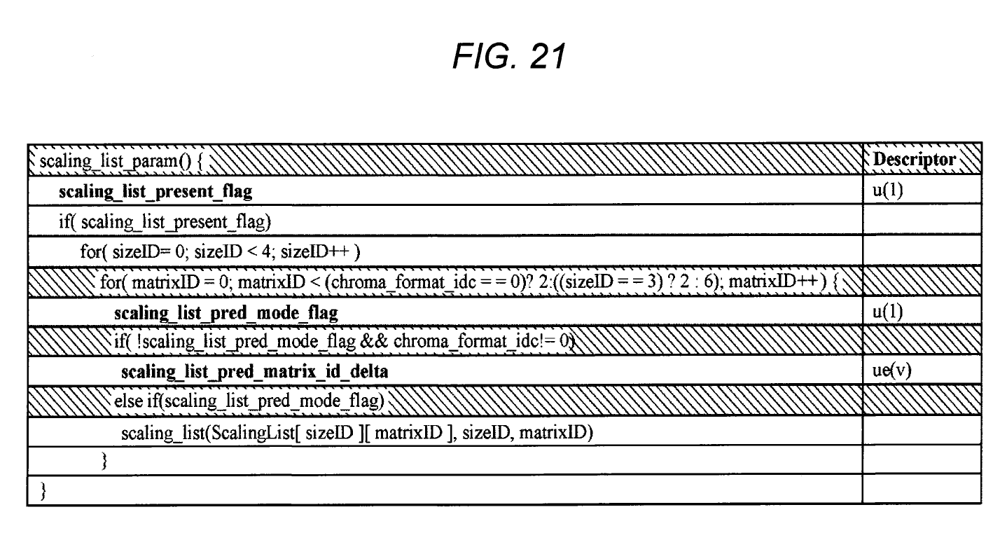

When the reference scaling list is obvious in this manner, transmission of scaling_list_pred_matrix_id_delta that is information for identifying the reference scaling list may be omitted. FIG. 21 is a table for explaining an example of syntax of the scaling list in this case.

In the syntax of the example of FIG. 21, in addition to the control similar to that of the example of

FIG. 6, control is made so that identification information (chroma_format_idc) of a chroma format is checked on the seventh line from the top, scaling_list_pred_matrix_id_delta is acquired when chroma_format_idc is not “0”, and scaling_list_pred_matrix_id_delta is not acquired when chroma_format_idc is “0”.

In other words, the image encoding device 100 transmits scaling_list_pred_matrix_id_delta when the chroma format is not monochrome, and does not transmit scaling_list_pred_matrix_id_delta when the chroma format is monochrome in accordance with the syntax.

Furthermore, the image decoding device 300 acquires scaling_list_pred_matrix_id_delta when the chroma format is not monochrome, and does not acquire scaling_list_pred_matrix_id_delta when the chroma format is monochrome in accordance with the syntax.

In this manner, as a result of omitting transmission of scaling_list_pred_matrix_id_delta, the image encoding device 100 can further improve the coding efficiency. Since calculation of scaling_list_pred_matrix_id_delta can also be omitted, the image encoding device 100 can further reduce the loads of the encoding process.

In addition, as a result of omitting transmission of scaling_list_pred_matrix_id_delta in this manner, the image decoding device 300 can realize further improvement in the coding efficiency. Since acquisition of scaling_list_pred_matrix_id_delta can also be omitted, the image decoding device 300 can further reduce the loads of the decoding process.

### 3-2 Flow of Scaling List Encoding Process

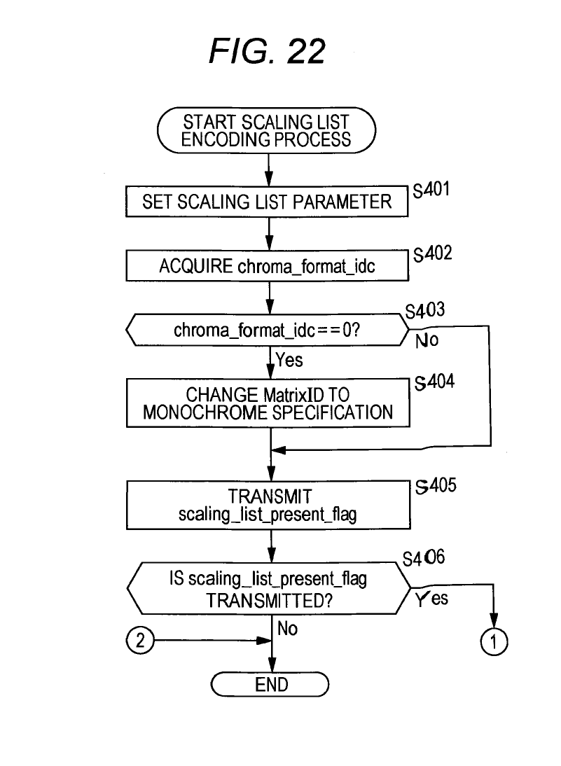

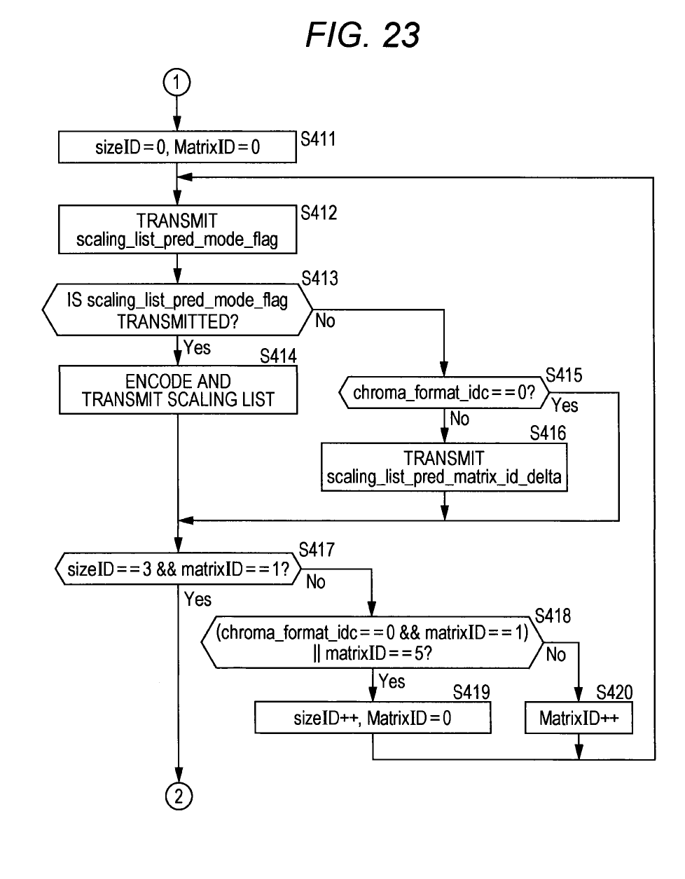

An example of a flow of a scaling list encoding process performed by the image encoding device 100 in this case will be described with reference to the flowcharts of FIGS. 22 and 23.

As shown in FIGS. 22 and 23, processing in this case is performed basically in the same manner as described with reference to the flowcharts of FIGS. 12 and 13.

For example, processing in steps S401 to S406 of FIG. 22 is performed in the same manner as the processing in steps S151 to S156 of FIG. 12.

Furthermore, processing in steps S411 to S414 of FIG. 23 is also performed in the same manner as the processing in steps S161 to S164 of FIG. 13.

In step S413 of FIG. 23, however, in the copy mode, that is, when it is determined that scaling_list_pred_mode_flag is not transmitted, the process proceeds to step S415.

In step S415, the matrix ID controller 211 determines whether or not chroma_format_idc is “0”. If chroma_format_idc is determined not to be “0” (chroma_ format_ idc!=0), the process proceeds to step S416.

Processing in step S416 is performed similarly to the processing in step S165 of FIG. 13. When the processing in step S416 is terminated, the process proceeds to step S417.

If chroma_format_idc is determined to be “0” (chroma_format_idc==0) in step S415, the processing in step S416 is omitted and the process proceeds to step S417.

As described above, the parameter scaling_list_pred_matrix_id_delta indicating the reference is transmitted only when chroma_format_idc is determined not to be “0”.

The other processing is the same as in the example of FIGS. 12 and 13, and processing in steps S417 to S420 is performed in the same manner as the processing in steps S166 to S169 in FIG. 13.

As a result of such control, the image encoding device 100 can improve the coding efficiency and reduce the loads of the encoding process.

### 3-3 Flow of Scaling List Decoding Process

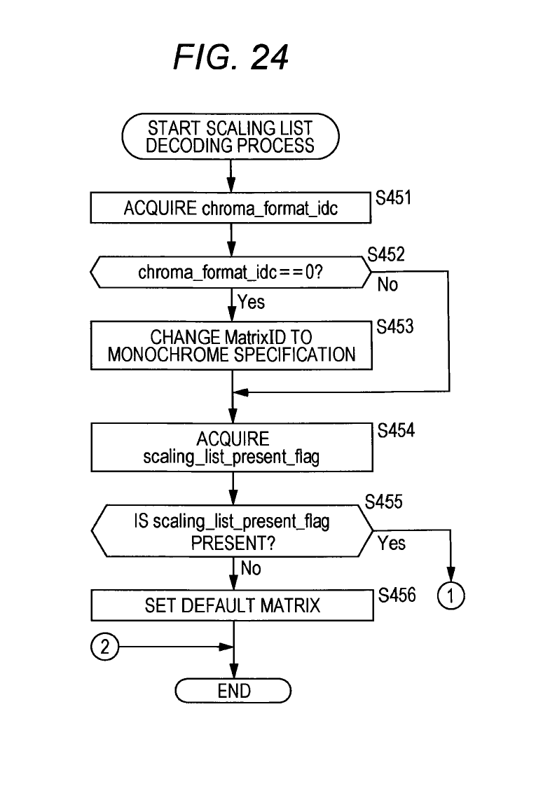

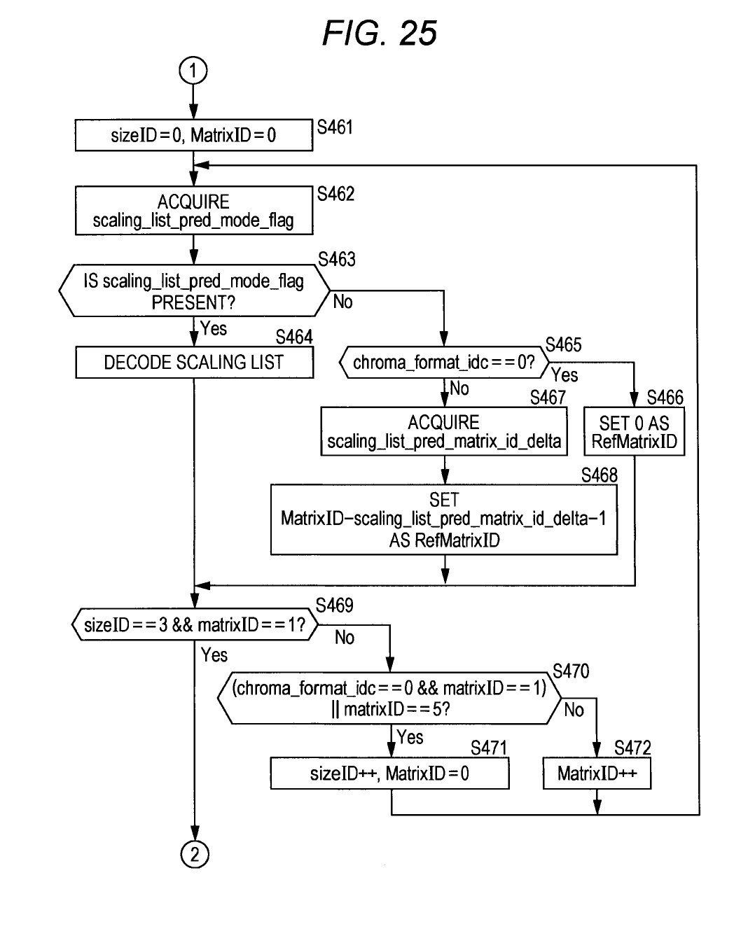

An example of a flow of a scaling list decoding process performed by the image decoding device 300 in this case will be described with reference to the flowcharts of FIGS. 24 and 25.

As shown in FIGS. 24 and 25, processing in this case is performed basically in the same manner as described with reference to the flowcharts of FIGS. 19 and 20.

For example, processing in steps S451 to S456 of FIG. 24 is performed in the same manner as the processing in steps S341 to S346 of FIG. 19.

Furthermore, processing in steps S461 to S464 of FIG. 25 is also performed in the same manner as the processing in steps S351 to S354 of FIG. 20.

In step S463 of FIG. 25, however, in the copy mode, that is, when it is determined that scaling_list_pred_mode_flag is not present, the process proceeds to step S465.

In step S465, the matrix ID controller 391 determines whether or not chroma_format_idc is “0”. If chroma_format_idc is determined to be “0” (chroma_format_idc==0), the process proceeds to step S466.

In step S466, since scaling_list_pred_matrix_id_delta is not transmitted, the copy unit 361 sets “0” as the reference matrix ID (RefMatrixID). When the processing in step S466 is terminated, the process proceeds to step S469.

If chroma_format_idc is determined not to be “0” (chroma_format_idc!=0) in step S465, the process proceeds to step S467.

Processing in steps S467 and S468 is performed in the same manner as the processing in steps S355 and S356 of FIG. 20.

Thus, the parameter scaling_list_pred_matrix_id_delta indicating the reference is transmitted only when chroma_format_idc is determined not to be “0”. The reference scaling list is then identified on the basis of scaling_list_pred_matrix_id_delta that is the parameter indicating the reference. If chroma_format_idc is determined to be “0”, the parameter scaling_list_pred_matrix_id_delta indicating the reference is not transmitted but a scaling list that is obviously the reference scaling list is set.

The other processing is the same as in the example of FIGS. 19 and 20, and processing in steps S469 to S472 is performed in the same manner as the processing in steps S357 to S360 in FIG. 20.

As a result of such control, the image decoding device 300 can realize improvement in the coding efficiency and reduce the loads of the decoding process.

### 4. Fourth Embodiment

### 4-1 Another Example of Syntax

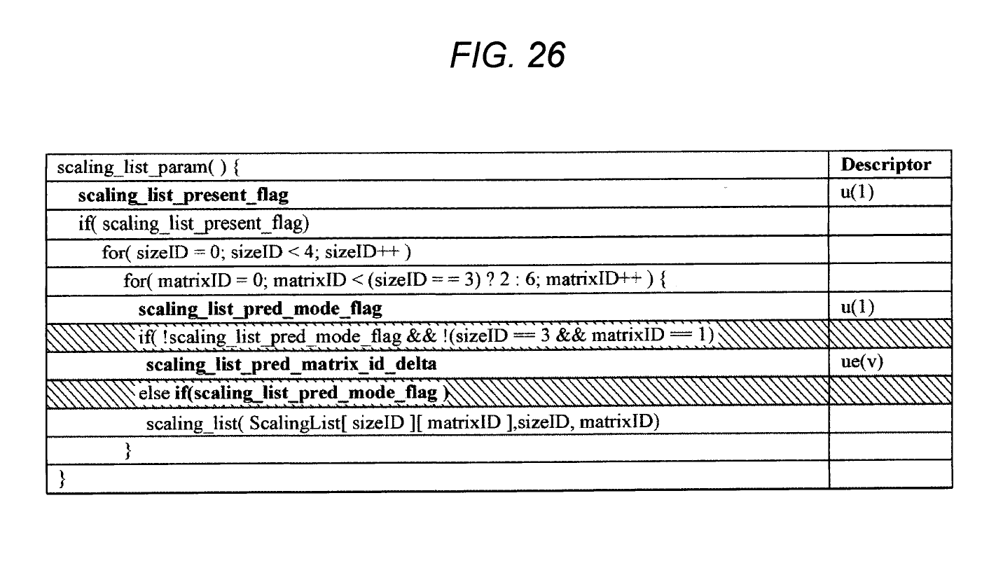

As shown in FIG. 4, note that two matrix IDs are assigned when the size ID is “3”. Thus, when the size ID is “3” and the matrix ID is “1”, transmission of scaling_list_pred_matrix_id_delta may be omitted. FIG. 26 is a table for explaining an example of syntax of the scaling list in this case.

In the syntax of the example of FIG. 26, in addition to the control similar to the of the example of FIG. 3, not only the presence of scaling_list_pred_mode_flag but also whether or not the size ID is “3” and the matrix ID is “1” (!(sizeID==3 && matrixID==1)) are checked on the seventh line from the top.

Control is then made to acquire scaling_list_pred_matrix_id_delta if the mode is the copy mode and the size ID is other than “3” or the matrix ID is other than “1”, or not to acquire scaling_list_pred_matrix_id_delta if the mode is the normal mode or if the size ID is “3” and the matrix ID is “1”.

In other words, the image encoding device 100 controls whether or not to transmit scaling_list_pred_matrix_id_delta according to such conditions. In addition, the image decoding device 300 controls whether or not to acquire scaling_list_pred_matrix_id_delta according to such conditions.

In this manner, as a result of omitting transmission of scaling_list_pred_matrix_id_delta, the image encoding device 100 can further improve the coding efficiency. Since calculation of scaling_list_pred_matrix_id_delta can also be omitted, the image encoding device 100 can further reduce the loads of the encoding process.

In addition, as a result of omitting transmission of scaling_list_pred_matrix_id_delta in this manner, the image decoding device 300 can realize further improvement in the coding efficiency. Since acquisition of scaling_list_pred_matrix_id_delta can also be omitted, the image decoding device 300 can further reduce the loads of the decoding process.

### 4-2 Flow of Scaling List Encoding Process

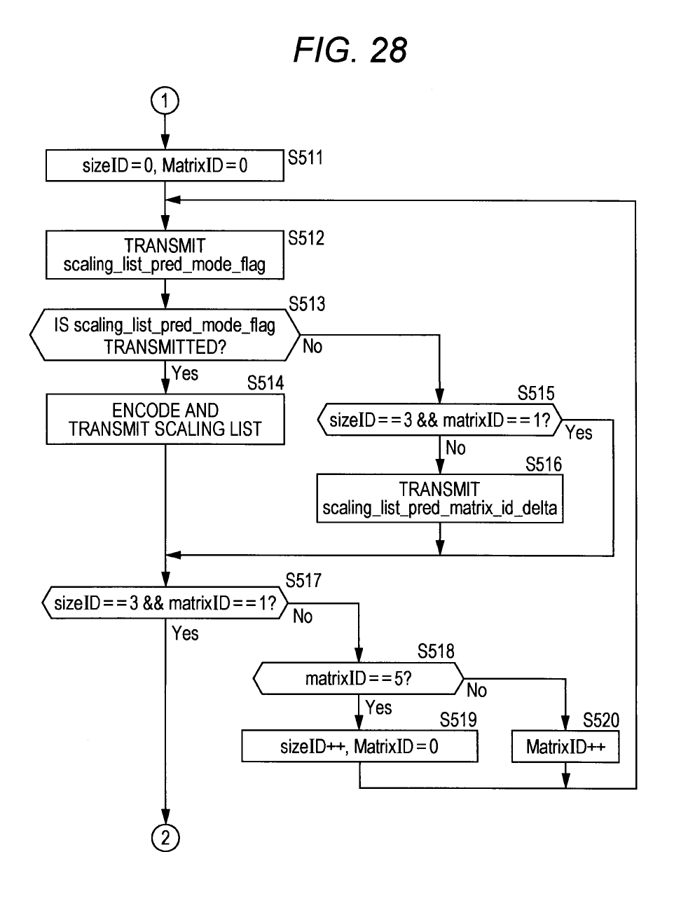

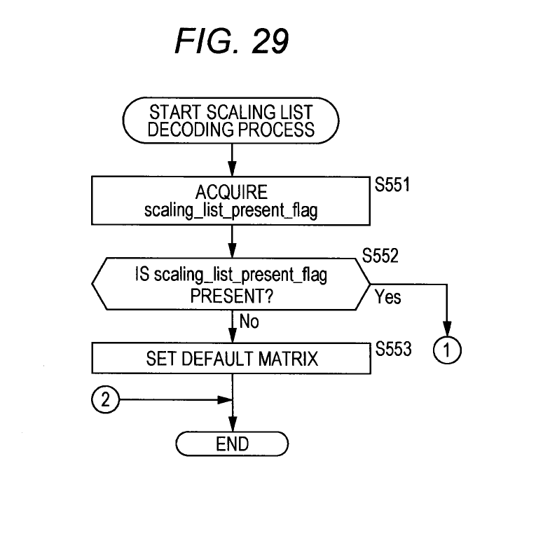

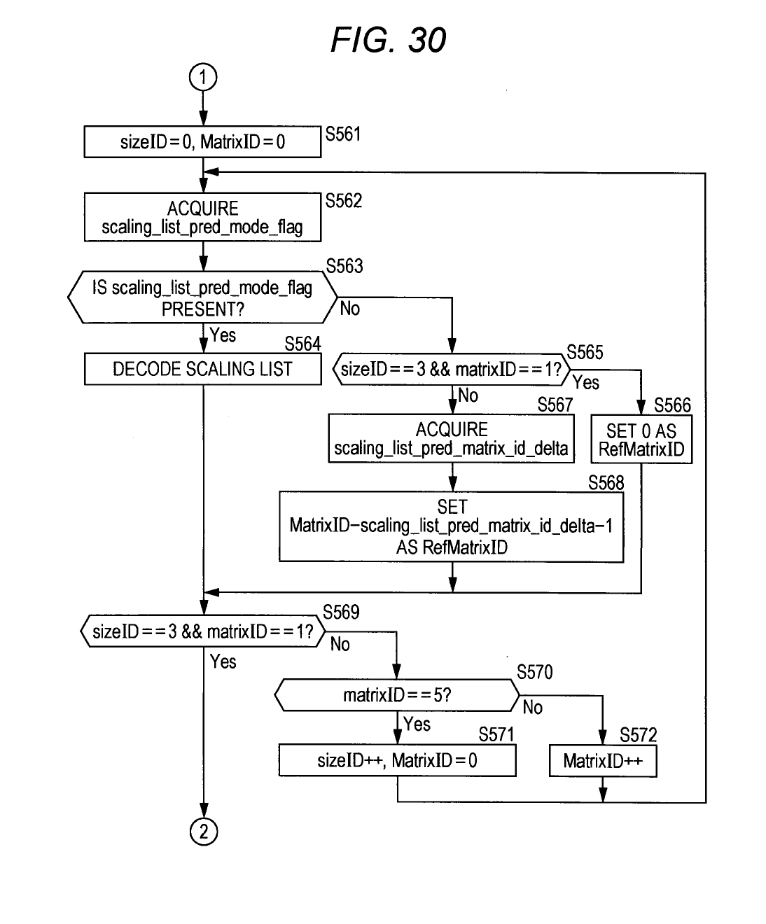

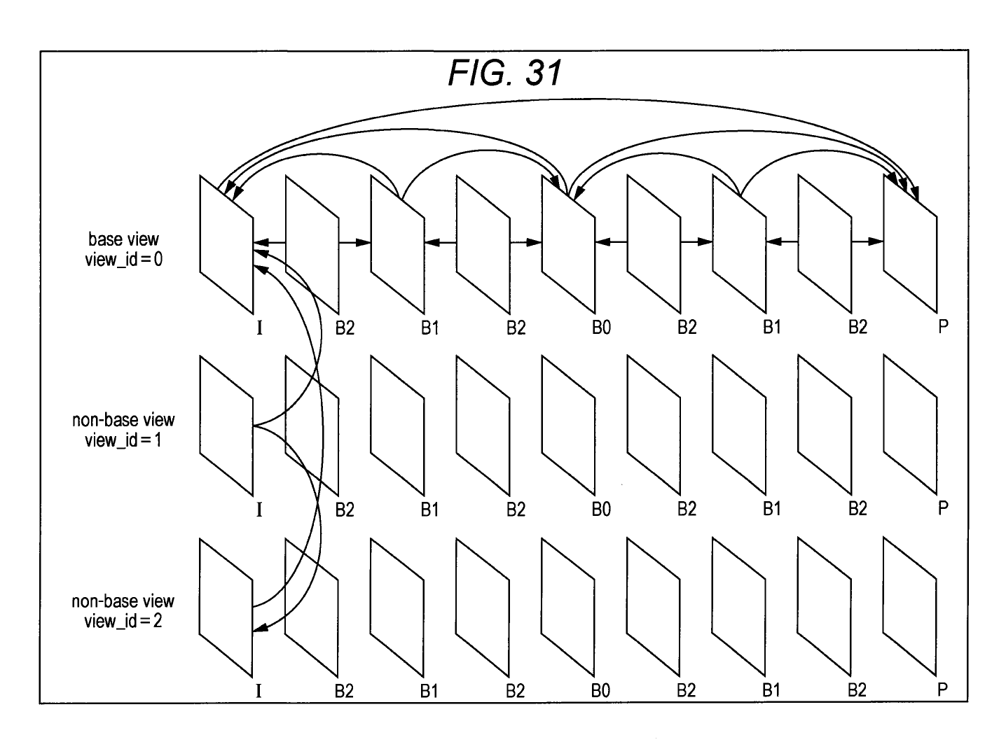

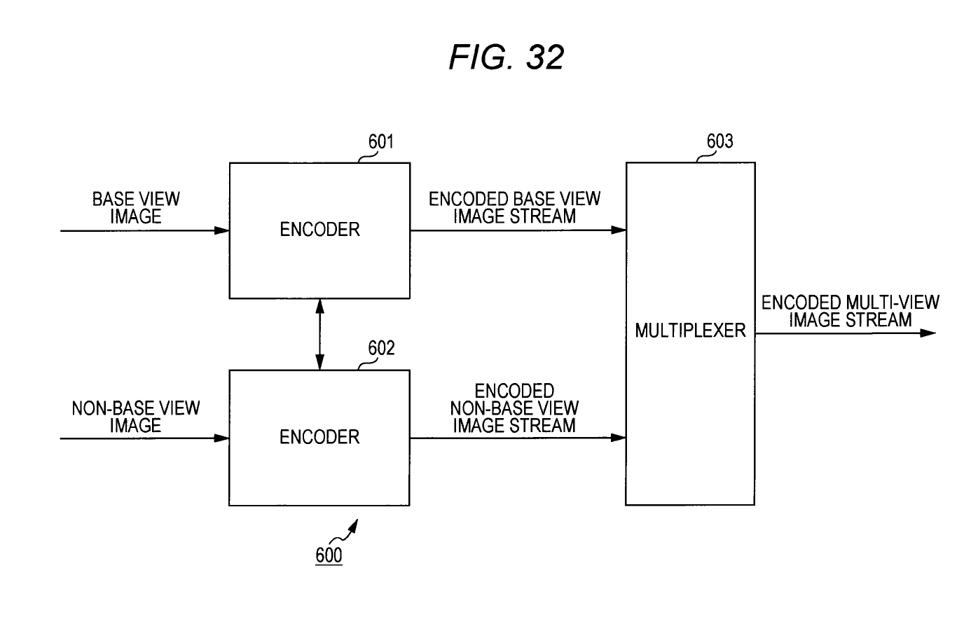

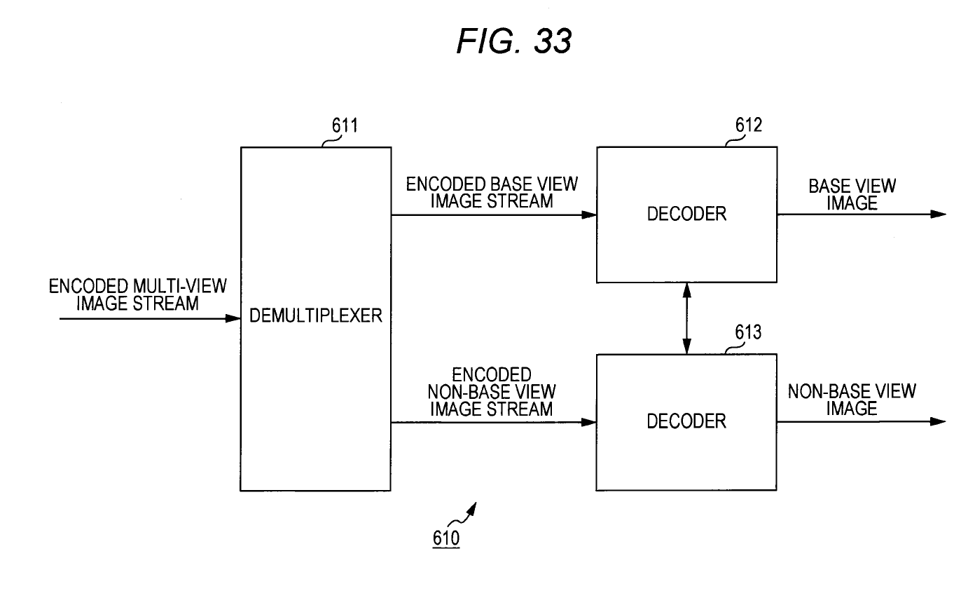

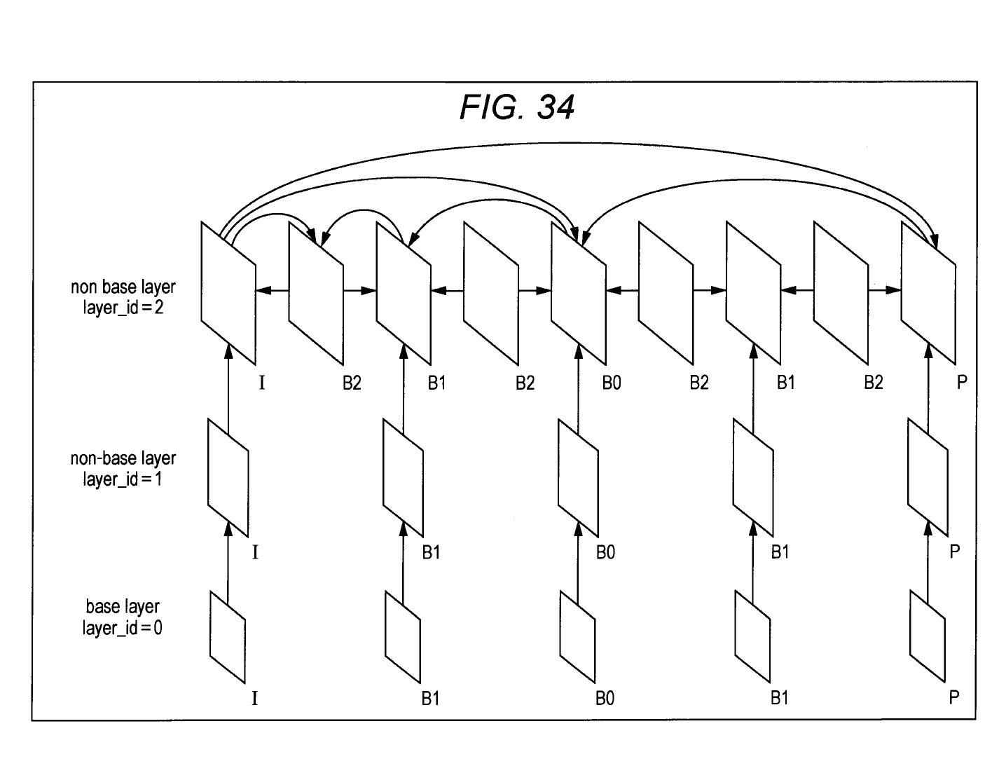

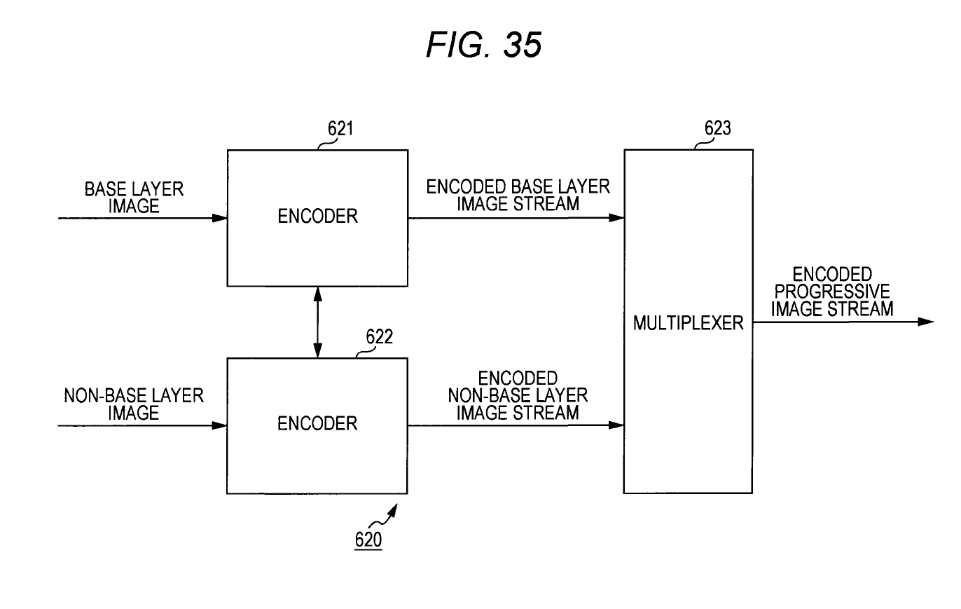

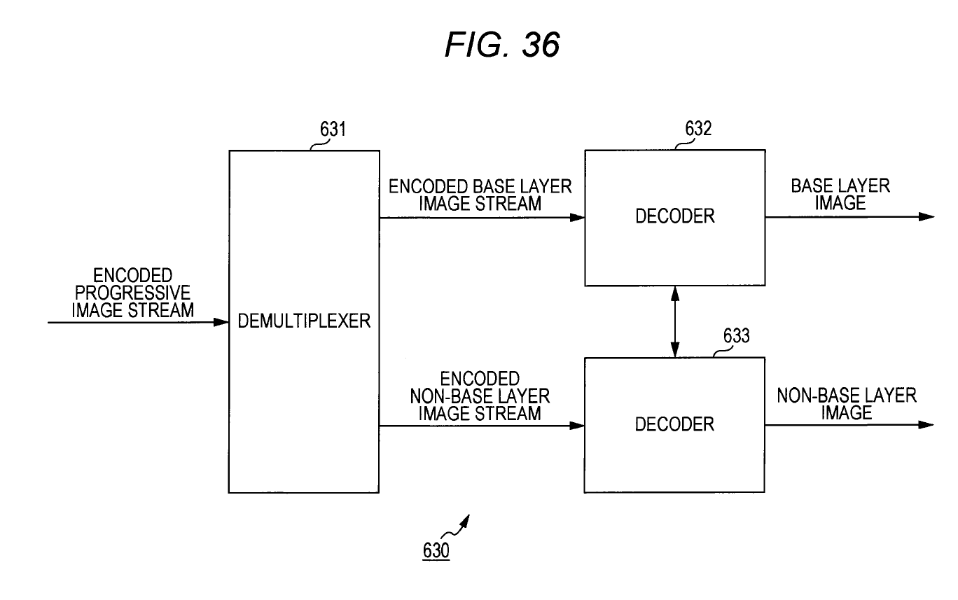

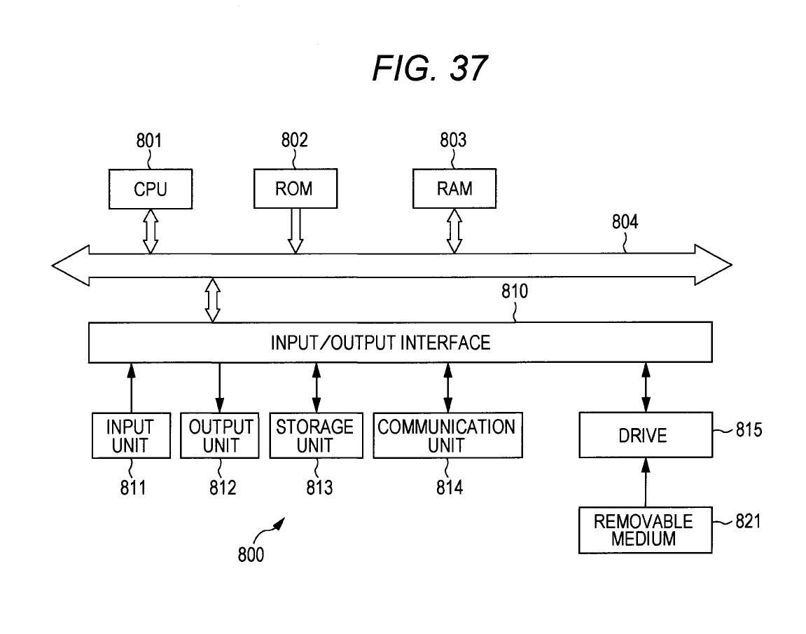

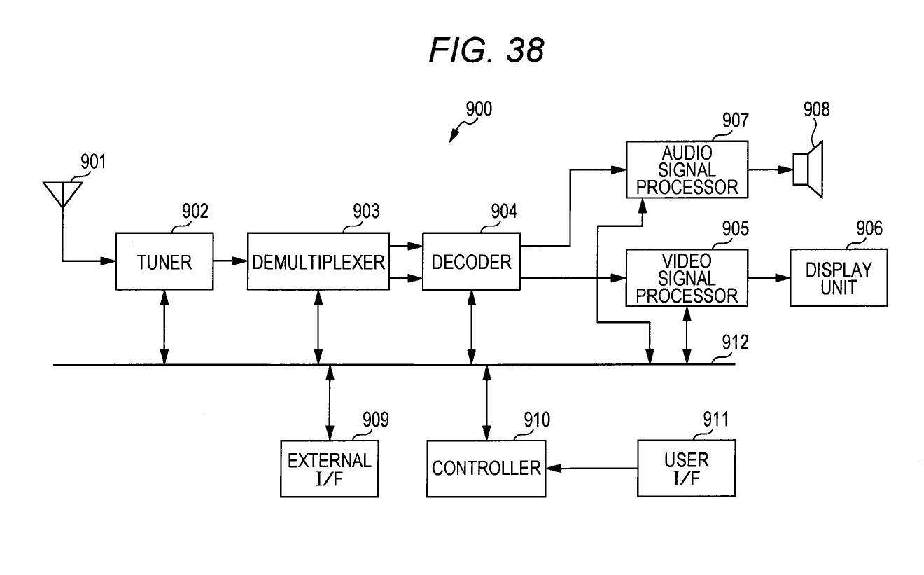

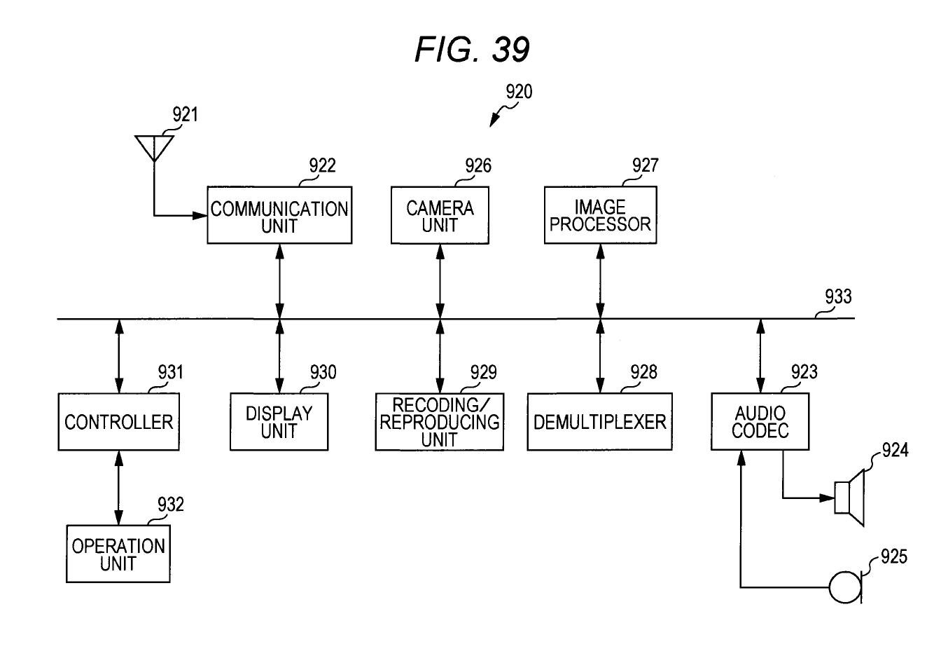

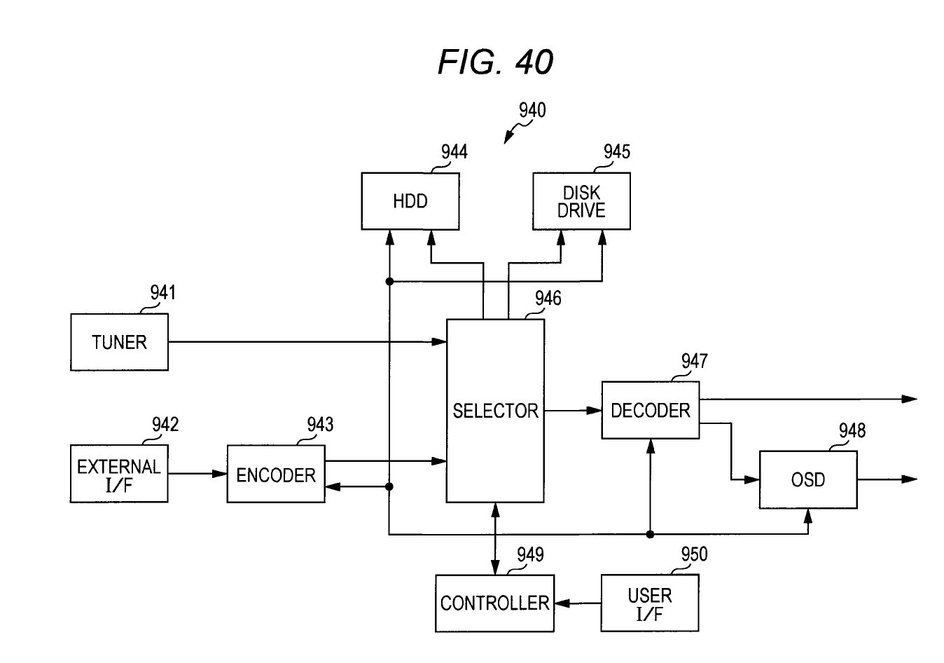

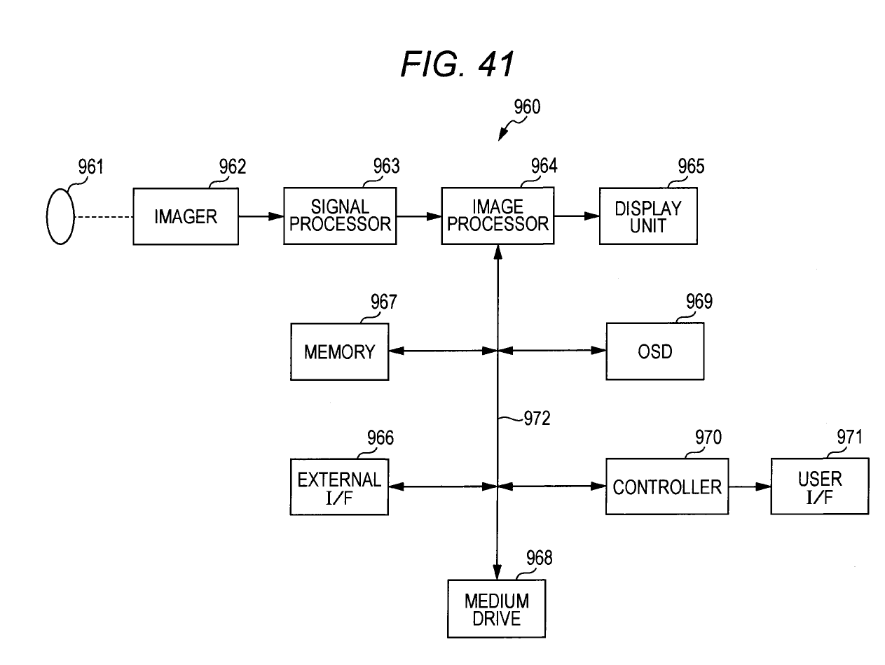

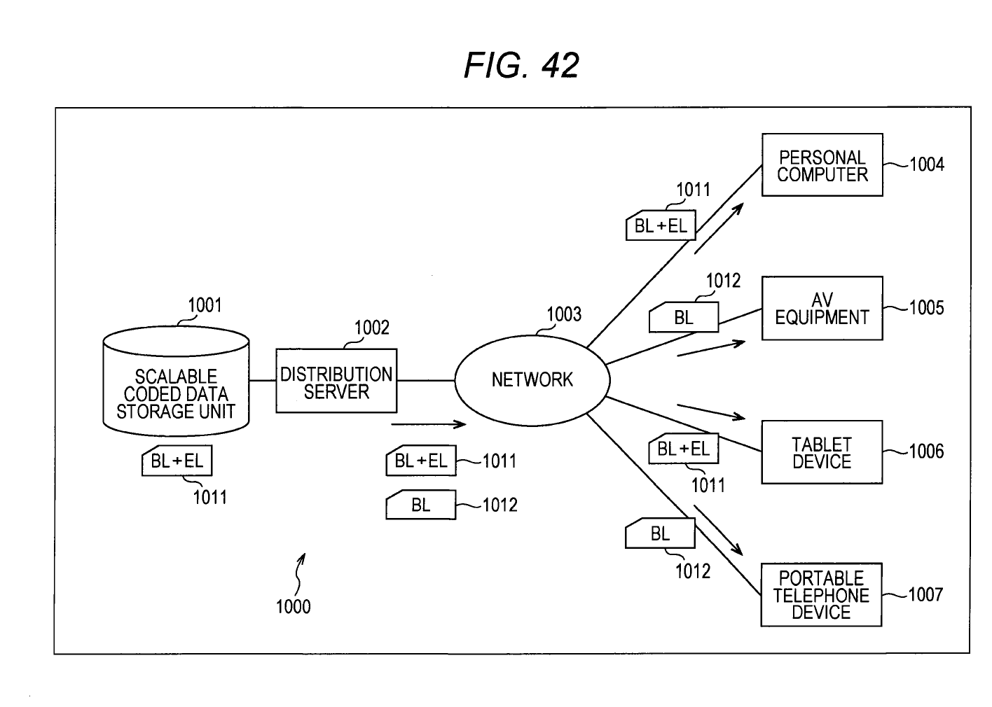

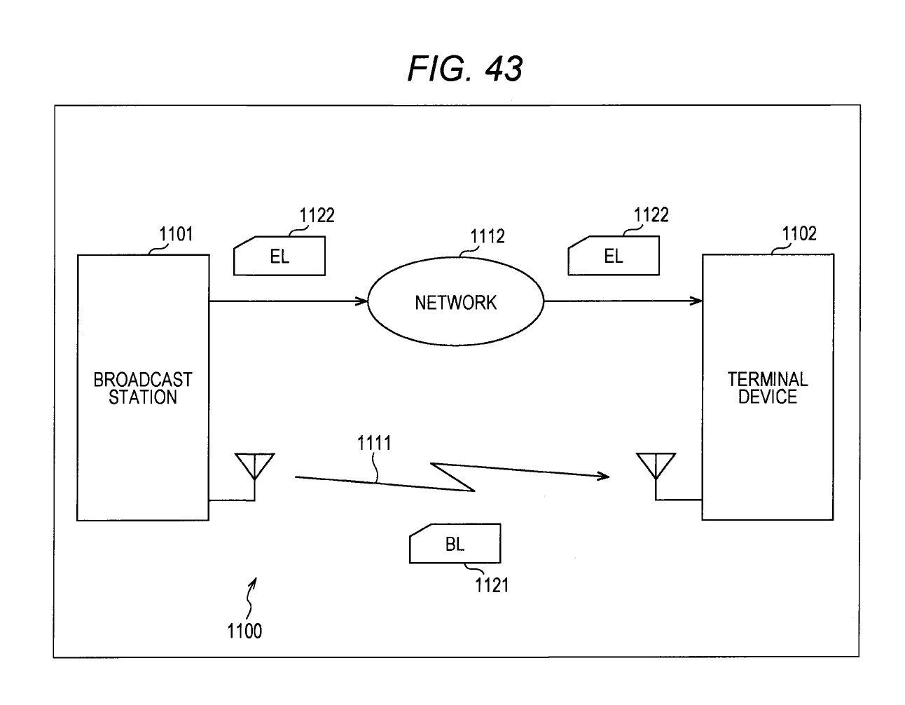

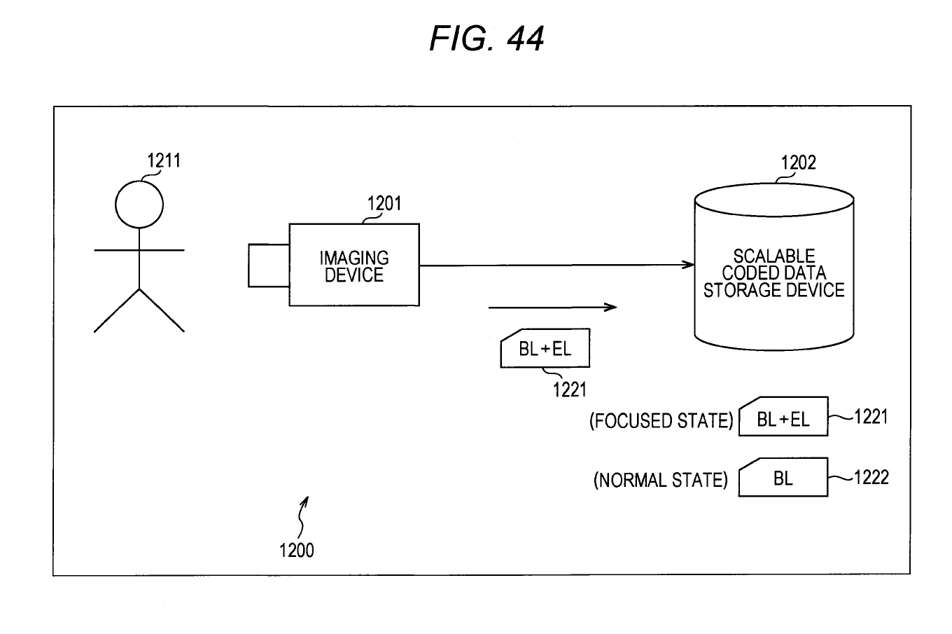

An example of a flow of a scaling list encoding process performed by the image encoding device 100 in this case will be described with reference to the flowcharts of FIGS. 27 and 28.

As shown in FIGS. 27 and 28, processing in this case is performed basically in the same manner as described with reference to the flowcharts of FIGS. 12 and 13.

For example, processing in steps S501 to S503 of FIG. 27 is performed in the same manner as the processing in steps S151, S155 and S156 of FIG. 12.

Thus, in the case of the example of FIG. 27, the processing in steps S152 to S154 of FIG. 12 is omitted. The same processing as the processing in steps S152 to S154 may of course be performed in the example of FIG. 27 similarly to FIG. 12.

Furthermore, processing in steps S511 to S514 of FIG. 28 is also performed in the same manner as the processing in steps S161 to S164 of FIG. 13.

In step S513 of FIG. 28, however, in the copy mode, that is, when it is determined that scaling_list_pred_mode_flag is not transmitted, the process proceeds to step S515.

In step S515, the matrix ID controller 211 determines whether or not the size ID is “3” (SizeID==3) and the matrix ID is “1” (MatrixID==1).

If it is determined that the size ID is not “3” (SizeID!=3) or that the matrix ID is not “1” (MatrixID!=1), the process proceeds to step S516.

Processing in step S516 is performed similarly to the processing in step S165 of FIG. 13. When the processing in step S516 is terminated, the process proceeds to step S517. If it is determined in step S515 that the size ID is “3” (SizeID==3) and the matrix ID is “1” (MatrixID==1), the processing in step S516 is omitted and the process proceeds to step S517.

Thus, scaling_list_pred_matrix_id_delta is transmitted only if the size ID is determined not to be “3” or if the matrix ID is determined not to be “1”.

The other processing is the same as in the example of FIGS. 12 and 13, and processing in steps S517 to S520 is performed in the same manner as the processing in steps S166 to S169 in FIG. 13.

As a result of such control, the image encoding device 100 can improve the coding efficiency and reduce the loads of the encoding process.

### 4-3 Flow of Scaling List Decoding Process

An example of a flow of a scaling list decoding process performed by the image decoding device 300 in this case will be described with reference to the flowcharts of FIGS. 29 and 30.

As shown in FIGS. 29 and 30, processing in this case is performed basically in the same manner as described with reference to the flowcharts of FIGS. 19 and 20.

For example, processing in steps S551 to S553 of FIG. 29 is performed in the same manner as the processing in steps S344 to S346 of FIG. 19.

Thus, in the case of the example of FIG. 29, the processing in steps S341 to S343 of FIG. 19 is omitted. The same processing as the processing in steps S341 to S343 may of course be performed in the example of FIG. 29 similarly to FIG. 19.

Furthermore, processing in steps S561 to S564 of FIG. 30 is also performed in the same manner as the processing in steps S351 to S354 of FIG. 20.

In step S563 of FIG. 30, however, in the copy mode, that is, when it is determined that scaling_list_pred_mode_flag is not present, the process proceeds to step S565.

In step S565, the matrix ID controller 391 determines whether or not the size ID is “3” (SizeID==3) and the matrix ID is “1” (MatrixID==1).

If it is determined that the size ID is “3” (SizeID==3) and the matrix ID is “1” (MatrixID==1), the process proceeds to step S566.

In step S566, since scaling_list_pred_matrix_id_delta is not transmitted, the copy unit 361 sets “0” as the reference matrix ID (RefMatrixID). When the processing in step S566 is terminated, the process proceeds to step S569.

If it is determined in step S565 that the size ID is not “3” (SizeID!=3) or that the matrix ID is not “1” (MatrixID!=1), the process proceeds to step S567.

Processing in steps S567 and S568 is performed in the same manner as the processing in steps S355 and S356 of FIG. 20.

Thus, scaling_list_pred_matrix_id_delta is transmitted only if the size ID is determined not to be “3” (SizeID!=3) or if the matrix ID is determined not to be “1” (MatrixID!=1), and the reference scaling list is identified on the basis of the scaling_list_pred_matrix_id_delta. If the size ID is determined to be “3” (SizeID==3) and the matrix ID is determined to be “1” (MatrixID==1), scaling_list_pred_matrix_id_delta is not transmitted but a scaling list that is obviously the reference scaling list is set.

The other processing is the same as in the example of FIGS. 19 and 20, and processing in steps S569 to S572 is performed in the same manner as the processing in steps S357 to S360 in FIG. 20.

As a result of such control, the image decoding device 300 can realize improvement in the coding efficiency and reduce the loads of the decoding process.

### 5. Fifth Embodiment

### Application to Multi-View Image Encoding/Multi-View Image Decoding

The series of processes described above can be applied to multi-view image encoding and multi-view image decoding. FIG. 31 is a diagram showing an example of a multi-view image encoding technique.

As shown in FIG. 31, a multi-view image includes images of multiple views. The multiple views of the multi-view image include base views to be encoded/decoded by using only the images of the present views and non-base views to be encoded/decoded by using images of other views. The non-base views may use images of base views and may use images of other non-base views.

For encoding/decoding a multi-view image as in FIG. 31, images of respective views are encoded/decoded. The methods described in the embodiments above may be applied to encoding/decoding of the respective views. In this manner, the efficiency of coding respective views can be improved.

Furthermore, in encoding/decoding respective views, the flags and parameters used in the methods described in the embodiments above may be shared. In this manner, the coding efficiency can be improved.

More specifically, information on scaling lists (such as parameters and flags) may be shared in encoding/decoding respective views, for example.

Necessary information other than these may of course be also shared in encoding/decoding respective views.

For example, in transmitting scaling lists and information on scaling lists in a sequence parameter set (SPS) or a picture parameter set (PPS), if these SPS and PPS are shared among views, the scaling lists and the information on scaling lists will naturally be shared as well. In this manner, the coding efficiency can be improved.

In addition, matrix elements of a scaling list (quantization matrix) for base views may be changed according to disparity values between views. Furthermore, offset values for adjusting matrix elements for non-base views in relation to matrix elements of a scaling list (quantization matrix) for base views may be transmitted. In these manners, the coding efficiency can be improved.

For example, a scaling list for each view may be transmitted separately in advance. If different scaling lists are used for different views, only information indicating a difference from the scaling list transmitted previously may be transmitted. Any form of information may be used for the information indicating the difference. For example, the information may be in units of 4×4 or 8×8, or may be a difference between matrices.

If the SPS and the PPS are not shared but scaling lists and information on scaling lists are shared between views, an SPS and a PPS of another view may be capable of being referred to (that is, the scaling lists and the information on scaling lists of another view can be used).

For expressing such a multi-view image as an image having images of Y, U, and V and depth images (Depth) corresponding to the disparity amounts between views as components, scaling lists and information on scaling lists independent of one another may be used for the respective components (Y, U, V, and Depth).

For example, since a depth image (Depth) is an edge image, no scaling list is needed. Thus, even if use of scaling lists is specified in a SPS or a PPS, no scaling list may be applied (or a scaling list having matrix components having the same value (FLAT) may be applied) to depth images (Depth).

### <Multi-View Image Encoding Device>

FIG. 32 is a diagram showing a multi-view image encoding device that encodes a multi-view image described above. As shown in FIG. 32, the multi-view image encoding device 600 includes an encoder 601, an encoder 602, and a multiplexer 603.

The encoder 601 encodes base view images to generate an encoded base view image stream. The encoder 602 encodes non-base view images to generate an encoded non-base view image stream. The multiplexer 603 multiplexes the encoded base view image stream generated by the encoder 601 and the encoded non-base view image stream generated by the encoder 602 to generate an encoded multi-view image stream.

The image encoding device 100 (FIG. 7) can be applied to the encoder 601 and the encoder 602 of the multi-view image encoding device 600. Thus, in encoding of respective views, the coding efficiency can be improved and decrease in the image quality of the views can be suppressed. Furthermore, since the encoder 601 and the encoder 602 can perform processing such as quantization and inverse quantization by using the same flags or parameters (that is, the encoder 601 and the encoder 602 can share flags and parameters), the coding efficiency can be improved.

### <Multi-View Image Decoding Device>

FIG. 33 is a diagram showing a multi-view image decoding device that performs multi-view image decoding described above. As shown in FIG. 33, the multi-view image decoding device 610 includes a demultiplexer 611, a decoder 612, and a decoder 613.

The demultiplexer 611 demultiplexes an encoded multi-view image stream obtained by multiplexing an encoded base view image stream and an encoded non-base view image stream to extract the encoded base view image stream and the encoded non-base view image stream. The decoder 612 decodes the encoded base view image stream extracted by the demultiplexer 611 to obtain base view images. The decoder 613 decodes the encoded non-base view image stream extracted by the demultiplexer 611 to obtain non-base view images.

The image decoding device 300 (FIG. 14) can be applied to the decoder 612 and the decoder 613 of the multi-view image decoding device 610. Thus, in decoding of respective views, the coding efficiency can be improved and decrease in the image quality of the views can be suppressed. Furthermore, since the decoder 612 and the decoder 613 can perform processing such as quantization and inverse quantization by using the same flags or parameters (that is, the decoder 612 and the decoder 613 can share flags and parameters), the coding efficiency can be improved.

### 6. Sixth Embodiment

### Application to Progressive Image Encoding/Progressive Image Decoding

The series of processes described above can be applied to progressive image encoding and progressive image decoding (scalable encoding and scalable decoding). FIG. 34 is a diagram showing an example of a progressive image coding technique.

With the progressive image encoding (scalable coding), images are layered in multiple layers and encoded in units of the layers so that image data have a scalability function for a predetermined parameter. The progressive image decoding (scalable decoding) is decoding associated with the progressive image encoding.

As shown in FIG. 34, in image layering, one image is divided into multiple images (layers) on the basis of a predetermined parameter having a scalability function. Specifically, an image (layered image) that is layered includes multiple layers of images having values of the predetermined parameter that are different from one another. The layers of the layered image include base layers that are encoded/decoded by using only the present layers of images without using the other layers of images and non-base layers (also referred to as enhancement layers) that are encoded/decoded by using the other layers of images. The non-base layers may use base layer images or may use the other non-base layer images.

Typically, a non-base layer is constituted by the present image and difference image data (difference data) from another layer image so as to reduce redundancy. For example, when one image is layered in two layers, which are a base layer and a non-base layer (also referred to as an enhancement layer), an image of a lower quality than the original image can be obtained only by data of the base layer and the original image (that is, a high-quality image) can be obtained by combining the data of the base layer and the data of the non-base layer.

As a result of layering images in this manner, images of various qualities can be easily obtained depending on conditions. For example, to a terminal having low processing capability such as a portable telephone, compressed image information of only base layers can be transmitted so that moving images with low spatial and temporal resolution or of low quality are reproduced, and to a terminal having high processing capability such as a television set or a personal computer, compressed image information of enhancement layers in addition to base layers can be transmitted so that moving images with high spatial and temporal resolution or of high quality are reproduced. In such a manner, compressed image information according to the capability of a terminal and a network can be transmitted from a server without performing any transcoding process.

For encoding/decoding a layered image as in the example of FIG. 34, images of respective layers are encoded/decoded. The methods described in the embodiments above may be applied to encoding/decoding of the respective layers. In this manner, the efficiency of coding respective layers can be improved.

Furthermore, in encoding/decoding respective layers, the flags and parameters used in the methods described in the embodiments above may be shared. In this manner, the coding efficiency can be improved.

More specifically, information on scaling lists (such as parameters and flags) may be shared in encoding/decoding respective layers, for example.

Necessary information other than these may of course be also shared in encoding/decoding respective layers.

An example of such a layered image is an image layered according to spatial resolution (also referred to as spatial resolution scalability) (spatial scalability). In a layered image having spatial resolution scalability, the image resolution differs from layer to layer. For example, the layer of an image with the lowest spatial resolution is a base layer, and the layer of an image with a higher resolution than the base layer is a non-base layer (enhancement layer).

Image data of a non-base layer (enhancement layer) may be data independent of the other layers and an image with a resolution of the layer may be able to be obtained only by the image data similarly to a base layer, but the image data is typically data corresponding to a difference image between the image of the layer and an image of another layer (one layer lower than the layer, for example). In this case, an image with the resolution of the base layer can be obtained only by image data of the base layer, but an image with the resolution of a non-base layer (enhancement layer) is obtained by combining the image data of the layer and image layer of another layer (one layer lower than the layer, for example). In this manner, redundancy of image data between layers can be suppressed.

In such a layered image having spatial resolution scalability, since the image resolution differs from layer to layer, the resolutions of processing units for encoding/decoding of respective layers also differ from one another. Thus, when scaling lists (quantization matrices) are shared in encoding/decoding of respective layers, the scaling lists (quantization matrices) may be up-converted according to the resolution ratio of the layers.

For example, assume that the resolution of a base layer image is 2K (1920×1080, for example) and that the resolution of a non-base layer (enhancement layer) image is 4K (3840×2160, for example). In this case, 16×16 of the base layer image (2K image) corresponds to 32×32 of the non-base layer image (4K image). The scaling lists (quantization matrices) are also up-converted where appropriate according to such a resolution ratio.

For example, a scaling list of 4×4 used for quantization/inverse quantization of a base layer is up-converted to 8×8 for use for quantization/inverse quantization of a non-base layer. Similarly, a scaling list of 8×8 for a base layer is up-converted to 16×16 for a non-base layer. Similarly, a scaling list up-converted to 16×16 for use for a base layer is up-converted to 32×32 for a non-base layer.

A parameter that provides scalability is not limited to spatial resolution but may also be temporal resolution (temporal scalability), for example. In a layered image having temporal resolution scalability, the frame rate differs from layer to layer. Alternatively, examples of the parameter include bit-depth scalability with which the bit depth of image data differs from layer to layer, and chroma scalability with which the format of components differs from layer to layer.

Still alternatively, the examples also include SNR scalability with which the signal to noise ratio (SNR) of images differs from layer to layer.

For improving image quality, it is desirable to make quantization error smaller as the signal to noise ratio is lower. Thus, in the case of SNR scalability, it is desirable to use different scaling lists (scaling lists that are not shared) depending on the signal to noise ratio for quantization/inverse quantization of respective layers. Thus, when a scaling list is shared among layers as described above, offset values for adjusting matrix elements for an enhancement layer in relation to matrix elements of a scaling list for a base layer may be transmitted. More specifically, information indicating a difference between the shared scaling list and a scaling list that is actually used may be transmitted for each layer. For example, the information indicating the difference may be transmitted in a sequence parameter set (SPS) or a picture parameter set (PPS) for each layer. Any form of information may be used for the information indicating the difference. For example, the information may be a matrix having difference values between respective elements of both scaling lists as elements or may be a function representing the difference.

### <Progressive Image Encoding Device>

FIG. 35 is a diagram showing a progressive image encoding device that performs the progressive image coding described above. As shown in FIG. 35, the progressive image encoding device 620 includes an encoder 621, and encoder 622, and a multiplexer 623.

The encoder 621 encodes base layer images to generate an encoded base layer image stream. The encoder 622 encodes non-base layer images to generate an encoded non-base layer image stream. The multiplexer 623 multiplexes the encoded base layer image stream generated by the encoder 621 and the encoded non-base layer image stream generated by the encoder 622 to generate an encoded progressive image stream.

The image encoding device 100 (FIG. 7) can be applied to the encoder 621 and the encoder 622 of the progressive image encoding device 620. Thus, in encoding of respective layers, the coding efficiency can be improved and decrease in the image quality of the layers can be suppressed. Furthermore, since the encoder 621 and the encoder 622 can perform processing such as quantization and inverse quantization by using the same flags or parameters (that is, the encoder 621 and the encoder 622 can share flags and parameters), the coding efficiency can be improved.

### <Progressive Image Decoding Device>

FIG. 36 is a diagram showing a progressive image decoding device that performs the progressive image decoding described above. As shown in FIG. 36, the progressive image decoding device 630 includes a demultiplexer 631, a decoder 632, and a decoder 633.

The demultiplexer 631 demultiplexes an encoded progressive image stream obtained by multiplexing an encoded base layer image stream and an encoded non-base layer image stream to extract the encoded base layer image stream and the encoded non-base layer image stream. The decoder 632 decodes the encoded base layer image stream extracted by the demultiplexer 631 to obtain base layer images. The decoder 633 decodes the encoded non-base layer image stream extracted by the demultiplexer 631 to obtain non-base layer images.

The image decoding device 300 (FIG. 14) can be applied to the decoder 632 and the decoder 633 of the progressive image decoding device 630. Thus, in decoding of respective layers, the coding efficiency can be improved and decrease in the image quality of the layers can be suppressed. Furthermore, since the decoder 632 and the decoder 633 can perform processing such as quantization and inverse quantization by using the same flags or parameters (that is, the decoder 632 and the decoder 633 can share flags and parameters), the coding efficiency can be improved.

### 7. Seventh Embodiment

### Computer

The series of processes described above can be performed either by hardware or by software. When the series of processes described above is performed by software, programs constituting the software are installed in a computer. Note that examples of the computer include a computer embedded in dedicated hardware and a general-purpose computer capable of executing various functions by installing various programs therein.

FIG. 37 is a block diagram showing an example structure of the hardware of a computer that performs the above described series of processes in accordance with programs.

In the computer 800 shown in FIG. 37, a CPU (Central Processing Unit) 801, a ROM (Read Only Memory) 802, and a RAM (Random Access Memory) 803 are connected to one another via a bus 804.

An input/output interface 810 is also connected to the bus 804. An input unit 811, an output unit 812, a storage unit 813, a communication unit 814, and a drive 815 are connected to the input/output interface 810.

The input unit 811 includes a keyboard, a mouse, a microphone, a touch panel, an input terminal, and the like, for example. The output unit 812 includes a display, a speaker, an output terminal, and the like, for example. The storage unit 813 is a hard disk, a RAM disk, a nonvolatile memory, or the like, for example. The communication unit 814 is a network interface or the like, for example. The drive 815 drives a removable medium 821 such as a magnetic disk, an optical disk, a magnetooptical disk, or a semiconductor memory.

In the computer 800 having the above described structure, the CPU 801 loads a program stored in the storage unit 813 into the RAM 803 via the input/output interface 810 and the bus 804 and executes the program, for example, so that the above described series of processes are performed. The RAM 803 also stores data necessary for the CPU 801 to perform various processes and the like as necessary.

The programs to be executed by the computer 800 (the CPU 801) may be recorded on the removable medium 821 as a package medium or the like and applied therefrom, for example. Alternatively, the programs can be provided via a wired or wireless transmission medium such as a local area network, the Internet, or digital satellite broadcasting.

In the computer 800, the programs can be installed in the storage unit 813 via the input/output interface 810 by mounting the removable medium 821 on the drive 815. Alternatively, the programs can be received by the communication unit 814 via a wired or wireless transmission medium and installed in the storage unit 813. Still alternatively, the programs can be installed in advance in the ROM 802 or the storage unit 813.

Programs to be executed by the computer 800 may be programs for carrying out processes in chronological order in accordance with the sequence described in this specification, or programs for carrying out processes in parallel or at necessary timing such as in response to a call.

In this specification, steps describing programs to be recorded in a recording medium include processes to be performed in parallel or independently of one another if not necessarily in chronological order, as well as processes to be performed in chronological order in accordance with the sequence described herein.

Furthermore, in this specification, a system refers to a set of multiple components (devices, modules (parts), etc.), and all the components may be or may not be within one housing. Thus, both of multiple devices accommodated in different housings and connected via a network and one device having a housing in which multiple modules are accommodated are systems.

Furthermore, any structure described above as one device (or one processing unit) may be divided into two or more devices (or processing units). Conversely, any structure described above as two or more devices (or processing units) may be combined into one device (or processing unit). Furthermore, it is of course possible to add components other than those described above to the structure of any of the devices (or processing units). Furthermore, some components of a device (or processing unit) may be incorporated into the structure of another device (or processing unit) as long as the structure and the function of the system as a whole are substantially the same.

While preferred embodiments of the present disclosure have been described above with reference to the accompanying drawings, the technical scope of the present disclosure is not limited to these examples. It is apparent that a person ordinary skilled in the art of the present disclosure can conceive various variations and modifications within the technical idea described in the claims, and it is naturally appreciated that these variations and modification belongs within the technical scope of the present disclosure.

For example, according to the present technology, a cloud computing structure in which one function is shared and processed in cooperation among multiple devices via a network can be used.

Furthermore, the steps described in the flowcharts above can be executed by one device and can also be shared and executed by multiple devices.

Furthermore, when multiple processes are contained in one step, the processes contained in the step can be executed by one device and can also be shared and executed by multiple devices.

The image encoding device 100 (FIG. 7) and the image decoding device 300 (FIG. 14) according to the embodiments described above can be applied to various electronic devices such as transmitters and receivers in satellite broadcasting, cable broadcasting such as cable TV (television broadcasting), distribution via the Internet, distribution to terminals via cellular communication, or the like, recording devices configured to record images in media such as magnetic discs and flash memory, and reproduction devices configured to reproduce images from the storage media. Four examples of applications will be described below.

### 8. Applications

### 8-1. Television Apparatus

FIG. 38 shows an example of a schematic structure of a television apparatus to which the embodiments described above are applied. The television apparatus 900 includes an antenna 901, a tuner 902, a demultiplexer 903, a decoder 904, a video signal processor 905, a display unit 906, an audio signal processor 907, a speaker 908, an external interface 909, a controller 910, a user interface 911, and a bus 912.

The tuner 902 extracts a signal of a desired channel from broadcast signals received via the antenna 901, and demodulates the extracted signal. The tuner 902 then outputs an encoded bit stream obtained by the demodulation to the demultiplexer 903. That is, the tuner 902 serves as a transmitter in the television apparatus 900 that receives an encoded stream of encoded images.

The demultiplexer 903 separates a video stream and an audio stream of a program to be viewed from the encoded bit stream, and outputs the separated streams to the decoder 904. The demultiplexer 903 also extracts auxiliary data such as an EPG (electronic program guide) from the encoded bit stream, and supplies the extracted data to the controller 910. If the encoded bit stream is scrambled, the demultiplexer 903 may descramble the encoded bit stream.

The decoder 904 decodes the video stream and the audio stream input from the demultiplexer 903. The decoder 904 then outputs video data generated by the decoding to the video signal processor 905. The decoder 904 also outputs audio data generated by the decoding to the audio signal processor 907.

The video signal processor 905 reproduces video data input from the decoder 904, and displays the video data on the display unit 906. The video signal processor 905 may also display an application screen supplied via the network on the display unit 906. Furthermore, the video signal processor 905 may perform additional processing such as noise removal on the video data depending on settings. The video signal processor 905 may further generate an image of a GUI (graphical user interface) such as a menu, a button or a cursor and superimpose the generated image on the output images.

The display unit 906 is driven by a drive signal supplied from the video signal processor 905, and displays video or images on a video screen of a display device (such as a liquid crystal display, a plasma display, or an OELD (organic electroluminescence display).

The audio signal processor 907 performs reproduction processing such as D/A conversion and amplification on the audio data input from the decoder 904, and outputs audio through the speaker 908. Furthermore, the audio signal processor 907 may perform additional processing such as noise removal on the audio data.

The external interface 909 is an interface for connecting the television apparatus 900 with an external device or a network. For example, a video stream or an audio stream received via the external interface 909 may be decoded by the decoder 904. That is, the external interface 909 also serves as a transmitter in the television apparatus 900 that receives an encoded stream of encoded images.

The controller 910 includes a processor such as a CPU, and a memory such as a RAM and a ROM. The memory stores programs to be executed by the CPU, program data, EPG data, data acquired via the network, and the like. Programs stored in the memory are read and executed by the CPU when the television apparatus 900 is activated, for example. The CPU controls the operation of the television apparatus 900 according to control signals input from the user interface 911, for example, by executing the programs.

The user interface 911 is connected to the controller 910. The user interface 911 includes buttons and switches for users to operate the television apparatus 900 and a receiving unit for receiving remote control signals, for example. The user interface 911 detects operation by a user via these components, generates a control signal, and outputs the generated control signal to the controller 910.

The bus 912 connects the tuner 902, the demultiplexer 903, the decoder 904, the video signal processor 905, the audio signal processor 907, the external interface 909, and the controller 910 to one another.

In the television apparatus 900 having such a structure, the decoder 904 has the functions of the image decoding device 300 (FIG. 14) according to the embodiments described above. The television apparatus 900 can therefore realize improvement in the coding efficiency.

### 8-2. Portable Telephone Device

FIG. 39 shows an example of a schematic structure of a portable telephone device to which the embodiments described above are applied. The portable telephone device 920 includes an antenna 921, a communication unit 922, an audio codec 923, a speaker 924, a microphone 925, a camera unit 926, an image processor 927, a demultiplexer 928, a recording/reproducing unit 929, a display unit 930, a controller 931, an operation unit 932, and a bus 933.

The antenna 921 is connected to the communication unit 922. The speaker 924 and the microphone 925 are connected to the audio codec 923. The operation unit 932 is connected to the controller 931. The bus 933 connects the communication unit 922, the audio codec 923, the camera unit 926, the image processor 927, the demultiplexer 928, the recording/reproducing unit 929, the display unit 930, and the controller 931 to one another.

The portable telephone device 920 performs operation such as transmission/reception of audio signals, transmission/reception of electronic mails and image data, capturing of images, recording of data, and the like in various operation modes including a voice call mode, a data communication mode, an imaging mode, and a video telephone mode.

In the voice call mode, an analog audio signal generated by the microphone 925 is supplied to the audio codec 923. The audio codec 923 converts the analog audio signal to audio data, performs A/D conversion on the converted audio data, and compresses the audio data. The audio codec 923 then outputs the audio data resulting from the compression to the communication unit 922. The communication unit 922 encodes and modulates the audio data to generate a signal to be transmitted. The communication unit 922 then transmits the generated signal to be transmitted to a base station (not shown) via the antenna 921. The communication unit 922 also amplifies and performs frequency conversion on a radio signal received via the antenna 921 to obtain a received signal. The communication unit 922 then demodulates and decodes the received signal to generate audio data, and outputs the generated audio data to the audio codec 923. The audio codec 923 decompresses and performs D/A conversion on the audio data to generate an analog audio signal. The audio codec 923 then supplies the generated audio signal to the speaker 924 to output audio therefrom.

In the data communication mode, the controller 931 generates text data to be included in an electronic mail according to operation by a user via the operation unit 932, for example. The controller 931 also displays the text on the display unit 930. The controller 931 also generates electronic mail data in response to an instruction for transmission from a user via the operation unit 932, and outputs the generated electronic mail data to the communication unit 922. The communication unit 922 encodes and modulates the electronic mail data to generate a signal to be transmitted. The communication unit 922 then transmits the generated signal to be transmitted to a base station (not shown) via the antenna 921. The communication unit 922 also amplifies and performs frequency conversion on a radio signal received via the antenna 921 to obtain a received signal. The communication unit 922 then demodulates and decodes the received signal to restore electronic mail data, and outputs the restored electronic mail data to the controller 931. The controller 931 displays the content of the electronic mail on the display unit 930 and stores the electronic mail data into a storage medium of the recording/reproducing unit 929.

The recording/reproducing unit 929 includes a readable/writable storage medium. For example, the storage medium may be an internal storage medium such as a RAM or flash memory, or may be an externally mounted storage medium such as a hard disk, a magnetic disk, a magnetooptical disk, a USB memory, or a memory card.

In the imaging mode, the camera unit 926 images a subject to generate image data, and outputs the generated image data to the image processor 927, for example. The image processor 927 encodes the image data input from the camera unit 926, and stores an encoded stream in the storage medium of the recording/reproducing unit 929.

In the video telephone mode, the demultiplexer 928 multiplexes a video stream encoded by the image processor 927 and an audio stream input from the audio codec 923, and outputs the multiplexed stream to the communication unit 922, for example. The communication unit 922 encodes and modulates the stream to generate a signal to be transmitted. The communication unit 922 then transmits the generated signal to be transmitted to a base station (not shown) via the antenna 921. The communication unit 922 also amplifies and performs frequency conversion on a radio signal received via the antenna 921 to obtain a received signal. The signal to be transmitted and the received signal may include encoded bit streams. The communication unit 922 then demodulates and decodes the received signal to restore the stream and outputs the restored stream to the demultiplexer 928. The demultiplexer 928 separates a video stream and an audio stream from the input stream, and outputs the video stream to the image processor 927 and the audio stream to the audio codec 923. The image processor 927 decodes the video stream to generate video data. The video data is supplied to the display unit 930, and a series of images is displayed by the display unit 930. The audio codec 923 decompresses and performs D/A conversion on the audio stream to generate an analog audio signal. The audio codec 923 then supplies the generated audio signal to the speaker 924 to output audio therefrom.

In the portable telephone device 920 having such a structure, the image processor 927 has the functions of the image encoding device 100 (FIG. 7) and the functions of the image decoding device 300 (FIG. 14) according to the embodiments described above. The portable telephone device 920 can therefore improve the coding efficiency.

Although the portable telephone device 920 has been described above, the image encoding device and the image decoding device to which the present technology is applied can be applied to any device having imaging functions and communication functions similarly to the portable telephone device 920 such as a PDA (Personal Digital Assistant), a smart phone, a UMPC (Ultra Mobile Personal Computer), a netbook, and a laptop personal computer, similarly to the portable telephone device 920.

### 8-3. Recording/Reproducing Device

FIG. 40 shows an example of a schematic structure of a recording/reproducing device to which the embodiments described above are applied. The recording/reproducing device 940 encodes audio data and video data of a received broadcast program and records the encoded data into a recording medium, for example. The recording/reproducing device 940 may also encode audio data and video data acquired from another device and record the encoded data into a recording medium, for example. The recording/reproducing device 940 also reproduces data recorded in the recording medium on a monitor and through a speaker in response to an instruction from a user, for example. In this case, the recording/reproducing device 940 decodes audio data and video data.

The recording/reproducing device 940 includes a tuner 941, an external interface 942, an encoder 943, an HDD (hard disk drive) 944, a disk drive 945, a selector 946, a decoder 947, an OSD (on-screen display) 948, a controller 949, and a user interface 950.

The tuner 941 extracts a signal of a desired channel from broadcast signals received via an antenna (not shown), and demodulates the extracted signal. The tuner 941 then outputs an encoded bit stream obtained by the demodulation to the selector 946. That is, the tuner 941 has a role as a transmitter in the recording/reproducing device 940.

The external interface 942 is an interface for connecting the recording/reproducing device 940 with an external device or a network. The external interface 942 may be an IEEE 1394 interface, a network interface, a USB interface, or a flash memory interface, for example. For example, video data and audio data received via the external interface 942 are input to the encoder 943. That is, the external interface 942 has a role as a transmitter in the recording/reproducing device 940.

The encoder 943 encodes the video data and the audio data if the video data and the audio data input from the external interface 942 are not encoded. The encoder 943 then outputs the encoded bit stream to the selector 946.

The HDD 944 records an encoded bit stream of compressed content data such as video and audio, various programs and other data in an internal hard disk. The HDD 944 also reads out the data from the hard disk for reproduction of video and audio.

The disk drive 945 records and reads out data into/from a recording medium mounted thereon. The recording medium mounted on the disk drive 945 may be a DVD disk (such as a DVD-Video, a DVD-RAM, a DVD-R, a DVD-RW, a DVD+R, or a DVD+RW) or a Blu-ray (registered trademark) disc, for example.

For recording video and audio, the selector 946 selects an encoded bit stream input from the tuner 941 or the encoder 943 and outputs the selected encoded bit stream to the HDD 944 or the disk drive 945. For reproducing video and audio, the selector 946 selects an encoded bit stream input from the HDD 944 or the disk drive 945 to the decoder 947.

The decoder 947 decodes the encoded bit stream to generate video data and audio data. The decoder 947 then outputs the generated video data to the OSD 948. The decoder 947 also outputs the generated audio data to an external speaker.

The OSD 948 reproduces the video data input from the decoder 947 and displays the video. The OSD 948 may also superimpose a GUI image such as a menu, a button or a cursor on the video to be displayed.

The controller 949 includes a processor such as a CPU, and a memory such as a RAM and a ROM. The memory stores programs to be executed by the CPU, program data, and the like. Programs stored in the memory are read and executed by the CPU when the recording/reproducing device 940 is activated, for example. The CPU controls the operation of the recording/reproducing device 940 according to control signals input from the user interface 950, for example, by executing the programs.

The user interface 950 is connected to the controller 949. The user interface 950 includes buttons and switches for users to operate the recording/reproducing device 940 and a receiving unit for receiving remote control signals, for example. The user interface 950 detects operation by a user via these components, generates a control signal, and outputs the generated control signal to the controller 949.

In the recording/reproducing device 940 having such a structure, the encoder 943 has the functions of the image encoding device 100 (FIG. 7) according to the embodiments described above. Furthermore, the decoder 947 has the functions of the image decoding device 300 (FIG. 14) according to the embodiments described above. The recording/reproducing device 940 can therefore improve the coding efficiency.

### 8-4. Imaging Device

FIG. 41 shows an example of a schematic structure of an imaging device to which the embodiments described above are applied. The imaging device 960 images a subject to generate image data, encodes the image data, and records the encoded image data in a recording medium.

The imaging device 960 includes an optical block 961, an imaging unit 962, a signal processor 963, an image processor 964, a display unit 965, an external interface 966, a memory 967, a media drive 968, an OSD 969, a controller 970, a user interface 971, and a bus 972.

The optical block 961 is connected to the imaging unit 962. The imaging unit 962 is connected to the signal processor 963. The display unit 965 is connected to the image processor 964. The user interface 971 is connected to the controller 970. The bus 972 connects the image processor 964, the external interface 966, the memory 967, the media drive 968, the OSD 969, and the controller 970 to one another.

The optical block 961 includes a focus lens, a diaphragm, and the like. The optical block 961 forms an optical image of a subject on the imaging surface of the imaging unit 962. The imaging unit 962 includes an image sensor such as a CCD or a CMOS, and converts the optical image formed on the imaging surface into an image signal that is an electric signal through photoelectric conversion. The imaging unit 962 then outputs the image signal to the signal processor 963.

The signal processor 963 performs various kinds of camera signal processing such as knee correction, gamma correction, and color correction on the image signal input from the imaging unit 962. The signal processor 963 outputs image data subjected to the camera signal processing to the image processor 964.

The image processor 964 encodes the image data input from the signal processor 963 to generate encoded data. The image processor 964 then outputs the generated encoded data to the external interface 966 or the media drive 968. The image processor 964 also decodes encoded data input from the external interface 966 or the media drive 968 to generate image data. The image processor 964 then outputs the generated image data to the display unit 965. The image processor 964 may output image data input from the signal processor 963 to the display unit 965 to display images. The image processor 964 may also superimpose data for display acquired from the OSD 969 on the images to be output to the display unit 965.

The OSD 969 may generate a GUI image such as a menu, a button or a cursor and output the generated image to the image processor 964, for example.

The external interface 966 is a USB input/output terminal, for example. The external interface 966 connects the imaging device 960 and a printer for printing of an image, for example. In addition, a drive is connected to the external interface 966 as necessary. A removable medium such as a magnetic disk or an optical disk is mounted to the drive, for example, and a program read out from the removable medium can be installed in the imaging device 960. Furthermore, the external interface 966 may be a network interface connected to a network such as a LAN or the Internet. That is, the external interface 966 has a role as a transmitter in the imaging device 960.

The recording medium to be mounted on the media drive 968 may be a readable/writable removable medium such as a magnetic disk, a magnetooptical disk, an optical disk or a semiconductor memory. Alternatively, a recording medium may be mounted on the media drive 968 in a fixed manner to form an immobile storage unit such as an internal hard disk drive or an SSD (solid state drive), for example.

The controller 970 includes a processor such as a CPU, and a memory such as a RAM and a ROM. The memory stores programs to be executed by the CPU, program data, and the like. Programs stored in the memory are read and executed by the CPU when the imaging device 960 is activated, for example. The CPU controls the operation of the imaging device 960 according to control signals input from the user interface 971, for example, by executing the programs.

The user interface 971 is connected with the controller 970. The user interface 971 includes buttons and switches for users to operate the imaging device 960, for example. The user interface 971 detects operation by a user via these components, generates a control signal, and outputs the generated control signal to the controller 970.

In the imaging device 960 having such a structure, the image processor 964 has the functions of the image encoding device 100 (FIG. 7) and the functions of the image decoding device 300 (FIG. 14) according to the embodiments described above. The imaging device 960 can therefore improve the coding efficiency.

### 9. Applications of Scalable Coding

### 9-1. Data Transmission System

Next, specific examples of use of scalable coded data obtained by scalable coding (progressive (image) coding) will be described. Scalable coding is used for selecting data to be transmitted as in an example shown in FIG. 57, for example.

In a data transmission system 1000 shown in FIG. 42, a distribution server 1002 reads output scalable coded data stored in a scalable coded data storage unit 1001, and delivers the scalable coded data to terminal devices such as a personal computer 1004, AV equipment 1005, a tablet device 1006 and a portable telephone device 1007 via a network 1003.

In this case, the distribution server 1002 selects and transmits encoded data of suitable quality depending on the capability, the communication environment, or the like of the terminal devices. If the distribution server 1002 transmits data of unnecessarily high quality, images of high quality may not necessarily be obtained at the terminal devices and a delay or an overflow may be caused. Furthermore, a communication band may be unnecessarily occupied and loads on the terminal devices may be unnecessarily increased. Conversely, if the distribution server 1002 transmits data of unnecessarily low quality, images of sufficient quality may not be obtained at the terminal devices. Thus, the distribution server 1002 reads out and transmits scalable coded data stored in the scalable coded data storage unit 1001 as coded data of suitable quality for the capability, the communication environment, and the like of the terminal devices as appropriate.

For example, assume that the scalable coded data storage unit 1001 stores scalable coded data (BL+EL) 1011 obtained by scalable coding. The scalable coded data (BL+EL) 1011 is coded data containing both a base layer and an enhancement layer, from which both a base layer image and an enhancement layer image can be obtained through decoding.

The distribution server 1002 selects a suitable layer according to the capability, the communication environment and the like of a terminal device to which data is to be transmitted, and reads out data of the layer. For example, the distribution server 1002 reads out high quality scalable coded data (BL+EL) 1011 from the scalable coded data storage unit 1001 and transmits the read data without any change for the personal computer 1004 and the tablet device 1006 with relatively high processing capability. In contrast, for example, the distribution server 1002 extracts data of the base layer from the scalable coded data (BL+EL) 1011 and transmits scalable coded data (BL) 1012 that is data having the same content as the scalable coded data (BL+EL) 1011 but having lower quality than the scalable coded data (BL+EL) 1011 for the AV equipment 1005 and the portable telephone device 1007 with relatively low processing capability.

As a result of using scalable coded data in this manner, the data amount can be easily adjusted, which can suppress generation of a delay and an overflow and suppress unnecessary increase in the loads on the terminal devices and communication media. Furthermore, since the redundancy between layers of the scalable coded data (BL+EL) 1011 is reduced, the data amount can be reduced as compared to a case in which encoded data of each layer is handled as individual data. The storage area of the scalable coded data storage unit 1001 can therefore be used more efficiently.

Since various devices can be applied such as the personal computer 1004 through the portable telephone device 1007 as the terminal devices, the hardware performance of the terminal devices varies depending on the devices. Furthermore, since various applications are executed by the terminal devices, the capability of software also varies. Furthermore, various wired or wireless communication line networks or combinations thereof such as the Internet and a LAN (Local Area Network) can be applied as the network 1003 that is a communication medium, and the data transmission capability thereof also varies. Furthermore, the data transmission capability may also change owing to other communication or the like.

The distribution server 1002 may therefore communicate with the terminal device to which data is to be transmitted before starting data transmission to acquire information on the capability of the terminal device such as the hardware performance of the terminal device and the performance of applications (software) to be executed by the terminal device, and information on the communication environment such as the available bandwidth or the like of the network 1003. The distribution server 1002 may then select a suitable layer on the basis of the acquired information.

Note that extraction of a layer may be performed at the terminal devices. For example, the personal computer 1004 may decode the transmitted scalable coded data (BL+EL) 1011 and display a base layer image or an enhancement layer image. Alternatively, for example, the personal computer 1004 may extract the base layer scalable coded data (BL) 1012 from the transmitted scalable coded data (BL+EL) 1011, and store the extracted data, transfer the extracted data to another device, or decode the extracted data to display a base layer image.

The numbers of scalable coded data storage units 1001, distribution servers 1002, networks 1003 and terminal devices may of course be any numbers. Furthermore, although an example in which the distribution server 1002 transmits data to terminal devices has been described above, examples of use are not limited thereto. The data transmission system 1000 can be applied to any system that selects and transmits a suitable layer depending on the capability, the communication environment and the like of a terminal device in transmitting coded data obtained by scalable coding to the terminal device.

The data transmission system 1000 as in FIG. 42 described above can also produce the same effects as those described above with reference to FIGS. 34 to 36 by applying the present technology similarly to the application to progressive encoding/progressive decoding described above with reference to FIGS. 34 to 36.

### 9-2. Data Transmission System

Scalable coding is also used for transmission via multiple communication media as in an example shown in FIG. 43, for example.

In a data transmission system 1100 shown in FIG. 43, a broadcast station 1101 transmits base layer scalable coded data (BL) 1121 via terrestrial broadcasting 1111. The broadcast station 1101 also transmits enhancement layer scalable coded data (EL) 1122 (in a form of a packet, for example) via a certain network 1112 of wired or wireless communication network or a combination thereof.

A terminal device 1102 has a function of receiving terrestrial broadcasting 1111 broadcasted by the broadcast station 1101 and receives the base layer scalable coded data (BL) 1121 transmitted via the terrestrial broadcasting 1111. The terminal device 1102 further has a communication function for communication via a network 1112 and receives enhancement layer scalable coded data (EL) 1122 transmitted via the network 1112.

The terminal device 1102 decodes the base layer scalable coded data (BL) 1121 acquired via the terrestrial broadcasting 1111 to obtain a base layer image, store the data, or transfer the data to another device according to an instruction from a user, for example.

The terminal device 1102 also combines the base layer scalable coded data (BL) 1121 acquired via the terrestrial broadcasting 1111 and the enhancement layer scalable coded data (EL) 1122 acquired via the network 1112 to obtain scalable coded data (BL+EL), decodes the scalable coded data (BL+EL) to obtain an enhancement layer image, stores the data, or transmits the data to another device according to an instruction from a user, for example.

As described above, different layers of the scalable coded data can be transmitted via different communication media. As a result, loads can be balanced and generation of a delay and an overflow can be suppressed.

Furthermore, communication media used for transmission may be capable of being selected for each layer depending on the conditions. For example, the base layer scalable coded data (BL) 1121 having a relatively large data amount may be transmitted via a communication medium with a wide bandwidth and the enhancement layer scalable coded data (EL) 1122 having a relatively small data amount may be transmitted via a communication medium with a narrow bandwidth. Alternatively, for example, the communication medium for transmitting the enhancement layer scalable coded data (EL) 1122 may be switched between the network 1112 and the terrestrial broadcasting 1111 depending on the available bandwidth of the network 1112. The same is of course applicable to data of any layer.

As a result of such control, increase in the loads of data transmission can be further suppressed.

Of course, any number of layers may be used and any number of communication media may be used for transmission. Furthermore, any number of terminal devices 1102 to which data are delivered may be used. Furthermore, although an example of broadcasting from the broadcast station 1101 has been described above, examples of use are not limited thereto. The data transmission system 1100 can be applied to any system that divides coded data obtained by scalable coding into multiple layers and transmits the layers via multiple lines.

The data transmission system 1100 as in FIG. 43 described above can also produce the same effects as those described above with reference to FIGS. 34 to 36 by applying the present technology similarly to the application to progressive encoding/progressive decoding described above with reference to FIGS. 34 to 36.

### 9-3. Imaging System

Scalable coding is also used for storing coded data as in an example shown in FIG. 44, for example.

In an imaging system 1200 shown in FIG. 44, an imaging device 1201 performs scalable coding on image data acquired by imaging a subject 1211, and supplies the image data as scalable coded data (BL+EL) 1221 to a scalable coded data storage device 1202.

The scalable coded data storage device 1202 stores scalable coded data (BL+EL) 1221 supplied from the imaging device 1201 with suitable quality depending on conditions. For example, in a normal state, the scalable coded data storage device 1202 extracts base layer data from the scalable coded data (BL+EL) 1221 and stores as base layer scalable coded data (BL) 1222 having low quality and a small data amount. In contrast, in focused state, the scalable coded data storage device 1202 stores scalable coded data (BL+EL) 1221 having high quality and a large data amount without any change.

In this manner, the scalable coded data storage device 1202 can save images with high quality only where necessary, which can suppress increase in the data amount while suppressing reduction in the value of images due to image quality degradation and improve the efficiency of use of storage areas.

Assume that the imaging device 1201 is a surveillance camera, for example. When no object to be monitored (such as an intruder) is present in a captured image (normal state), since the content of the captured image is likely to be less important, priority is placed on reduction of the data amount and the image data (scalable coded data) is stored with low quality. In contrast, when a subject 1211 to be monitored is present in a captured image (focused state), since the content of the captured image is likely to be important, priority is placed on the quality and the image data (scalable coded data) is stored with high quality.

Whether the state is a normal state or a focused state may be determined by the scalable coded data storage device 1202 by analyzing the image, for example. Alternatively, the imaging device 1201 may make the determination, and transmit the determination result to the scalable coded data storage device 1202.

Any criterion may be used for determining whether the state is a normal state or a focused state and any content of an image may be defined as the determination criterion. Conditions other than the content of an image may be used as determination criteria. For example, the state may be switched according to the volume, the waveform, or the like of recorded speech, may be switched at predetermined time intervals, or may be switched according to an external instruction such as an instruction from a user.

Although an example in which the state is switched between two states of the normal state and the focused state has been described above, the operation may be switched between any number of states such as three or more states of a normal state, a semi-focused state, a focused state, a very focused state, and the like. The upper limit of the number of states switched therebetween is dependent on the number of layers of scalable coded data.

Furthermore, the imaging device 1201 may determine the number of layers for scalable coding depending on the state. For example, in a normal state, the imaging device 1201 may generate base layer scalable coded data (BL) 1222 having low quality and a small amount of data and supply the base layer scalable coded data (BL) 1222 to the scalable coded data storage device 1202. In a focused state, for example, the imaging device 1201 may generate base layer scalable coded data (BL+EL) 1221 having high quality and a large data amount and supply the base layer scalable coded data (BL+EL) 1221 to the scalable coded data storage device 1202.

Although an example of a surveillance camera has been described above, the imaging system 1200 may be used in any application and is not limited to a surveillance camera.

The imaging system 1200 as in FIG. 44 described above can also produce the same effects as those described above with reference to FIGS. 34 to 36 by applying the present technology similarly to the application to progressive encoding/progressive decoding described above with reference to FIGS. 34 to 36.

Note that the present technology can also be applied to HTTP streaming such as MPEG DASH in which data is selected from multiple coded data with different resolutions or the like provided in advance. Thus, information on encoding and decoding can also be shared among such multiple coded data.

The image encoding device and the image decoding device to which the present technology is applied can of course also be applied to devices and systems other than those described above.

In the present specification, an example in which information on scaling lists is transmitted from the encoding side to the decoding side has been described. The method for transmitting the information on scaling lists may be such that the information may be transmitted or recorded as separate data associated with the encoded bit stream without being multiplexed with the encoded bit stream. Note that the term “associate” means to allow images (which may be part of images such as slices or blocks) contained in a bit stream to be linked with information on the images in decoding. That is, the information may be transmitted via a transmission path different from that for the images (or bit stream). Alternatively, the information may be recorded in a recording medium other than that for the images (or bit stream) (or on a different area of the same recording medium). Furthermore, the information and the images (or bit stream) may be associated with each other in any units such as in units of some frames, one frame or part of a frame.

The present technology can also have the following structures.

(1) An image processing device including:

a generator configured to generate information on a scaling list to which identification information is assigned according to a format of image data to be encoded;

an encoder configured to encode the information on the scaling list generated by the generator; and

a transmitter configured to transmit the encoded data of the information on the scaling list generated by the encoder.

(2) The image processing device of (1), wherein the identification information is assigned to a scaling list used for quantization of the image data.
(3) The image processing device of (2), wherein the identification information is assigned to a scaling list used for quantization of the image data from among multiple scaling lists provided in advance.
(4) The image processing device of (3), wherein the identification information is an identification number for identifying an object with a numerical value, and a small identification number is assigned to the scaling list used for quantization of the image data.
(5) The image processing device of any one of (1) to (4), wherein when a chroma format of the image data is monochrome, the identification information is assigned only to a scaling list for brightness components.
(6) The image processing device according to any one of (1) to (5), wherein in a normal mode:

the generator generates difference data between the scaling list to which the identification number is assigned and a predicted value thereof,

the encoder encodes the difference data generated by the generator, and

the transmitter transmits the encoded data of the difference data generated by the encoder.

(7) The image processing device of any one of (1) to (6), wherein in a copy mode:

the generator generates information indicating a reference scaling list that is a reference,

the encoder encodes the information indicating the reference scaling list generated by the generator, and

the transmitter transmits the encoded data of the information indicating the reference scaling list generated by the encoder.

(8) The image processing device of (7), wherein the generator generates the information indicating the reference scaling list only when multiple candidates for the reference scaling list are present.
(9) The image processing device of any one of (1) to (8), further including:

an image data encoder configured to encode the image data; and

an encoded data transmitter configured to transmit the encoded data of the image data generated by the image data encoder.

(10) An image processing method including:

generating information on a scaling list to which identification information is assigned according to a format of image data to be encoded;

encoding the generated information on the scaling list; and

transmitting the generated encoded data of the information on the scaling list.

(11) An image processing device including:

an acquisition unit configured to acquire encoded data of information on a scaling list to which identification information is assigned according to a format of encoded image data;

a decoder configured to decode the encoded data of information on the scaling list acquired by the acquisition unit; and

a generator configured to generate a current scaling list to be processed on the basis of the information on the scaling list generated by the decoder.

(12) The image processing device of (11), wherein the identification information is assigned to a scaling list used for quantization of the image data.
(13) The image processing device of (12), wherein the identification information is assigned to a scaling list used for quantization of the image data from among multiple scaling lists provided in advance.
(14) The image processing device of (13), wherein the identification information is an identification number for identifying an object with a numerical value, and a small identification number is assigned to the scaling list used for quantization of the image data.
(15) The image processing device of any one of (11) to (14), wherein when a chroma format of the image data is monochrome, the identification information is assigned only to a scaling list for brightness components.
(16) The image processing device of any one of (11) to (15), wherein in a normal mode:

the acquisition unit acquires encoded data of difference data between the scaling list to which the identification number is assigned and a predicted value thereof,

the decoder decodes the encoded data of difference data acquired by the acquisition unit, and

the generator generates the current scaling list on the basis of the difference data generated by the decoder.

(17) The image processing device of any one of (11) to (14), wherein in a copy mode:

the acquisition unit acquires encoded data of information indicating a reference scaling list that is a reference,

the decoder decodes the encoded data of the information indicating the reference scaling list acquired by the acquisition unit, and

the generator generates the current scaling list by using the information indicating the reference scaling list generated by the decoder.

(18) The image processing device of (17), wherein when the information indicating the reference scaling list is not transmitted, the generator sets “0” to the identification information of the reference scaling list.
(19) The image processing device of any one of (11) to (18), further including:

an encoded data acquisition unit configured to acquire encoded data of the image data; and

an image data decoder configured to decode the encoded data of the image data acquired by the encoded data acquisition unit.

(20) An image processing method including:

acquiring encoded data of information on a scaling list to which identification information is assigned according to a format of encoded image data;

decoding the acquired encoded data of the information on the scaling list; and

generating a current scaling list to be processed on the basis of the generated information on the scaling list.

### REFERENCE SIGNS LIST

100 Image encoding device
104 Orthogonal transform/quantization unit
131 Selector
132 Orthogonal transformer
133 Quantizer
134 Scaling list buffer
135 Matrix processor
161 Predictor
166 Output unit
171 Copy unit
172 Prediction matrix generator
210 Controller
211 Matrix ID controller
212 Mode controller
300 Image decoding device
303 Inverse quantization/inverse orthogonal transform unit
331 Matrix generator
332 Selector
333 Inverse quantizer
334 Inverse orthogonal transformer
351 Parameter analyzer
352 Predictor
355 Output unit
361 Copy unit
362 Prediction matrix generator
391 Matrix ID controller

1. An image processing device comprising:
a generator configured to generate information on a scaling list to which identification information is assigned according to a format of image data to be encoded;
an encoder configured to encode the information on the scaling list generated by the generator; and
a transmitter configured to transmit the encoded data of the information on the scaling list generated by the encoder.

2. The image processing device according to claim 1, wherein the identification information is assigned to a scaling list used for quantization of the image data.

3. The image processing device according to claim 2, wherein the identification information is assigned to a scaling list used for quantization of the image data from among multiple scaling lists provided in advance.

4. The image processing device according to claim 3, wherein the identification information is an identification number for identifying an object with a numerical value, and a small identification number is assigned to the scaling list used for quantization of the image data.

5. The image processing device according to claim 1, wherein when a chroma format of the image data is monochrome, the identification information is assigned only to a scaling list for brightness components.

6. The image processing device according to claim 1, wherein in a normal mode:
the generator generates difference data between the scaling list to which the identification number is assigned and a predicted value thereof,
the encoder encodes the difference data generated by the generator, and
the transmitter transmits the encoded data of the difference data generated by the encoder.

7. The image processing device according to claim 1, wherein in a copy mode:
the generator generates information indicating a reference scaling list that is a reference,
the encoder encodes the information indicating the reference scaling list generated by the generator, and
the transmitter transmits the encoded data of the information indicating the reference scaling list generated by the encoder.

8. The image processing device according to claim 7, wherein the generator generates the information indicating the reference scaling list only when multiple candidates for the reference scaling list are present.

9. The image processing device according to claim 1, further comprising:
an image data encoder configured to encode the image data; and
an encoded data transmitter configured to transmit the encoded data of the image data generated by the image data encoder.

10. An image processing method comprising:
generating information on a scaling list to which identification information is assigned according to a format of image data to be encoded;
encoding the generated information on the scaling list; and
transmitting the generated encoded data of the information on the scaling list.

11. An image processing device comprising:
an acquisition unit configured to acquire encoded data of information on a scaling list to which identification information is assigned according to a format of encoded image data;
a decoder configured to decode the encoded data of information on the scaling list acquired by the acquisition unit; and
a generator configured to generate a current scaling list to be processed on the basis of the information on the scaling list generated by the decoder.

12. The image processing device according to claim 11, wherein the identification information is assigned to a scaling list used for quantization of the image data.

13. The image processing device according to claim 12, wherein the identification information is assigned to a scaling list used for quantization of the image data from among multiple scaling lists provided in advance.

14. The image processing device according to claim 13, wherein the identification information is an identification number for identifying an object with a numerical value, and a small identification number is assigned to the scaling list used for quantization of the image data.

15. The image processing device according to claim 11, wherein when a chroma format of the image data is monochrome, the identification information is assigned only to a scaling list for brightness components.

16. The image processing device according to claim 11, wherein in a normal mode:
the acquisition unit acquires encoded data of difference data between the scaling list to which the identification number is assigned and a predicted value thereof,
the decoder decodes the encoded data of difference data acquired by the acquisition unit, and
the generator generates the current scaling list on the basis of the difference data generated by the decoder.

17. The image processing device according to claim 11, wherein in a copy mode:
the acquisition unit acquires encoded data of information indicating a reference scaling list that is a reference,
the decoder decodes the encoded data of the information indicating the reference scaling list acquired by the acquisition unit, and
the generator generates the current scaling list by using the information indicating the reference scaling list generated by the decoder.

18. The image processing device according to claim 17, wherein when the information indicating the reference scaling list is not transmitted, the generator sets “0” to the identification information of the reference scaling list.

19. The image processing device according to claim 11, further comprising:
an encoded data acquisition unit configured to acquire encoded data of the image data; and
an image data decoder configured to decode the encoded data of the image data acquired by the encoded data acquisition unit.

20. An image processing method comprising:
acquiring encoded data of information on a scaling list to which identification information is assigned according to a format of encoded image data;
decoding the acquired encoded data of the information on the scaling list; and
generating a current scaling list to be processed on the basis of the generated information on the scaling list.
